(19) United States
(12) Patent Application Publication
(10) Pub. No.: US 2013/0252082 A1
(43) Pub. Date: Sep. 26, 2013

(54) HARD CARBON MATERIALS

(71) Applicant: ENERG2 TECHNOLOGIES, INC., Seattle, WA (US)

(72) Inventors: Leah A. Thompkins, Seattle, WA (US); Aaron M. Feaver, Seattle, WA (US); Henry R. Costantino, Woodinville, WA (US); Avery Sakshaug, Lynnwood, WA (US)

(73) Assignee: EnerG2 Technologies, Inc., Seattle, WA (US)

(21) Appl. No.: 13/740,110

(22) Filed: Jan. 11, 2013

Related U.S. Application Data
(60) Provisional application No. 61/585,611, filed on Jan. 11, 2012.
(60) Provisional application No. 61/613,790, filed on Mar. 21, 2012.

(51) Int. Cl. H01M 4/133; H01M 10/056; H01M 10/0525

(52) U.S. Cl. CPC H01M 4/133; H01M 10/0525; H01M 10/056
USPC 429/188; 429/231.8; 429/213

(57) ABSTRACT

The present application is directed to hard carbon materials. The hard carbon materials find utility in any number of electrical devices, for example, in lithium ion batteries. Methods for making the disclosed carbon materials are also disclosed.

### BACKGROUND

1. Technical Field

The present invention generally relates to hard carbon materials, methods for making the same and devices containing the same.

2. Description of the Related Art

Lithium-based electrical storage devices have potential to replace devices currently used in any number of applications. For example, current lead acid automobile batteries are not adequate for next generation all-electric and hybrid electric vehicles due to irreversible, stable sulfate formations during discharge. Lithium ion batteries are a viable alternative to the lead-based systems currently used due to their capacity, and other considerations. Carbon is one of the primary materials used in both lithium secondary batteries and hybrid lithium-ion capacitors (LIC). The carbon anode typically stores lithium in between layered graphite sheets through a mechanism called intercalation. Traditional lithium ion batteries are comprised of a graphitic carbon anode and a metal oxide cathode; however such graphitic anodes typically suffer from low power performance and limited capacity.

Hard carbon materials have been proposed for use in lithium ion batteries, but the physical and chemical properties of known hard carbon materials are not optimized for use as anodes in lithium-based batteries. Thus, anodes comprising known hard carbon materials still suffer from many of the disadvantages of limited capacity and low first cycle efficiency. Hard carbon materials having properties optimized for use in lithium-based batteries are expected to address these deficiencies and provide other related advantages.

While significant advances have been made in the field, there continues to be a need in the art for improved hard carbon materials for use in electrical energy storage devices (e.g., lithium ion batteries), as well as for methods of making the same and devices containing the same. The present invention fulfills these needs and provides further related advantages.

### BRIEF SUMMARY

In general terms, the current invention is directed to novel hard carbon materials with optimized lithium storage and utilization properties. The novel carbon materials find utility in any number of electrical energy storage devices, for example as electrode material in lithium-based electrical energy storage devices (e.g., lithium ion batteries). Electrodes comprising the carbon materials display high reversible capacity, high first cycle efficiency, high power performance or any combination thereof. The present inventors have discovered that such improved electrochemical performance is related, at least in part, to the carbon materials physical and chemical properties such as surface area, pore structure, crystallinity, surface chemistry and other properties as discussed in more detail herein. Furthermore, certain electrochemical modifiers can be incorporated on the surface of and/or in the carbon material to further tune the desired properties.

In certain embodiments, the present disclosure provides a carbon material comprising a surface area of greater than 50 m²/g and a specific lithium uptake capacity of greater than 1.4:6. In some embodiments, the specific lithium uptake capacity is greater than 1.6:6.

In some embodiments, the specific surface area is greater than 100 m²/g, for example greater than 200 m²/g.

In some other embodiments, the carbon material comprises from 1% to 6% nitrogen by weight relative to total weight of all components in the carbon material. In some other embodiments, the carbon material comprises from 6% to 20% nitrogen by weight relative to total weight of all components in the carbon material.

In some other embodiments, the carbon material comprises a total pore volume from 0.1 to 0.6 cm³/g. In some embodiments, the carbon material comprises a tap density from 0.3 to 0.9 g/cm³.

In some specific embodiments, the carbon material comprises a nitrogen content from 1% to 20%, a total pore volume from 0.1 to 0.6 cm³/g and a tap density from 0.3 to 1.0 g/cm³.

In still other embodiments, the first cycle efficiency of a lithium based energy storage device is greater than 70% when the carbon material is incorporated into an electrode of the lithium based energy storage device. For example, in some embodiments the first cycle efficiency of a lithium based energy storage device is greater than 80% when the carbon material is incorporated into an electrode of the lithium based energy storage device. In other embodiments, the first cycle efficiency of a lithium based energy storage device is greater than 90% when the carbon material is incorporated into an electrode of the lithium based energy storage device.

In other specific embodiments, the first cycle efficiency of a lithium based energy storage device is greater than 70% when the carbon material is incorporated into an electrode of the lithium based energy storage device.

In other embodiments, 50% of the total pore volume comprises pores less than 100 nm in diameter. In some other embodiments, 50% of the total pore volume comprises pores less than 1 nm in diameter.

In certain embodiments, the total concentration of all elements having an atomic number from 11 to 92 is below 200 ppm as measured by proton induced X-ray emission. For example, in some embodiments 50% of the total pore volume comprises pores less than 1 nm and wherein the total concentration of all elements having an atomic number from 11 to 92 is below 200 ppm as measured by proton induced X-ray emission.

In some embodiments, the carbon material comprises an electrochemical modifier. In certain embodiments, the electrochemical modifier is selected from iron, tin, silicon, nickel, aluminum and manganese. In one embodiment, the electrochemical modifier comprises silicon. In another embodiment, the electrochemical modifier comprises tin. In some other embodiments, the carbon material comprises Al₂O₃.

In certain embodiments, the carbon material comprises organic functionality as determined by FTIR analysis.

In other embodiments, the carbon material comprises less than 10% crystallinity.

In some other embodiments, the carbon material comprises an Lₐ ranging from 20 nm to 30 nm as determined by RAMAN spectroscopy analysis. In some embodiments, the carbon material comprises an R ranging from 0.60 to 0.90 as determined by RAMAN spectroscopy analysis.

In still other embodiments, the carbon material comprises a total of less than 200 ppm of all elements having atomic numbers ranging from 11 to 92, excluding any intentionally added electrochemical modifier, as measured by proton induced x-ray emission.

In other embodiments, the carbon material comprises a pyrolyzed polymer cryogel.

In still other embodiments, the carbon material has a ratio of intercalation storage to pore storage ranging from 2:1 to 1:2.

In some other embodiments, the lithium content and lithium location within the carbon structure can be measured with a FIB and SEM.

In some embodiments, the carbon material comprises a lithium plating potential between −5 mV and −15 mV versus lithium metal.

Certain embodiments of the present disclosure provide an electrode comprising a binder and any of the carbon material described herein.

In other aspects, the present disclosure provides an electrical energy storage device comprising:

a) at least one anode comprising a hard carbon material;

b) at least one cathode comprising a metal oxide; and

c) an electrolyte comprising lithium ions;

wherein the electrical energy storage device has a first cycle efficiency of at least 70% and a reversible capacity of at least 200 mAh/g with respect to the mass of the hard carbon material present in the device.

For example, in certain embodiments the hard carbon is any of the carbon materials described herein.

In other embodiments, the first cycle efficiency of the device is greater than 70%. In still other embodiments, the first cycle efficiency is greater than 80%. In yet more embodiments, the first cycle efficiency is greater than 90%.

In other embodiments, the electrical energy storage device has a gravimetric capacity of greater than 400 mAh/g based on total mass of active material in the electrical energy storage device. For example, in some embodiments the electrical energy storage device has a gravimetric capacity of greater than 500 mAh/g based on total mass of active material in the electrical energy storage device. In other embodiments, the electrical energy storage device has a gravimetric capacity ranging from 550 mAh/g to 750 mAh/g based on total mass of active material in the electrical energy storage device.

In some embodiments, the electrical energy storage device has a ratio of intercalation storage to pore storage ranging from 2:1 to 1:2.

In some other embodiments, the electrical energy storage device has a lithium plating potential between −5 mV and −15 mV versus lithium metal.

In some other embodiments, the present disclosure is directed to a condensation polymer gel prepared from polymer precursors comprising an aldehyde compound and a phenolic compound and a volatile basic salt catalyst in a mixed solvent system, wherein the nitrogen content of the condensation polymer is at least 1% by mass of the dry weight of the condensation polymer.

In certain embodiments, the nitrogen content is at least 6% by mass of the dry weight of the condensation polymer. For example, in some embodiments the nitrogen content is at least 20% by mass of the dry weight of the condensation polymer.

In still other embodiments, a dopant nitrogen-containing compound is associated non-covalently with the condensation polymer gel.

In certain specific embodiments, the aldehyde is formaldehyde, the phenolic compound is phenol, resorcinol, or combinations thereof, the mixed solvent system comprises water and acetic acid, the volatile basic salt catalyst is ammonium carbonate, ammonium bicarbonate, ammonium acetate, or ammonium hydroxide, or a combination thereof, and the dopant nitrogen-containing compound is urea, melamine, ammonia, or a combination thereof.

In still other embodiments, the polymer precursor further comprises a nitrogen-containing compound which is associated covalently within the condensation polymer gel.

In some embodiments, the nitrogen-containing compound is urea, melamine, ammonia, or combination thereof.

Other embodiments of the present disclosure include a condensation polymer gel prepared from precursors comprising an aldehyde compound, an amine compound and a carboxy compound, wherein the nitrogen content is at least 1% by mass of the dry weight of the condensation polymer.

In some embodiments of the foregoing condensation polymer, the aldehyde is formaldehyde, the amine compound is urea, and the carboxy compound is formic acid. In other embodiments, the condensation polymer gel is in the form of particles having a volume average particle size ranging from 1 to 25 mm. In still other embodiments, the condensation polymer gel is in the form of particles having a volume average particle size ranging from 10 to 1000 um.

In some embodiments, the present disclosure provides a method for preparing a condensation polymer gel, the method comprising;

a) forming condensation polymer gel particles having a volume average particle size ranging from 0.01 to 25 mm from polymer precursors comprising an aldehyde compound and a phenolic compound and a volatile basic salt catalyst in a mixed solvent system; and,

b) contacting the condensation polymer gel particles with a dopant nitrogen containing compound under conditions sufficient to associate at least 1% by mass of the dry weight of the condensation polymer of the dopant nitrogen containing compound non-covalently with the condensation polymer gel.

In certain specific embodiments of the foregoing method, the aldehyde is formaldehyde, the phenolic compound is phenol, resorcinol, or combination thereof, the mixed solvent system comprises water and acetic acid, the volatile basic salt catalyst is ammonium carbonate, ammonium bicarbonate, ammonium acetate, or ammonium hydroxide, or a combination thereof, and the dopant nitrogen-containing compound is urea, melamine, ammonia, or combination thereof.

In another aspect the present disclosure is directed to a method for preparing a condensation polymer gel prepared from precursors comprising an aldehyde compound, an amine compound and a carboxy compound, wherein the nitrogen content is at least 1% by mass of the dry weight of the condensation polymer, the method comprising;

a) forming condensation polymer gel particles having a volume average particle size ranging from 0.01 to 25 mm from polymer precursors comprising an aldehyde compound, an amine compound and a carboxy compound; and

b) optionally contacting the condensation polymer gel particles with a dopant nitrogen containing compound under conditions sufficient to associate the dopant nitrogen containing compound covalently or non-covalently with the condensation polymer gel.

In some embodiments of any of the foregoing methods, the volume average particle size ranges from 1 to 25 mm. In other embodiments, the volume average particle size ranges from 10 to 1000 um.

In still more embodiments, the disclosure provides a carbon material prepared by a process comprising:
1) polymerizing one or more polymer precursors to obtain a polymer gel; and
2) pyrolyzing the polymer gel to obtain the carbon material,

wherein a nitrogen containing substance is contacted with the polymer gel during polymerization of the one or more polymer precursors, the nitrogen containing substance is contacted with the polymer gel after polymerization of the polymer gel, the nitrogen containing compound is contacted with the carbon material or polymer gel during pyrolysis or the nitrogen containing compound is contacted with the carbon material after pyrolysis or combinations thereof.

In certain embodiments, the above process further comprises contacting the carbon material with a hydrocarbon compound. For example, in some embodiments the hydrocarbon compound is cyclohexane. In some other embodiments, the nitrogen containing compound is urea, melamine or ammonia.

These and other aspects of the invention will be apparent upon reference to the following detailed description. To this end, various references are set forth herein which describe in more detail certain background information, procedures, compounds and/or compositions, and are each hereby incorporated by reference in their entirety.

### BRIEF DESCRIPTION OF THE DRAWINGS

In the figures, identical reference numbers identify similar elements. The sizes and relative positions of elements in the figures are not necessarily drawn to scale and some of these elements are arbitrarily enlarged and positioned to improve figure legibility. Further, the particular shapes of the elements as drawn are not intended to convey any information regarding the actual shape of the particular elements, and have been solely selected for ease of recognition in the figures.

FIG. 1 depicts pore size distribution of exemplary carbon materials.

FIG. 2 shows electrochemical performance of exemplary carbon materials.

FIG. 3 presents pore size distributions of exemplary carbon materials.

FIG. 4 depicts RAMAN spectra of exemplary carbon materials.

FIG. 5 is a plot of an x-ray diffraction pattern of exemplary carbon materials.

FIG. 6 shows an example SAXS plot along with the calculation of the empirical R value for determining internal pore structure.

FIG. 7 presents SAXS of three exemplary carbon materials.

FIG. 8a presents FTIR spectra of exemplary carbon materials.

FIG. 8b shows electrochemical performance of exemplary carbon materials.

FIG. 9 presents electrochemical performance of a carbon material before and after hydrocarbon surface treatment.

FIG. 10 is a graph showing pore size distribution of a carbon material before and after hydrocarbon surface treatment

FIG. 11 presents first cycle voltage profiles of exemplary carbon materials.

FIG. 12 is a graph showing the electrochemical stability of an exemplary carbon material compared to graphitic carbon.

FIG. 13 shows voltage versus specific capacity data for a silicon-carbon composite material.

FIG. 14 shows a TEM of a silicon particle embedded into a hard carbon particle

FIG. 15 depicts electrochemical performance of hard carbon materials comprising an electrochemical modifier.

FIG. 16 shows electrochemical performance of hard carbon materials comprising graphite.

FIG. 17 is a graph showing electrochemical performance of hard carbon materials comprising graphite.

FIG. 18 presents the differential capacity, the voltage profile and the stability of graphitic materials cycled at different voltage profiles.

FIG. 19 presents the differential capacity, the voltage profile and the stability of hard carbon materials cycled at different voltage profiles.

FIG. 20 is a graph of a wide angle XPS spectrum for an exemplary carbon material.

FIG. 21 presents an Auger scan using XPS methods for an exemplary carbon material having approximately 65% sp² hybridized carbons.

FIG. 22 depicts a SAXS measurement, internal pore analysis and domain size of exemplary hard carbon material

FIG. 23 demonstrates the effect on pH as the pyrolysis temperature increases for a representative carbon material.

FIG. 24 shows Li:C ratio for an exemplary carbon material as a function of pH from 7 to 7.5.

FIG. 25 presents the capacity of an exemplary, ultrapure hard carbon.

FIG. 26 is another graph showing the capacity of an exemplary, ultrapure hard carbon.

### DETAILED DESCRIPTION

In the following description, certain specific details are set forth in order to provide a thorough understanding of various embodiments. However, one skilled in the art will understand that the invention may be practiced without these details. In other instances, well-known structures have not been shown or described in detail to avoid unnecessarily obscuring descriptions of the embodiments. Unless the context requires otherwise, throughout the specification and claims which follow, the word “comprise” and variations thereof, such as, “comprises” and “comprising” are to be construed in an open, inclusive sense, that is, as “including, but not limited to.” Further, headings provided herein are for convenience only and do not interpret the scope or meaning of the claimed invention.

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments. Also, as used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

### DEFINITIONS

As used herein, and unless the context dictates otherwise, the following terms have the meanings as specified below.

“Carbon material” refers to a material or substance comprised substantially of carbon. Carbon materials include ultrapure as well as amorphous and crystalline carbon materials. Examples of carbon materials include, but are not limited to, activated carbon, pyrolyzed dried polymer gels, pyrolyzed polymer cryogels, pyrolyzed polymer xerogels, pyrolyzed polymer aerogels, activated dried polymer gels, activated polymer cryogels, activated polymer xerogels, activated polymer aerogels and the like.

“Hard Carbon” refers to a non-graphitizable carbon material. At elevated temperatures (e.g., >1500° C.) a hard carbon remains substantially amorphous, whereas a “soft” carbon will undergo crystallization and become graphitic.

“First cycle efficiency” refers to the percent difference in volumetric or gravimetric capacity between the initial charge and the first discharge cycle of a lithium battery. First cycle efficiency is calculated by the following formula: (F²/F¹)×100), where F¹ and F² are the volumetric or gravimetric capacity of the initial lithium insertion and the first cycle lithium extraction, respectively.

“Electrochemical modifier” refers to any chemical element, compound comprising a chemical element or any combination of different chemical elements and compounds which enhances the electrochemical performance of a carbon material. Electrochemical modifiers can change (increase or decrease) the resistance, capacity, power performance, stability and other properties of a carbon material. Electrochemical modifiers generally impart a desired electrochemical effect. In contrast, an impurity in a carbon material is generally undesired and tends to degrade, rather than enhance, the electrochemical performance of the carbon material. Examples of electrochemical modifiers within the context of the present disclosure include, but are not limited to, elements, and compounds or oxides comprising elements, in groups 12-15 of the periodic table, other elements such as silicon, tin, sulfur, and tungsten and combinations thereof. For example, electrochemical modifiers include, but are not limited to, tin, silicon, tungsten, silver, zinc, molybdenum, iron, nickel, aluminum, manganese and combinations thereof as well as oxides of the same and compounds comprising the same.

“Group 12” elements include zinc (Zn), cadmium (Cd), mercury (Hg), and copernicium (Cn).

“Group 13” elements include boron (B), aluminum (Al), gallium (Ga), indium (In) and thallium (Tl).

“Group 14” elements include carbon (C), silicon (Si), germanium (Ge), tin (Sn) and lead (Pb).

“Group 15” elements include nitrogen (N), phosphorous (P), arsenic (As), antimony (Sb) and bismuth (Bi).

“Amorphous” refers to a material, for example an amorphous carbon material, whose constituent atoms, molecules, or ions are arranged randomly without a regular repeating pattern. Amorphous materials may have some localized crystallinity (i.e., regularity) but lack long-range order of the positions of the atoms. Pyrolyzed and/or activated carbon materials are generally amorphous.

“Crystalline” refers to a material whose constituent atoms, molecules, or ions are arranged in an orderly repeating pattern. Examples of crystalline carbon materials include, but are not limited to, diamond and graphene.

“Synthetic” refers to a substance which has been prepared by chemical means rather than from a natural source. For example, a synthetic carbon material is one which is synthesized from precursor materials and is not isolated from natural sources.

“Impurity” or “impurity element” refers to an undesired foreign substance (e.g., a chemical element) within a material which differs from the chemical composition of the base material. For example, an impurity in a carbon material refers to any element or combination of elements, other than carbon, which is present in the carbon material. Impurity levels are typically expressed in parts per million (ppm).

“PIXE impurity” or “PIXE element” is any impurity element having an atomic number ranging from 11 to 92 (i.e., from sodium to uranium). The phrases “total PIXE impurity content” and “total PIXE impurity level” both refer to the sum of all PIXE impurities present in a sample, for example, a polymer gel or a carbon material. Electrochemical modifiers are not considered PIXE impurities as they are a desired constituent of the carbon materials. For example, in some embodiments an element may be added to a carbon material as an electrochemical modifier and will not be considered a PIXE impurity, while in other embodiments the same element may not be a desired electrochemical modifier and, if present in the carbon material, will be considered a PIXE impurity. PIXE impurity concentrations and identities may be determined by proton induced x-ray emission (PIXE).

“Ultrapure” refers to a substance having a total PIXE impurity content of less than 0.050%. For example, an “ultrapure carbon material” is a carbon material having a total PIXE impurity content of less than 0.050% (i.e., 500 ppm).

“Ash content” refers to the nonvolatile inorganic matter which remains after subjecting a substance to a high decomposition temperature. Herein, the ash content of a carbon material is calculated from the total PIXE impurity content as measured by proton induced x-ray emission, assuming that nonvolatile elements are completely converted to expected combustion products (i.e., oxides).

“Polymer” refers to a macromolecule comprised of two or more structural repeating units.

“Synthetic polymer precursor material” or “polymer precursor” refers to compounds used in the preparation of a synthetic polymer. Examples of polymer precursors that can be used in certain embodiments of the preparations disclosed herein include, but are not limited to, aldehydes (i.e., HC(═O)R, where R is an organic group), such as for example, methanal (formaldehyde); ethanal (acetaldehyde); propanal (propionaldehyde); butanal (butyraldehyde); glucose; benzaldehyde and cinnamaldehyde. Other exemplary polymer precursors include, but are not limited to, phenolic compounds such as phenol and polyhydroxy benzenes, such as dihydroxy or trihydroxy benzenes, for example, resorcinol (i.e., 1,3-dihydroxy benzene), catechol, hydroquinone, and phloroglucinol. Mixtures of two or more polyhydroxy benzenes are also contemplated within the meaning of polymer precursor.

“Monolithic” refers to a solid, three-dimensional structure that is not particulate in nature.

“Sol” refers to a colloidal suspension of precursor particles (e.g., polymer precursors), and the term “gel” refers to a wet three-dimensional porous network obtained by condensation or reaction of the precursor particles.

“Polymer gel” refers to a gel in which the network component is a polymer; generally a polymer gel is a wet (aqueous or non-aqueous based) three-dimensional structure comprised of a polymer formed from synthetic precursors or polymer precursors.

“Sol gel” refers to a sub-class of polymer gel where the polymer is a colloidal suspension that forms a wet three-dimensional porous network obtained by reaction of the polymer precursors.

“Polymer hydrogel” or “hydrogel” refers to a subclass of polymer gel or gel wherein the solvent for the synthetic precursors or monomers is water or mixtures of water and one or more water-miscible solvent.

“Acid” refers to any substance that is capable of lowering the pH of a solution. Acids include Arrhenius, Brønsted and Lewis acids. A “solid acid” refers to a dried or granular compound that yields an acidic solution when dissolved in a solvent. The term “acidic” means having the properties of an acid.

“Base” refers to any substance that is capable of raising the pH of a solution. Bases include Arrhenius, Brønsted and Lewis bases. A “solid base” refers to a dried or granular compound that yields basic solution when dissolved in a solvent. The term “basic” means having the properties of a base.

“Miscible” refers to the property of a mixture wherein the mixture forms a single phase over certain ranges of temperature, pressure, and composition.

“Catalyst” is a substance which alters the rate of a chemical reaction. Catalysts participate in a reaction in a cyclic fashion such that the catalyst is cyclically regenerated. The present disclosure contemplates catalysts which are sodium free. The catalyst used in the preparation of a ultrapure polymer gel as described herein can be any compound that facilitates the polymerization of the polymer precursors to form an ultrapure polymer gel. A “volatile catalyst” is a catalyst which has a tendency to vaporize at or below atmospheric pressure. Exemplary volatile catalysts include, but are not limited to, ammoniums salts, such as ammonium bicarbonate, ammonium carbonate, ammonium hydroxide, and combinations thereof.

“Solvent” refers to a substance which dissolves or suspends reactants (e.g., ultrapure polymer precursors) and provides a medium in which a reaction may occur. Examples of solvents useful in the preparation of the gels, ultrapure polymer gels, ultrapure synthetic carbon materials and ultrapure synthetic amorphous carbon materials disclosed herein include, but are not limited to, water, alcohols and mixtures thereof. Exemplary alcohols include ethanol, t-butanol, methanol and mixtures thereof. Such solvents are useful for dissolution of the synthetic ultrapure polymer precursor materials, for example dissolution of a phenolic or aldehyde compound. In addition, in some processes such solvents are employed for solvent exchange in a polymer hydrogel (prior to freezing and drying), wherein the solvent from the polymerization of the precursors, for example, resorcinol and formaldehyde, is exchanged for a pure alcohol. In one embodiment of the present application, a cryogel is prepared by a process that does not include solvent exchange.

“Dried gel” or “dried polymer gel” refers to a gel or polymer gel, respectively, from which the solvent, generally water, or mixture of water and one or more water-miscible solvents, has been substantially removed.

“Pyrolyzed dried polymer gel” refers to a dried polymer gel which has been pyrolyzed but not yet activated, while an “activated dried polymer gel” refers to a dried polymer gel which has been activated.

“Carbonizing”, “pyrolyzing”, “carbonization” and “pyrolysis” each refer to the process of heating a carbon-containing substance at a pyrolysis dwell temperature in an inert atmosphere (e.g., argon, nitrogen or combinations thereof) or in a vacuum such that the targeted material collected at the end of the process is primarily carbon. “Pyrolyzed” refers to a material or substance, for example a carbon material, which has undergone the process of pyrolysis.

“Dwell temperature” refers to the temperature of the furnace during the portion of a process which is reserved for maintaining a relatively constant temperature (i.e., neither increasing nor decreasing the temperature). For example, the pyrolysis dwell temperature refers to the relatively constant temperature of the furnace during pyrolysis, and the activation dwell temperature refers to the relatively constant temperature of the furnace during activation.

“Pore” refers to an opening or depression in the surface, or a tunnel in a carbon material, such as for example activated carbon, pyrolyzed dried polymer gels, pyrolyzed polymer cryogels, pyrolyzed polymer xerogels, pyrolyzed polymer aerogels, activated dried polymer gels, activated polymer cryogels, activated polymer xerogels, activated polymer aerogels and the like. A pore can be a single tunnel or connected to other tunnels in a continuous network throughout the structure.

“Pore structure” refers to the layout of the surface of the internal pores within a carbon material, such as an activated carbon material. Components of the pore structure include pore size, pore volume, surface area, density, pore size distribution and pore length. Generally the pore structure of activated carbon material comprises micropores and mesopores.

“Pore volume” refers to the total volume of the carbon mass occupied by pores or empty volume. The pores may be either internal (not accessible by gas sorption) or external (accessible by gas sorption).

“Mesopore” generally refers to pores having a diameter between about 2 nanometers and about 50 nanometers while the term “micropore” refers to pores having a diameter less than about 2 nanometers. Mesoporous carbon materials comprise greater than 50% of their total pore volume in mesopores while microporous carbon materials comprise greater than 50% of their total pore volume in micropores.

“Surface area” refers to the total specific surface area of a substance measurable by the BET technique. Surface area is typically expressed in units of m²/g. The BET (Brunauer/Emmett/Teller) technique employs an inert gas, for example nitrogen, to measure the amount of gas adsorbed on a material and is commonly used in the art to determine the accessible surface area of materials.

“Electrode” refers to a conductor through which electricity enters or leaves an object, substance or region.

“Binder” refers to a material capable of holding individual particles of a substance (e.g., a carbon material) together such that after mixing a binder and the particles together the resulting mixture can be formed into sheets, pellets, disks or other shapes. Non-exclusive examples of binders include fluoro polymers, such as, for example, PTFE (polytetrafluoroethylene, Teflon), PFA (perfluoroalkoxy polymer resin, also known as Teflon), FEP (fluorinated ethylene propylene, also known as Teflon), ETFE (polyethylenetetrafluoroethylene, sold as Tefzel and Fluon), PVF (polyvinyl fluoride, sold as Tedlar), ECTFE (polyethylenechlorotrifluoroethylene, sold as Halar), PVDF (polyvinylidene fluoride, sold as Kynar), PCTFE (polychlorotrifluoroethylene, sold as Kel-F and CTFE), trifluoroethanol and combinations thereof.

“Inert” refers to a material that is not active in the electrolyte of an electrical energy storage device, that is it does not absorb a significant amount of ions or change chemically, e.g., degrade.

“Conductive” refers to the ability of a material to conduct electrons through transmission of loosely held valence electrons.

“Current collector” refers to a part of an electrical energy storage and/or distribution device which provides an electrical connection to facilitate the flow of electricity in to, or out of, the device. Current collectors often comprise metal and/or other conductive materials and may be used as a backing for electrodes to facilitate the flow of electricity to and from the electrode.

“Electrolyte” means a substance containing free ions such that the substance is electrically conductive. Electrolytes are commonly employed in electrical energy storage devices. Examples of electrolytes include, but are not limited to, solvents such as propylene carbonate, ethylene carbonate, butylene carbonate, dimethyl carbonate, methyl ethyl carbonate, diethyl carbonate, sulfolane, methylsulfolane, acetonitrile or mixtures thereof in combination with solutes such as tetralkylammonium salts such as LiPF₆ (lithium hexafluorophosphate), LiBOB (lithium bis(oxatlato)borate, TEA TFB (tetraethylammonium tetrafluoroborate), MTEATFB (methyltriethylammonium tetrafluoroborate), EMITFB (1-ethyl-3-methylimidazolium tetrafluoroborate), tetraethylammonium, triethylammonium based salts or mixtures thereof. In some embodiments, the electrolyte can be a water-based acid or water-based base electrolyte such as mild aqueous sulfuric acid or aqueous potassium hydroxide.

“Elemental form” refers to a chemical element having an oxidation state of zero (e.g., metallic lead).

“Oxidized form” form refers to a chemical element having an oxidation state greater than zero.

“Skeletal density” refers to the density of the material including internal porosity and excluding external porosity as measured by helium pycnometry.

“Lithium uptake” refers to a carbon's ability to intercalate, absorb, or store lithium as measured as a ratio between the maximum number of lithium atoms to 6 carbon atoms.

### A. Carbon Materials

As noted above, traditional lithium based energy storage devices comprise graphitic anode material. The disadvantages of graphitic carbon are numerous in lithium ion batteries. For one, the graphite undergoes a phase and volume change during battery operation. That is, the material physically expands and contracts when lithium is inserted between the graphene sheets while the individual sheets physically shift laterally to maintain a low energy storage state. Secondly, graphite has a low capacity. Given the ordered and crystalline structure of graphite, it takes six carbons to store one lithium ion. The structure is not able to accommodate additional lithium. Thirdly, the movement of lithium ions is restricted to a 2D plane, reducing the kinetics and the rate capability of the material in a battery. This means that graphite does not perform well at high rates where power is needed. This power disadvantage is one of the limiting factors for using lithium ion batteries in all-electric vehicles.

Although hard carbon anodes for lithium-based devices has been explored, these carbon materials are generally low purity and low surface area and the known devices still suffer from poor power performance and low first cycle efficiency. The presently disclosed hard carbon materials comprise properties which are optimized for use in lithium-based devices which exceed the performance characteristics of other known devices.

1. Hard Carbon Materials

As noted above, the present disclosure is directed to hard carbon materials useful as anode material in lithium-based (or sodium-based) and other electrical storage devices. While not wishing to be bound by theory, it is believed that the purity profile, surface area, porosity and other properties of the carbon materials are related, at least in part, to its preparation method, and variation of the preparation parameters may yield carbon materials having different properties. Accordingly, in some embodiments, the carbon material is a pyrolyzed dried polymer gel.

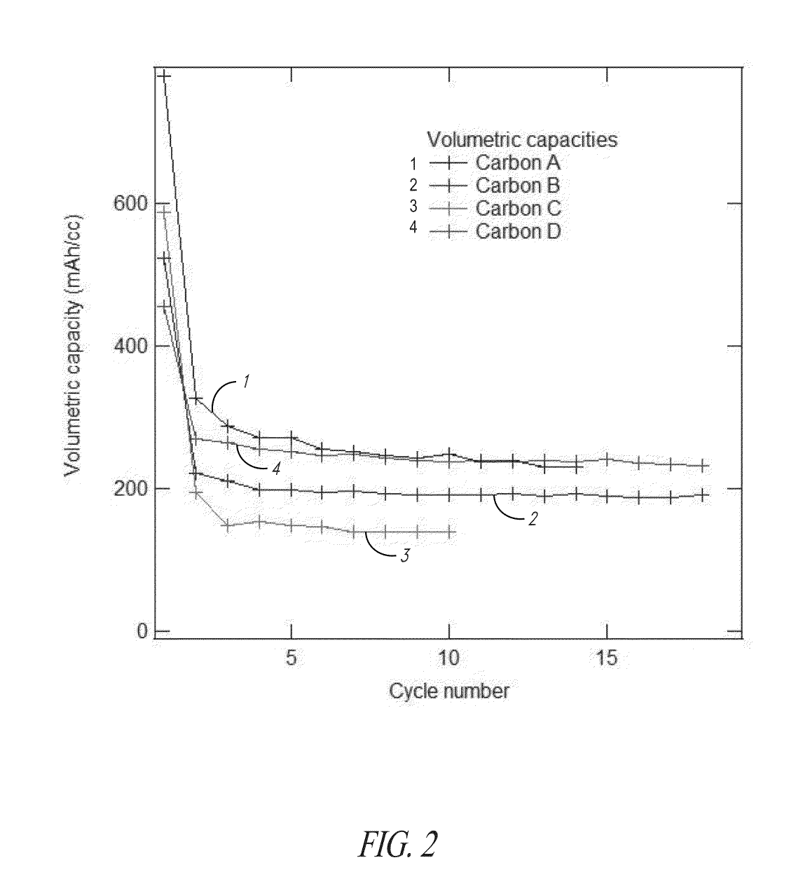

The disclosed carbon materials improve the properties of any number of electrical energy storage devices, for example the carbon materials have been shown to improve the first cycle efficiency of a lithium-based battery (see e.g., FIG. 2). Accordingly, one embodiment of the present disclosure provides a carbon material, wherein the carbon material has a first cycle efficiency of greater than 50% when the carbon material is incorporated into an electrode of a lithium based energy storage device, for example a lithium ion battery. For example, some embodiments provide a carbon material having a surface area of greater than 50 m²/g, wherein the carbon material has a first cycle efficiency of greater than 50% and a reversible capacity of at least 200 mAh/g when the carbon material is incorporated into an electrode of a lithium based energy storage device. In other embodiments, the first cycle efficiency is greater than 55%. In some other embodiments, the first cycle efficiency is greater than 60%. In yet other embodiments, the first cycle efficiency is greater than 65%. In still other embodiments, the first cycle efficiency is greater than 70%. In other embodiments, the first cycle efficiency is greater than 75%, and in other embodiments, the first cycle efficiency is greater than 80%, greater than 90%, greater than 95%, greater than 98%, or greater than 99%. In some embodiments of the foregoing, the carbon materials also comprise a surface area ranging from about 50 m²/g to about 400 m²/g or a pore volume ranging from about 0.05 to about 0.15 cc/g or both. For example, in some embodiments the surface area ranges from about 200 m²/g to about 300 m²/g or the surface area is about 250 m²/g.

The properties of the carbon material (e.g., first cycle efficiency, capacity, etc.) can be determined by incorporating into an electrode and testing electrochemically between upper and lower voltages of 3V and 20 mV, respectively. Alternatively, the carbon materials are tested at a current density of 40 mA/g with respect to the mass of carbon material.

The first cycle efficiency of the carbon anode material can be determined by comparing the lithium inserted into the anode during the first cycle to the lithium extracted from the anode on the first cycle. When the insertion and extraction are equal, the efficiency is 100%. As known in the art, the anode material can be tested in a half cell, where the counter electrode is lithium metal, the electrolyte is a 1M LiPF₆ 1:1 ethylene carbonate:diethylcarbonate (EC:DEC), using a commercial polypropylene separator.

In some embodiments, the operating voltage for the anode material ranges from about −20 mV to about 3 V versus lithium metal. In other embodiments, the operating voltage for the anode material ranges from about −20 mV to about 2 V versus lithium metal, from about −15 mV to about 1.5 V versus lithium metal, from about 0 V to about 3 V versus lithium metal, from about 0 V to about 2V versus lithium metal, or from about 0.05 V to about 1.5 V versus lithium metal.

In another embodiment the present disclosure provides a carbon material, wherein the carbon material has a volumetric capacity (i.e., reversible capacity) of at least 400 mAh/cc when the carbon material is incorporated into an electrode of a lithium based energy storage device, for example a lithium ion battery. In other embodiments, the volumetric capacity is at least 450 mAh/cc. In some other embodiments, the volumetric capacity is at least 500 mAh/cc. In yet other embodiments, the volumetric capacity is at least 550 mAh/cc. In still other embodiments, the volumetric capacity is at least 600 mAh/cc. In other embodiments, the volumetric capacity is at least 650 mAh/cc, and in other embodiments, the volumetric capacity is at least 700 mAh/cc.

In another embodiment the present disclosure provides a carbon material, wherein the carbon material has a gravimetric capacity (i.e., reversible capacity) of at least 150 mAh/g when the carbon material is incorporated into an electrode of a lithium based energy storage device, for example a lithium ion battery. In other embodiments, the gravimetric capacity is at least 200 mAh/g. In some other embodiments, the gravimetric capacity is at least 300 mAh/g. In yet other embodiments, the gravimetric capacity is at least 400 mAh/g. In still other embodiments, the gravimetric capacity is at least 500 mAh/g. In other embodiments, the gravimetric capacity is at least 600 mAh/g, and in other embodiments, the gravimetric capacity is at least 700 mAh/g, at least 800 mAh/g, at least 900 mAh/g, at least 1000 mAh/g, at least 1100 mAh/g or even at least 1200 mAh/g. In yet other embodiments, the gravimetric capacity is between 1200 and 3500 mAh/g. In some particular embodiments the carbon materials have a gravimetric capacity ranging from about 550 mAh/g to about 750 mAh/g. Certain examples of any of the above carbons may comprise an electrochemical modifier as described in more detail below.

The volumetric and gravimetric capacity can be determined through the use of any number of methods known in the art, for example by incorporating into an electrode half cell with lithium metal counter electrode in a coin cell. The gravimetric specific capacity is determined by dividing the measured capacity by the mass of the electrochemically active carbon materials. The volumetric specific capacity is determined by dividing the measured capacity by the volume of the electrode, including binder and conductivity additive. Methods for determining the volumetric and gravimetric capacity are described in more detail in the Examples.

Some of the capacity of the carbon may be due to surface loss/storage, structural intercalation or storage of lithium within the pores. Structural storage is defined as capacity inserted above 50 mV vs Li/Li while lithium pore storage is below 50 mV versus Li/Li⁺ but above the potential of lithium plating. In one embodiment, the storage capacity ratio of the carbon between structural intercalation and pore storage is between 1:10 and 10:1. In another embodiment, the storage capacity ratio of the carbon between structural intercalation and pore storage is between 1:5 and 1:10. In yet another embodiment, the storage capacity ratio of the carbon between structural intercalation and pore storage is between 1:2 and 1:4. In still yet another embodiment, the storage capacity of the carbon between structural intercalation and pore storage is between 1:1.5 and 1:2. In still another embodiment, the storage capacity ratio between structural intercalation and pore storage is 1:1. The ratio of capacity stored through intercalation may be greater than that of pore storage. In another embodiment, the storage capacity ratio of the carbon between structural intercalation and pore storage is between 10:1 and 5:1. In yet another embodiment, the storage capacity ratio of the carbon between structural intercalation and pore storage is between 2:1 and 4:1. In still yet another embodiment, the storage capacity ratio of the carbon between structural intercalation and pore storage is between 1.5:1 and 2:1.

The carbon may contain lithium metal, either through doping or through electrochemical cycling) in the pores of the carbon. Lithium plating within pores is seen as beneficial to both the capacity and cycling stability of the hard carbon. Plating within the pores can yield novel nanofiber lithium. In some cases lithium may be plated on the outside of the particle. External lithium plating is detrimental to the overall performance as explained in the examples. The presence of both internal and external lithium metal may be measured by cutting a material using a focused ion beam (FIB) and a scanning electron microscope (SEM). Metallic lithium is easily detected in contrast to hard carbon in an SEM. After cycling, and when the material has lithium inserted below 0V, the carbon may be sliced and imaged. In one embodiment the carbon displays lithium in the micropores. In another embodiment the carbon displays lithium in the mesopores. In still another embodiment, the carbon displays no lithium plating on the surface of the carbon. In yet still another embodiment carbon is stored in multiple pore sizes and shapes. The material shape and pore size distribution may uniquely and preferentially promote pore plating prior to surface plating. Ideal pore size for lithium storage is explained below.

Due to structural differences, lithium plating may occur at different voltages. The voltage of lithium plating is defined as when the voltage increases despite lithium insertion at a slow rate of 20 mA/g. In one embodiment the voltage of lithium plating of the carbon collected in a half-cell versus lithium metal at a current density of 20 mA/g is 0V. In another embodiment the voltage of lithium plating of the carbon collected in a half-cell versus lithium metal at a current density of 20 mA/g is between 0V and −5 mV. In yet another embodiment the voltage of lithium plating of the carbon collected in a half-cell versus lithium metal at a current density of 20 mA/g is between −5 mV and −10 mV. In still yet another embodiment the voltage of lithium plating of the carbon collected in a half-cell versus lithium metal at a current density of 20 mA/g is between −10 mV and −15 mV. In still another embodiment the voltage of lithium plating of the carbon collected in a half-cell versus lithium metal at a current density of 20 mA/g is between −15 mV and −20 mV. In yet another embodiment the voltage of lithium plating of the carbon collected in a half-cell versus lithium metal at a current density of 20 mA/g is below −20 mV. In yet another embodiment the voltage of lithium plating of the carbon collected in a half-cell versus lithium metal at a current density of 20 mA/g is below −40 mV.

In some embodiments of the foregoing, the carbon materials also comprise a surface area ranging from about 50 m²/g to about 400 m²/g or a pore volume of at least about 0.1 cc/g or both. For example, in some embodiments the surface area ranges from about 200 m²/g to about 300 m²/g or about 250 m²/g. In other embodiments, the pore volume ranges from about 0.1 to about 0.6 cc/g.

In still other embodiments the present disclosure provides a carbon material, wherein when the carbon material is incorporated into an electrode of a lithium based energy storage device the carbon material has a volumetric capacity at least 10% greater than when the lithium based energy storage device comprises a graphite electrode. In some embodiments, the lithium based energy storage device is a lithium ion battery. In other embodiments, the carbon material has a volumetric capacity in a lithium based energy storage device that is at least 5% greater, at least 10% greater, at least 15% greater than the volumetric capacity of the same electrical energy storage device having a graphite electrode. In still other embodiments, the carbon material has a volumetric capacity in a lithium based energy storage device that is at least 20% greater, at least 30% greater, at least 40% greater, at least 50% greater, at least 200% greater, at least 100% greater or at least 150% greater than the volumetric capacity of the same electrical energy storage device having a graphite electrode.

While not wishing to be bound by theory, the present applicants believe the superior properties of the disclosed carbon materials is related, at least in part, to its unique properties such as surface area, purity, pore structure, crystallinity and surface chemistry, etc. For example, in some embodiments the specific surface area (as measured by BET analysis) of the carbon materials may be low (<300 m²/g), medium (from about 300 m²/g to about 1000 m²/g) or high (>1000 m²/g) or have a surface area that spans one or more of these ranges. For example, in some embodiments the surface area ranges from about 50 m²/g to about 1200 m²/g for example from about 50 m²/g to about 400 m²/g. In other particular embodiments, the surface area ranges from about 200 m²/g to about 300 m²/g for example the surface area may be about 250 m²/g.

In some embodiments, the specific surface area is less than about 100 m²/g. In other embodiments, the specific surface area is less than about 50 m²/g. In other embodiments, the specific surface area is less than about 20 m²/g. In other embodiments, the specific surface area is less than about 10 m²/g. In other embodiments, the specific surface area is less than about 5 m²/g.

In some embodiments the surface area ranges from about 1 m²/g to about 200 m²/g. In some other embodiments the surface area ranges from about 100 m²/g to about 200 m²/g. In yet other embodiments the surface area ranges from about 1 m²/g to about 20 m²/g, for example from about 2 m²/g to about 15 m²/g. While not limiting in any way, some embodiments which comprise a surface area ranging from about 50 m²/g to about 1200 m²/g for example from about 50 m²/g to about 400 m²/g have also been found to have good first cycle efficiency (e.g., >50%).

Other embodiments include carbon materials comprising medium surface area (from 300 to 1000 m²/g). In some embodiments the surface area ranges from about 300 m²/g to about 800 m²/g. In some other embodiments the surface area ranges from about 300 m²/g to about 400 m²/g. In yet other embodiments the surface area ranges from about 400 m²/g to about 500 m²/g. In yet other embodiments the surface area ranges from about 500 m²/g to about 600 m²/g. In yet other embodiments the surface area ranges from about 600 m²/g to about 700 m²/g.

In yet other embodiments the surface area ranges from about 700 m²/g to about 800 m²/g. In yet other embodiments the surface area ranges from about 800 m²/g to about 900 m²/g. In yet other embodiments the surface area ranges from about 900 m²/g to about 1000 m²/g. Certain embodiments which comprise medium surface area have been found to have high gravimetric capacity (e.g., >500 mAh/g).

In still other embodiments, the carbon materials comprise high surface area (>1000 m²/g). In some embodiments the surface area ranges from about 1000 m²/g to about 3000 m²/g. In some other embodiments the surface area ranges from about 1000 m²/g to about 2000 m²/g. Certain embodiments which comprise high surface area have been found to have high gravimetric capacity (e.g., >500 mAh/g).

The surface area may be modified through activation. The activation method may use steam, chemical activation, CO2 or other gasses. Methods for activation of carbon material are well known in the art.

The carbon material may be doped with lithium atoms, wherein the lithium is in ionic form and not in the form of lithium metal. These lithium atoms may or may not be able to be separated from the carbon. The number of lithium atoms to 6 carbon atoms can be calculated by techniques known to those familiar with the art:

#Li=Q×3.6×MM/(C %×F)

Wherein Q is the lithium extraction capacity measured in mAh/g between the voltages of 5 mV and 2.0V versus lithium metal, MM is 72 or the molecular mass of 6 carbons, F is Faraday's constant of 96500, C % is the mass percent carbon present in the structure as measured by CHNO or XPS.

The material can be characterized by the ratio of lithium atoms to carbon atoms (Li:C) which may vary between about 0:6 and 2:6. In some embodiments the Li:C ratio is between about 0.05:6 and about 1.9:6. In other embodiments the maximum Li:C ratio wherein the lithium is in ionic and not metallic form is 2.2:6. In certain other embodiments, the Li:C ratio ranges from about 1.2:6 to about 2:6, from about 1.3:6 to about 1.9:6, from about 1.4:6 to about 1.9:6, from about 1.6:6 to about 1.8:6 or from about 1.7:6 to about 1.8:6. In other embodiments, the Li:C ratio is greater than 1:6, greater than 1.2:6, greater than 1.4:6, greater than 1.6:6 or even greater than 1.8:6. In even other embodiments, the Li:C ratio is about 1.4:6, about 1.5:6, about 1.6:6, about 1.6:6, about 1.7:6, about 1.8:6 or about 2:6. In a specific embodiment the Li:C ratio is about 1.78:6.

In certain other embodiments, the carbon materials comprise an Li:C ratio ranging from about 1:6 to about 2.5:6, from about 1.4:6 to about 2.2:6 or from about 1.4:6 to about 2:6. In still other embodiments, the carbon materials may not necessarily include lithium, but instead have a lithium uptake capacity (i.e., the capability to uptake a certain quantity of lithium). While not wishing to be bound by theory, it is believed the lithium uptake capacity of the carbon materials contributes to their superior performance in lithium based energy storage devices. The lithium uptake capacity is expressed as a ratio of the atoms of lithium taken up by the carbon per atom of carbon. In certain other embodiments, the carbon materials comprise a lithium uptake capacity ranging from about 1:6 to about 2.5:6, from about 1.4:6 to about 2.2:6 or from about 1.4:6 to about 2:6.

In certain other embodiments, the lithium uptake capacity ranges from about 1.2:6 to about 2:6, from about 1.3:6 to about 1.9:6, from about 1.4:6 to about 1.9:6, from about 1.6:6 to about 1.8:6 or from about 1.7:6 to about 1.8:6. In other embodiments, the lithium uptake capacity is greater than 1:6, greater than 1.2:6, greater than 1.4:6, greater than 1.6:6 or even greater than 1.8:6. In even other embodiments, the Li:C ratio is about 1.4:6, about 1.5:6, about 1.6:6, about 1.6:6, about 1.7:6, about 1.8:6 or about 2:6. In a specific embodiment the Li:C ratio is about 1.78:6.

Different methods of doping may include chemical reactions, electrochemical reactions, physical mixing of particles, gas phase reactions, solid phase reactions, liquid phase reactions.

In other embodiments the lithium is in the form of lithium metal.

Since the total pore volume may partially relate to the storage of lithium ions, the internal ionic kinetics, as well as the available carbon/electrolyte surfaces capable of charge-transfer, this is one parameter that can be adjusted to obtain the desired electrochemical properties. Some embodiments include carbon materials having low total pore volume (e.g., less than about 0.1 cc/g). In one embodiment, the total pore volume of the carbon materials is less than about 0.01 cc/g. In another embodiment, the total pore volume of the carbon materials is less than about 0.001 cc/g. In yet another embodiment, the total pore volume of the carbon materials is less than about 0.0001 cc/g.

In one embodiment, the total pore volume of the carbon materials ranges from about 0.00001 cc/g to about 0.1 cc/g, for example from about 0.0001 cc/g to about 0.01 cc/g. In some other embodiments, the total pore volume of the carbon materials ranges from about 0.001 cc/g to about 0.01 cc/g.

In other embodiments, the carbon materials comprise a total pore volume ranging greater than or equal to 0.1 cc/g, and in other embodiments the carbon materials comprise a total pore volume less than or equal to 0.6 cc/g. In other embodiments, the carbon materials comprise a total pore volume ranging from about 0.1 cc/g to about 0.6 cc/g. In some other embodiments, the total pore volume of the carbon materials ranges from about 0.1 cc/g to about 0.2 cc/g. In some other embodiments, the total pore volume of the carbon materials ranges from about 0.2 cc/g to about 0.3 cc/g. In some other embodiments, the total pore volume of the carbon materials ranges from about 0.3 cc/g to about 0.4 cc/g. In some other embodiments, the total pore volume of the carbon materials ranges from about 0.4 cc/g to about 0.5 cc/g. In some other embodiments, the total pore volume of the carbon materials ranges from about 0.5 cc/g to about 0.6 cc/g.

The present invention also includes hard carbon materials having high total pore volume, for example greater than 0.6 cc/g. In some other embodiments, the total pore volume of the carbon materials ranges from about 0.6 cc/g to about 2.0 cc/g. In some other embodiments, the total pore volume of the carbon materials ranges from about 0.6 cc/g to about 1.0 cc/g. In some other embodiments, the total pore volume of the carbon materials ranges from about 1.0 cc/g to about 1.5 cc/g. In some other embodiments, the total pore volume of the carbon materials ranges from about 1.5 cc/g to about 2.0 cc/g.

The carbon materials may comprise a majority (e.g., >50%) of the total pore volume residing in pores of certain diameter. For example, in some embodiments greater than 50%, greater than 60%, greater than 70%, greater than 80%, greater than 90% or even greater than 95% of the total pore volume resides in pores having a diameter of 1 nm or less. In other embodiments greater than 50%, greater than 60%, greater than 70%, greater than 80%, greater than 90% or even greater than 95% of the total pore volume resides in pores having a diameter of 100 nm or less. In other embodiments greater than 50%, greater than 60%, greater than 70%, greater than 80%, greater than 90% or even greater than 95% of the total pore volume resides in pores having a diameter of 0.5 nm or less.

In some embodiments, the tap density of the carbon materials may be predictive of their electrochemical performance, for example the volumetric capacity. While not limiting in any way, the pore volume of a carbon material may be related to its tap density and carbons having low pore volume are sometimes found to have high tap density (and vice versa). Accordingly, carbon materials having low tap density (e.g., <0.3 g/cc), medium tap density (e.g., from 0.3 to 0.5 g/cc) or high tap density (e.g., >0.5 g/cc) are provided.

In yet some other embodiments, the carbon materials comprise a tap density greater than or equal to 0.3 g/cc. In yet some other embodiments, the carbon materials comprise a tap density ranging from about 0.3 g/cc to about 0.5 g/cc. In some embodiments, the carbon materials comprise a tap density ranging from about 0.35 g/cc to about 0.45 g/cc. In some other embodiments, the carbon materials comprise a tap density ranging from about 0.30 g/cc to about 0.40 g/cc. In some embodiments, the carbon materials comprise a tap density ranging from about 0.40 g/cc to about 0.50 g/cc. In some embodiments of the foregoing, the carbon materials comprise a medium total pore volume (e.g., from about 0.1 cc/g to about 0.6 cc/g).

In yet some other embodiments, the carbon materials comprise a tap density greater than about 0.5 g/cc. In some other embodiments, the carbon materials comprise a tap density ranging from about 0.5 g/cc to about 2.0 g/cc. In some other embodiments, the carbon materials comprise a tap density ranging from about 0.5 g/cc to about 1.0 g/cc. In some embodiments, the carbon materials comprise a tap density ranging from about 0.5 g/cc to about 0.75 g/cc. In some embodiments, the carbon materials comprise a tap density ranging from about 0.75 g/cc to about 1.0 g/cc, for example from about 0.75 g/cc to about 0.95 g/cc. In some embodiments of the foregoing, the carbon materials comprise a low, medium or high total pore volume.

The density of the carbon materials can also be characterized by their skeletal density as measured by helium pycnometry. In certain embodiments, the skeletal density of the carbon materials ranges from about 1 g/cc to about 3 g/cc, for example from about 1.5 g/cc to about 2.3 g/cc. In other embodiments, the skeletal density ranges from about 1.5 cc/g to about 1.6 cc/g, from about 1.6 cc/g to about 1.7 cc/g, from about 1.7 cc/g to about 1.8 cc/g, from about 1.8 cc/g to about 1.9 cc/g, from about 1.9 cc/g to about 2.0 cc/g, from about 2.0 cc/g to about 2.1 cc/g, from about 2.1 cc/g to about 2.2 cc/g or from about 2.2 cc/g to about 2.3 cc/g.

As discussed in more detail below, the surface functionality of the presently disclosed carbon materials may be altered to obtain the desired electrochemical properties. One property which can be predictive of surface functionality is the pH of the carbon materials. The presently disclosed carbon materials comprise pH values ranging from less than 1 to about 14, for example less than 5, from 5 to 8 or greater than 8. In some embodiments, the pH of the carbon materials is less than 4, less than 3, less than 2 or even less than 1. In other embodiments, the pH of the carbon materials is between about 5 and 6, between about 6 and 7, between about 7 and 8 or between 8 and 9 or between 9 and 10. In still other embodiments, the pH is high and the pH of the carbon materials ranges is greater than 8, greater than 9, greater than 10, greater than 11, greater than 12, or even greater than 13.

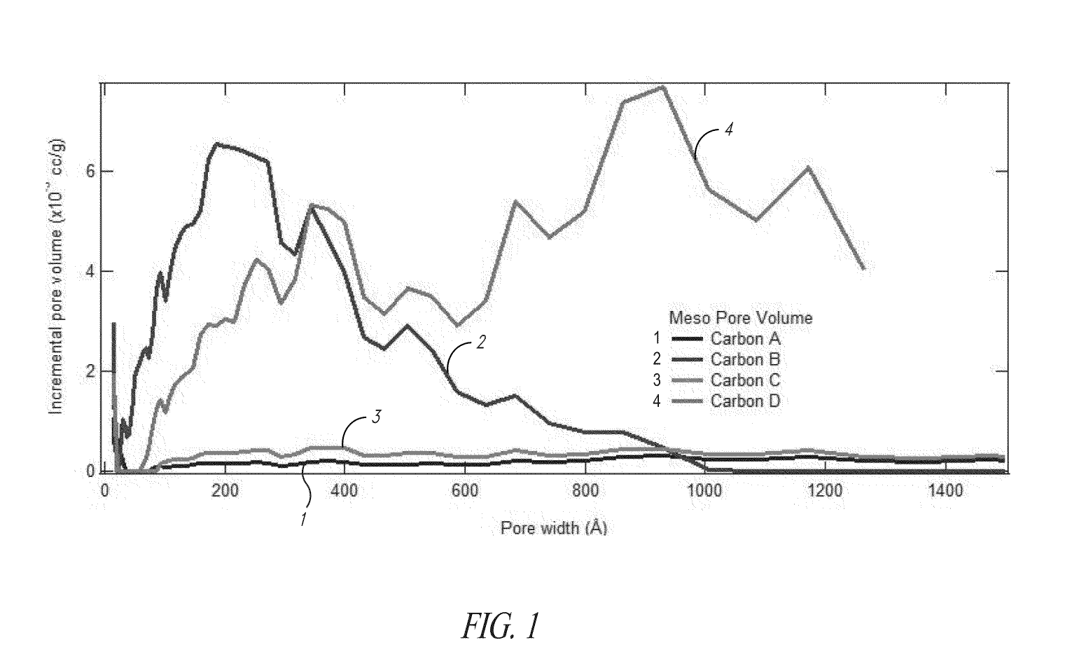

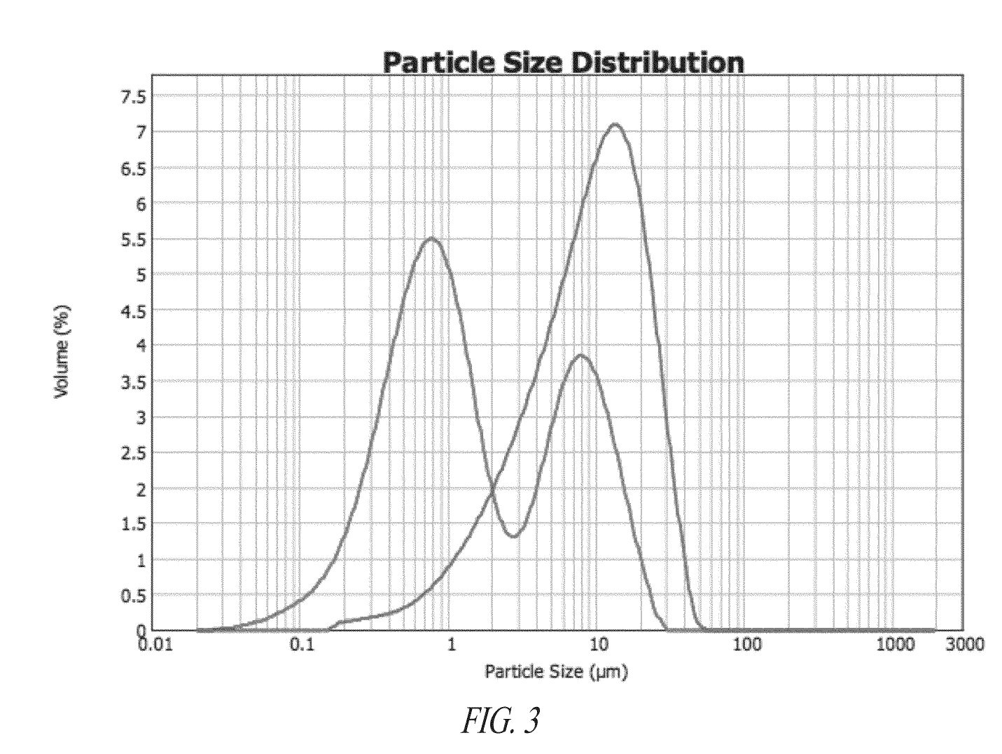

Pore size distribution may be important to both the storage capacity of the material and the kinetics and power capability of the system. The poor size distribution can range from micro to meso to macro (see e.g., FIG. 1) and may be either monomodal, bimodal or multimodal (i.e., may comprise one or more different distribution of pore sizes, see e.g., FIG. 3). Micropores, with average pore sizes less than 1 nm, may create additional storage sites as well as lithium (or sodium) ion diffusion paths. Graphite sheets typically are spaced 0.33 nm apart for lithium storage. While not wishing to be bound by theory, it is thought that large quantities of pores of similar size may yield graphite-like structures within pores with additional hard carbon-type storage in the bulk structure. Mesopores are typically below 100 nm. These pores are ideal locations for nano particle dopants, such as metals, and provide pathways for both conductive additive and electrolyte for ion and electron conduction. In some embodiments the carbon materials comprise macropores greater than 100 nm which may be especially suited for large particle doping.

Accordingly, in one embodiment, the carbon material comprises a fractional pore volume of pores at or below 1 nm that comprises at least 50% of the total pore volume, at least 75% of the total pore volume, at least 90% of the total pore volume or at least 99% of the total pore volume. In other embodiments, the carbon material comprises a fractional pore volume of pores at or below 10 nm that comprises at least 50% of the total pore volume, at least 75% of the total pore volume, at least 90% of the total pore volume or at least 99% of the total pore volume. In other embodiments, the carbon material comprises a fractional pore volume of pores at or below 50 nm that comprises at least 50% of the total pore volume, at least 75% of the total pore volume, at least 90% of the total pore volume or at least 99% of the total pore volume.

In another embodiment, the carbon material comprises a fractional pore surface area of pores at or below 100 nm that comprises at least 50% of the total pore surface area, at least 75% of the total pore surface area, at least 90% of the total pore surface area or at least 99% of the total pore surface area. In another embodiment, the carbon material comprises a fractional pore surface area of pores at or greater than 100 nm that comprises at least 50% of the total pore surface area, at least 75% of the total pore surface area, at least 90% of the total pore surface area or at least 99% of the total pore surface area.

In another embodiment, the carbon material comprises pores predominantly in the range of 100 nm or lower, for example 10 nm or lower, for example 5 nm or lower. Alternatively, the carbon material comprises micropores in the range of 0-2 nm and mesopores in the range of 2-100 nm. The ratio of pore volume or pore surface in the micropore range compared to the mesopore range can be in the range of 95:5 to 5:95.

In some embodiments, the median particle diameter for the carbon materials ranges from 1 to 1000 microns. In other embodiments the median particle diameter for the carbon materials ranges from 1 to 100 microns. Still in other embodiments the median particle diameter for the carbon materials ranges from 1 to 50 microns. Yet in other embodiments, the median particle diameter for the carbon materials ranges from 5 to 15 microns or from 1 to 5 microns. Still in other embodiments, the median particle diameter for the carbon materials is about 10 microns. Still in other embodiments, the median particle diameter for the carbon materials is less than 4, is less than 3, is less than 2, is less than 1 microns.

In some embodiments, the carbon materials exhibit a median particle diameter ranging from 1 micron to 5 microns. In other embodiments, the median particle diameter ranges from 5 microns to 10 microns. In yet other embodiments, the median particle diameter ranges from 10 nm to 20 microns. Still in other embodiments, the median particle diameter ranges from 20 nm to 30 microns. Yet still in other embodiments, the median particle diameter ranges from 30 microns to 40 microns. Yet still in other embodiments, the median particle diameter ranges from 40 microns to 50 microns. In other embodiments, the median particle diameter ranges from 50 microns to 100 microns. In other embodiments, the median particle diameter ranges in the submicron range <1 micron.

In other embodiments, the carbon materials are microporous (e.g., greater than 50% of pores less than 1 nm) and comprise monodisperse micropores. For example in some embodiments the carbon materials are microporous, and (Dv90−Dv10)/Dv50, where Dv10, Dv50 and Dv90 refer to the pore size at 10%, 50% and 90% of the distribution by volume, is about 3 or less, typically about 2 or less, often about 1.5 or less.

In other embodiments, the carbon materials are mesoporous (e.g., greater than 50% of pores less than 100 nm) and comprise monodisperse mesopores. For example in some embodiments, the carbon materials are mesoporous and (Dv90−Dv10)/Dv50, where Dv10, Dv50 and Dv90 refer to the pore size at 10%, 50% and 90% of the distribution by volume, is about 3 or less, typically about 2 or less, often about 1.5 or less.

In other embodiments, the carbon materials are macroporous (e.g., greater than 50% of pores greater than 100 nm) and comprise monodisperse macropores. For example in some embodiments, the carbon materials are macroporous and (Dv90−Dv10)/Dv50, where Dv10, Dv50 and Dv90 refer to the pore size at 10%, 50% and 90% of the distribution by volume, is about 3 or less, typically about 2 or less, often about 1.5 or less.

In some other embodiments, the carbon materials have a bimodal pore size distribution. For example, the carbon materials may comprise a population of micropores and a population of mesopores. In some embodiments, the ratio of micropores to mesopores ranges from about 1:10 to about 10:1, for example from about 1:3 to about 3:1.

In some embodiments, the carbon materials comprise pores having a peak height found in the pore volume distribution ranging from 0.1 nm to 0.25 nm. In other embodiments, the peak height found in the pore volume distribution ranges from 0.25 nm to 0.50 nm. Yet in other embodiments, the peak height found in the pore volume distribution ranges from 0.75 nm to 1.0 nm. Still in other embodiments, the peak height found in the pore volume distribution ranges from 0.1 nm to 0.50 nm. Yet still in other embodiments, the peak height found in the pore volume distribution ranges from 0.50 nm to 1.0 nm.

In some embodiments, the carbon materials comprise pores having a peak height found in the pore volume distribution ranging from 2 nm to 10 nm. In other embodiments, the peak height found in the pore volume distribution ranges from 10 nm to 20 nm. Yet in other embodiments, the peak height found in the pore volume distribution ranges from 20 nm to 30 nm. Still in other embodiments, the peak height found in the pore volume distribution ranges from 30 nm to 40 nm. Yet still in other embodiments, the peak height found in the pore volume distribution ranges from 40 nm to 50 nm. In other embodiments, the peak height found in the pore volume distribution ranges from 50 nm to 100 nm.

The present inventors have found that the extent of disorder in the carbon materials may have an impact on the electrochemical properties of the carbon materials. For example, the data in Table 4 (see Examples) shows a possible trend between the available lithium sites for insertion and the range of disorder/crystallite size. Thus controlling the extent of disorder in the carbon materials provides a possible avenue to improve the rate capability for carbons since a smaller crystallite size may allow for lower resistive lithium ion diffusion through the amorphous structure. The present invention includes embodiments which comprise both high and low levels of disorder.

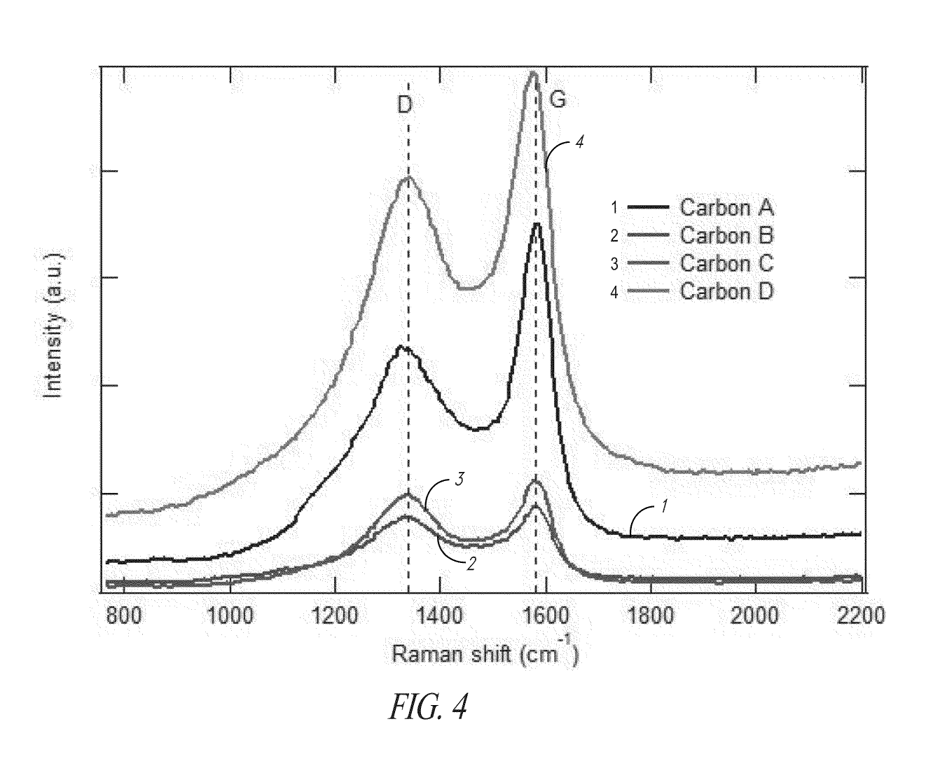

Disorder, as recorded by RAMAN spectroscopy, is a measure of the size of the crystallites found within both amorphous and crystalline structures (M. A. Pimenta, G. Dresselhaus, M. S. Dresselhaus, L. G. Can ado, A. Jorio, and R. Saito, “Studying disorder in graphite-based systems by Raman spectroscopy,” Physical Chemistry Chemical Physics, vol. 9, no. 11, p. 1276, 2007). RAMAN spectra of exemplary carbon are shown in FIG. 4. For carbon structures, crystallite sizes (Lₐ) can be calculated from the relative peak intensities of the D and G Raman shifts (Eq 1)

Lₐ(nm)=(2.4×10⁻¹⁰)λ⁴ₗₐₛₑᵣR⁻¹ (1)

where

R═I_{D}/I_{G} (2)

The values for R and Lₐ can vary in certain embodiments, and their value may affect the electrochemical properties of the carbon materials, for example the capacity of the 2^{nd} lithium insertion (2^{nd} lithium insertion is related to first cycle efficiency since first cycle efficiency=(capacity at 1^{st} lithium insertion/capacity at 2^{nd} lithium insertion)×100). For example, in some embodiments R ranges from about 0 to about 1 or from about 0.50 to about 0.95. In other embodiments, R ranges from about 0.60 to about 0.90. In other embodiments, R ranges from about 0.80 to about 0.90. Lₐ also varies in certain embodiments and can range from about 1 nm to about 500 nm. In certain other embodiments, La ranges from about 5 nm to about 100 nm or from about 10 to about 50 nm. In other embodiments, La ranges from about 15 nm to about 30 nm, for example from about 20 to about 30 nm or from about 25 to 30 nm.

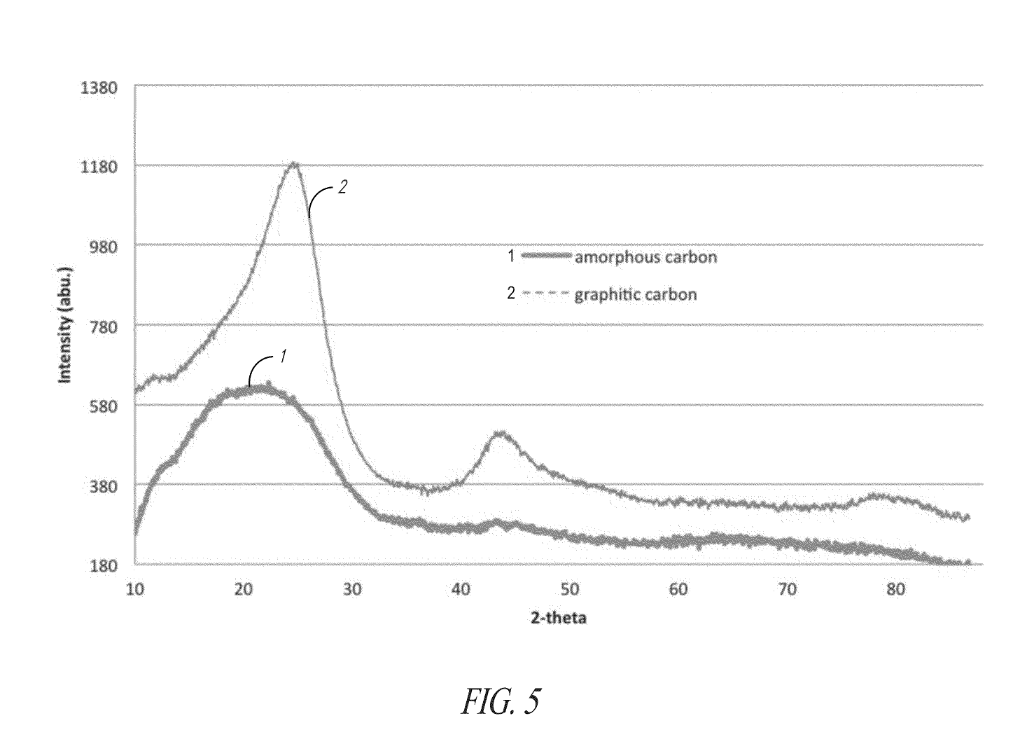

In a related embodiment, the electrochemical properties of the carbon materials are related to the level of crystallinity as measured by X-ray diffraction (XRD). While Raman measures the size of the crystallites, XRD records the level of periodicity in the bulk structure through the scattering of incident X-rays (see e.g., FIG. 5). The present invention includes materials that are non-graphitic (crystallinity <10%) and semi-graphitic (crystallinity between 10 and 50%). The crystallinity of the carbon materials ranges from about 0% to about 99%. In some embodiments, the carbon materials comprise less than 10% crystallinity, less than 5% crystallinity or even less than 1% crystallinity (i.e., highly amorphous). In other embodiments, the carbon materials comprise from 10% to 50% crystallinity. In still other embodiments, the carbon materials comprise less than 50% crystallinity, less than 40% crystallinity, less than 30% crystallinity or even less than 20% crystallinity.

In a related embodiment, the electrochemical performance of the carbon materials are related to the empirical values, R, as calculated from Small Angle X-ray Diffraction (SAXS), wherein R=B/A and B is the height of the double layer peak and A is the baseline for the single graphene sheet as measured by SAXS.

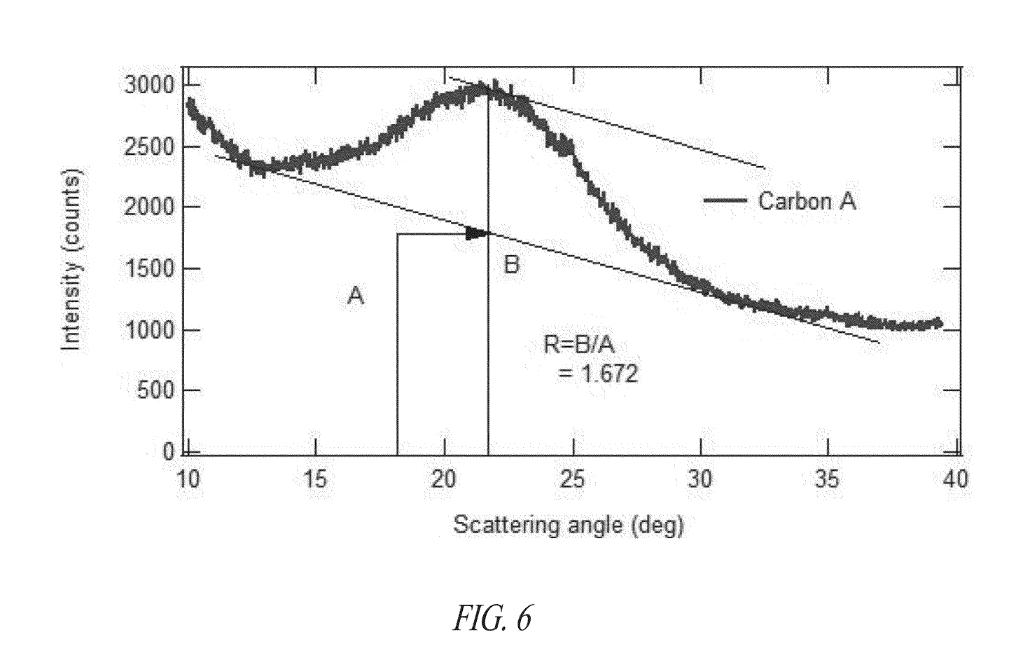

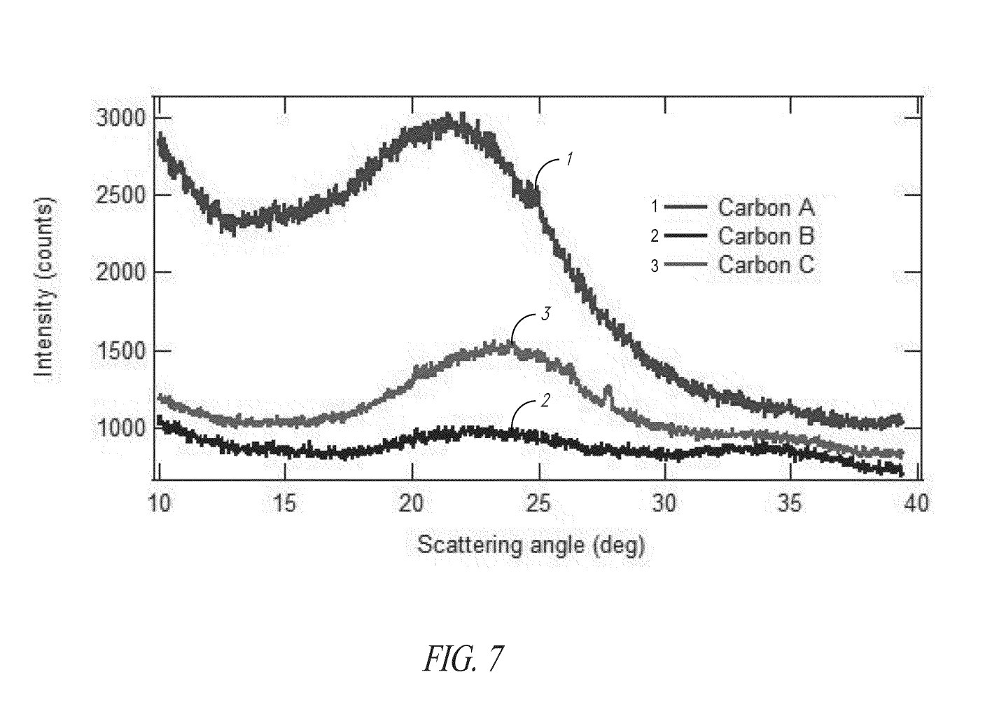

SAXS has the ability to measure internal pores, perhaps inaccessible by gas adsorption techniques but capable of lithium storage. In certain embodiments, the R factor is below 1, comprising single layers of graphene. In other embodiments, the R factor ranges from about 0.1 to about 20 or from about 1 to 10. In yet other embodiments, the R factor ranges from 1 to 5, from 1 to 2, or from 1.5 to 2. In still other embodiments, the R factor ranges from 1.5 to 5, from 1.75 to 3, or from 2 to 2.5. Alternatively, the R factor is greater than 10. The SAXS pattern may also be analyzed by the number of peaks found between 10° and 40°. In some embodiments, the number of peaks found by SAXS at low scattering angles are 1, 2, 3, or even more than 3. FIGS. 6 and 7 present representative SAXS plots.

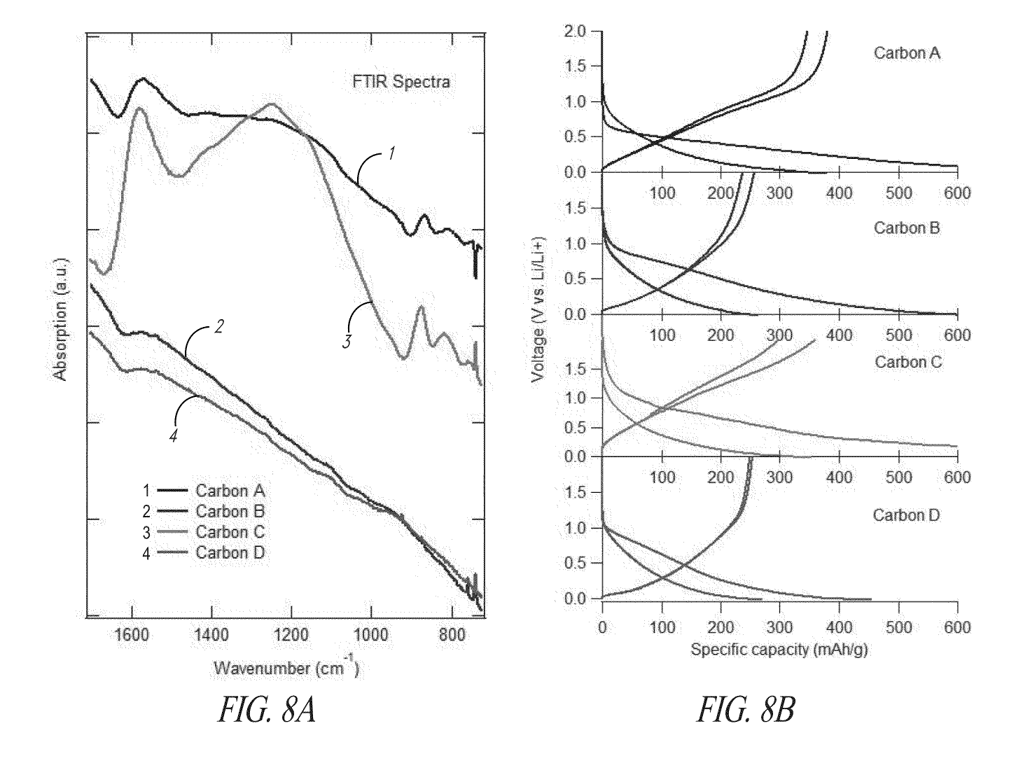

In certain embodiments, the organic content of the carbon materials can be manipulated to provide the desired properties, for example by contacting the carbon materials with a hydrocarbon compound such as cyclohexane and the like. Infra-red spectroscopy (FTIR) can be used as a metric to determine the organic content of both surface and bulk structures of the carbon materials (see e.g., FIG. 8A.). In one embodiment, the carbon materials comprise essentially no organic material. An FTIR spectra which is essentially featureless is indicative of such embodiments (e.g., carbons B and D). In other embodiments, the carbon materials comprise organic material, either on the surface or within the bulk structure. In such embodiments, the FTIR spectra generally depict large hills and valleys which indicates the presence of organic content.

The organic content may have a direct relationship to the electrochemical performance (FIG. 8b) and response of the material when placed into a lithium bearing device for energy storage. Carbon materials with flat FTIR signals (no organics) often display a low extraction peak in the voltage profile at 0.2 V. Well known to the art, the extract voltage is typical of lithium stripping. In certain embodiments, the carbon materials comprise organic content and the lithium stripping plateau is absent or near absent.

The carbon materials may also comprise varying amounts of carbon, oxygen, hydrogen and nitrogen as measured by gas chromatography CHNO analysis. In one embodiment, the carbon content is greater than 98 wt. % or even greater than 99.9 wt % as measured by CHNO analysis. In another embodiment, the carbon content ranges from about 10 wt % to about 99.9%, for example from about 50 to about 98 wt. % of the total mass. In yet other embodiments, the carbon content ranges 90 to 98 wt. %, 92 to 98 wt % or greater than 95% of the total mass. In yet other embodiments, the carbon content ranges from 80 to 90 wt. % of the total mass. In yet other embodiments, the carbon content ranges from 70 to 80 wt. % of the total mass. In yet other embodiments, the carbon content ranges from 60 to 70 wt. % of the total mass.

In another embodiment, the nitrogen content ranges from 0 to 90 wt. % based on total mass of all components in the carbon material as measured by CHNO analysis. In another embodiment, the nitrogen content ranges from 1 to 10 wt. % of the total mass. In yet other embodiments, the nitrogen content ranges from 10 to 20 wt. % of the total mass. In yet other embodiments, the nitrogen content ranges from 20 to 30 wt. % of the total mass. In another embodiment, the nitrogen content is greater than 30 wt. %.

In still other embodiments, the nitrogen content is greater than 1% or ranges from about 1% to about 20%. In some more specific embodiments, the nitrogen content ranges from about 1% to about 6%, while in other embodiments, the nitrogen content ranges from about 0.1% to about 1%. In certain of the above embodiments, the nitrogen content is based on weight relative to total weight of all components in the carbon material

The carbon and nitrogen content may also be measured as a ratio of C:N (carbon atoms to nitrogen atoms). In one embodiment, the C:N ratio ranges from 1:0.001 to 0.001:1 or from 1:0.001 to 1:1. In another embodiment, the C:N ratio ranges from 1:0.001 to 1:0.01. In yet another embodiment, the C:N ratio ranges from 1:0.01 to 1:1. In yet another embodiment, the content of nitrogen exceeds the content of carbon, for example the C:N ratio can range from about 0.01:1 to about 0.1:1 or from 0.1:1 to about 0.5:1.

The carbon materials may also comprise varying amounts of carbon, oxygen, nitrogen, Cl, and Na, to name a few, as measured by XPS analysis. In one embodiment, the carbon content is greater than 98 wt. % as measured by XPS analysis. In another embodiment, the carbon content ranges from 50 to 98 wt. % of the total mass. In yet other embodiments, the carbon content ranges 90 to 98 wt. % of the total mass. In yet other embodiments, the carbon content ranges from 80 to 90 wt. % of the total mass. In yet other embodiments, the carbon content ranges from 70 to 80 wt. % of the total mass. In yet other embodiments, the carbon content ranges from 60 to 70 wt. % of the total mass.

In other embodiments, the carbon content ranges from 10% to 99.9%, from 10% to 99%, from 10% to 98%, from 50% to 99.9%, from 50% to 99%, from 50% to 98%, from 75% to 99.9%, from 75% to 99% or from 75% to 98% of the total mass of all components in the carbon material as measured by XPS analysis

In another embodiment, the nitrogen content ranges from 0 to 90 wt. % as measured by XPS analysis. In another embodiment, the nitrogen content ranges from 1 to 75 wt. % of the total mass. In another embodiment, the nitrogen content ranges from 1 to 50 wt. % of the total mass. In another embodiment, the nitrogen content ranges from 1 to 25 wt. % of the total mass. In another embodiment, the nitrogen content ranges from 1 to 20 wt. % of the total mass. In another embodiment, the nitrogen content ranges from 1 to 10 wt. % of the total mass. In another embodiment, the nitrogen content ranges from 1 to 6 wt. % of the total mass. In yet other embodiments, the nitrogen content ranges from 10 to 20 wt. % of the total mass. In yet other embodiments, the nitrogen content ranges from 20 to 30 wt. % of the total mass. In another embodiment, the nitrogen content is greater than 30 wt. %.

The carbon and nitrogen content may also be measured as a ratio of C:N by XPS. In one embodiment, the C:N ratio ranges from 0.001:1 to 1:0.001. In one embodiment, the C:N ratio ranges from 0.01:1 to 1:0.01. In one embodiment, the C:N ratio ranges from 0.1:1 to 1:0.01. In one embodiment, the C:N ratio ranges from 1:0.5 to 1:0.001. In one embodiment, the C:N ratio ranges from 1:0.5 to 1:0.01. In one embodiment, the C:N ratio ranges from 1:0.5 to 1:0.1. In one embodiment, the C:N ratio ranges from 1:0.2 to 1:0.01. In one embodiment, the C:N ratio ranges from 1:0.001 to 1:1. In another embodiment, the C:N ratio ranges from 1:0.001 to 0.01. In yet another embodiment, the C:N ratio ranges from 1:0.01 to 1:1. In yet another embodiment, the content of nitrogen exceeds the content of carbon.

The carbon material can include both sp3 and sp2 hybridized carbons. The percentage of sp2 hybridization can be measured by XPS using the Auger spectrum, as known in the art (S. Turgeon, R. W. Paynter Thin Solid Films 394 (2001)4448). It is assumed that for materials which are less than 100% sp2, the remainder of the bonds are sp3. The carbon materials range from about 1% sp2 hybridization to 100% sp2 hybridization. Other embodiments include carbon materials comprising from about 25% to about 95% sp2, from about 50%-95% sp2, from about 50% to about 75% sp2, from about 65% to about 95% sp2 or about 65% sp2.

The carbon materials may also comprise an electrochemical modifier (i.e., a dopant) selected to optimize the electrochemical performance of the carbon materials. The electrochemical modifier may be incorporated within the pore structure and/or on the surface of the carbon material or incorporated in any number of other ways. For example, in some embodiments, the carbon materials comprise a coating of the electrochemical modifier (e.g., Al₂O₃) on the surface of the carbon materials. In some embodiments, the carbon materials comprise greater than about 100 ppm of an electrochemical modifier. In certain embodiments, the electrochemical modifier is selected from iron, tin, silicon, nickel, aluminum and manganese.

In certain embodiments the electrochemical modifier comprises an element with the ability to lithiate from 3 to 0 V versus lithium metal (e.g. silicon, tin, sulfur). In other embodiments, the electrochemical modifier comprises metal oxides with the ability to lithiate from 3 to 0 V versus lithium metal (e.g. iron oxide, molybdenum oxide, titanium oxide). In still other embodiments, the electrochemical modifier comprises elements which do not lithiate from 3 to 0 V versus lithium metal (e.g. aluminum, manganese, nickel, metal-phosphates). In yet other embodiments, the electrochemical modifier comprises a non-metal element (e.g. fluorine, nitrogen, hydrogen). In still other embodiments, the electrochemical modifier comprises any of the foregoing electrochemical modifiers or any combination thereof (e.g. tin-silicon, nickel-titanium oxide).

The electrochemical modifier may be provided in any number of forms. For example, in some embodiments the electrochemical modifier comprises a salt. In other embodiments, the electrochemical modifier comprises one or more elements in elemental form, for example elemental iron, tin, silicon, nickel or manganese. In other embodiments, the electrochemical modifier comprises one or more elements in oxidized form, for example iron oxides, tin oxides, silicon oxides, nickel oxides, aluminum oxides or manganese oxides.

In other embodiments, the electrochemical modifier comprises iron. In other embodiments, the electrochemical modifier comprises tin. In other embodiments, the electrochemical modifier comprises silicon. In some other embodiments, the electrochemical modifier comprises nickel. In yet other embodiments, the electrochemical modifier comprises aluminum. In yet other embodiments, the electrochemical modifier comprises manganese. In yet other embodiments, the electrochemical modifier comprises Al₂O₃. In yet other embodiments, the electrochemical modifier comprises titanium. In yet other embodiments, the electrochemical modifier comprises titanium oxide. In yet other embodiments, the electrochemical modifier comprises lithium. In yet other embodiments, the electrochemical modifier comprises sulfur. In yet other embodiments, the electrochemical modifier comprises phosphorous. In yet other embodiments, the electrochemical modifier comprises molybdenum.

In addition to the above exemplified electrochemical modifiers, the carbon materials may comprise one or more additional forms (i.e., allotropes) of carbon. In this regard, it has been found that inclusion of different allotropes of carbon such as graphite, amorphous carbon, diamond, C60, carbon nanotubes (e.g., single and/or multi-walled), graphene and/or carbon fibers into the carbon materials is effective to optimize the electrochemical properties of the carbon materials. The various allotropes of carbon can be incorporated into the carbon materials during any stage of the preparation process described herein. For example, during the solution phase, during the gelation phase, during the curing phase, during the pyrolysis phase, during the milling phase, or after milling. In some embodiments, the second carbon form is incorporated into the carbon material by adding the second carbon form before or during polymerization of the polymer gel as described in more detail herein. The polymerized polymer gel containing the second carbon form is then processed according to the general techniques described herein to obtain a carbon material containing a second allotrope of carbon.

Accordingly, in some embodiments the carbon materials comprise a second carbon form selected from graphite, amorphous carbon, diamond, C60, carbon nanotubes (e.g., single and/or multi-walled), graphene and carbon fibers. In some embodiments, the second carbon form is graphite. In other embodiments, the second form is diamond. The ratio of carbon material (e.g., hard carbon) to second carbon allotrope can be tailored to fit any desired electrochemical application.

In certain embodiments, the ratio of hard carbon to second carbon allotrope in the carbon materials ranges from about 0.01:1 to about 100:1. In other embodiments, the ratio of hard carbon to second carbon allotrope ranges from about 1:1 to about 10:1 or about 5:1. In other embodiments, the ratio of hard carbon to second carbon allotrope ranges from about 1:10 to about 10:1. In other embodiments, the ratio of hard carbon to second carbon allotrope ranges from about 1:5 to about 5:1. In other embodiments, the ratio of hard carbon to second carbon allotrope ranges from about 1:3 to about 3:1. In other embodiments, the ratio of hard carbon to second carbon allotrope ranges from about 1:2 to about 2:1.

The electrochemical properties of the carbon materials can be modified, at least in part, by the amount of the electrochemical modifier in the carbon material. Accordingly, in some embodiments, the carbon material comprises at least 0.10%, at least 0.25%, at least 0.50%, at least 1.0%, at least 5.0%, at least 10%, at least 25%, at least 50%, at least 75%, at least 90%, at least 95%, at least 99% or at least 99.5% of the electrochemical modifier. For example, in some embodiments, the carbon materials comprise between 0.5% and 99.5% carbon and between 0.5% and 99.5% electrochemical modifier. The percent of the electrochemical modifier is calculated on weight percent basis (wt %). In some other more specific embodiments, the electrochemical modifier comprises iron, tin, silicon, nickel and manganese.

The hard carbon materials have purities not previously obtained with hard carbon materials. While not wishing to be bound by theory, it is believed that the high purity of the hard carbon materials contributes to the superior electrochemical properties of the same. In some embodiments, the carbon material comprises low total PIXE impurities (excluding any intentionally included electrochemical modifier). Thus, in some embodiments the total PIXE impurity content (excluding any intentionally included electrochemical modifier) of all other PIXE elements in the carbon material (as measured by proton induced x-ray emission) is less than 1000 ppm. In other embodiments, the total PIXE impurity content (excluding any intentionally included electrochemical modifier) of all other PIXE elements in the carbon material is less than 800 ppm, less than 500 ppm, less than 300 ppm, less than 200 ppm, less than 150 ppm, less than 100 ppm, less than 50 ppm, less than 25 ppm, less than 10 ppm, less than 5 ppm or less than 1 ppm.

In addition to low content of undesired PIXE impurities, the disclosed carbon materials may comprise high total carbon content. In some examples, in addition to carbon, the carbon material may also comprise oxygen, hydrogen, nitrogen and an optional electrochemical modifier. In some embodiments, the material comprises at least 75% carbon, 80% carbon, 85% carbon, at least 90% carbon, at least 95% carbon, at least 96% carbon, at least 97% carbon, at least 98% carbon or at least 99% carbon on a weight/weight basis. In some other embodiments, the carbon material comprises less than 10% oxygen, less than 5% oxygen, less than 3.0% oxygen, less than 2.5% oxygen, less than 1% oxygen or less than 0.5% oxygen on a weight/weight basis. In other embodiments, the carbon material comprises less than 10% hydrogen, less than 5% hydrogen, less than 2.5% hydrogen, less than 1% hydrogen, less than 0.5% hydrogen or less than 0.1% hydrogen on a weight/weight basis. In other embodiments, the carbon material comprises less than 5% nitrogen, less than 2.5% nitrogen, less than 1% nitrogen, less than 0.5% nitrogen, less than 0.25% nitrogen or less than 0.01% nitrogen on a weight/weight basis. The oxygen, hydrogen and nitrogen content of the disclosed carbon materials can be determined by combustion analysis. Techniques for determining elemental composition by combustion analysis are well known in the art.

The total ash content of a carbon material may, in some instances, have an effect on the electrochemical performance of a carbon material. Accordingly, in some embodiments, the ash content (excluding any intentionally included electrochemical modifier) of the carbon material ranges from 0.1% to 0.001% weight percent ash, for example in some specific embodiments the ash content (excluding any intentionally included electrochemical modifier) of the carbon material is less than 0.1%, less than 0.08%, less than 0.05%, less than 0.03%, than 0.025%, less than 0.01%, less than 0.0075%, less than 0.005% or less than 0.001%.

In other embodiments, the carbon material comprises a total PIXE impurity content of all other elements (excluding any intentionally included electrochemical modifier) of less than 500 ppm and an ash content (excluding any intentionally included electrochemical modifier) of less than 0.08%. In further embodiments, the carbon material comprises a total PIXE impurity content of all other elements (excluding any intentionally included electrochemical modifier) of less than 300 ppm and an ash content (excluding any intentionally included electrochemical modifier) of less than 0.05%. In other further embodiments, the carbon material comprises a total PIXE impurity content of all other elements (excluding any intentionally included electrochemical modifier) of less than 200 ppm and an ash content (excluding any intentionally included electrochemical modifier) of less than 0.05%. In other further embodiments, the carbon material comprises a total PIXE impurity content of all other elements (excluding any intentionally included electrochemical modifier) of less than 200 ppm and an ash content (excluding any intentionally included electrochemical modifier) of less than 0.025%. In other further embodiments, the carbon material comprises a total PIXE impurity content of all other elements (excluding any intentionally included electrochemical modifier) of less than 100 ppm and an ash content (excluding any intentionally included electrochemical modifier) of less than 0.02%. In other further embodiments, the carbon material comprises a total PIXE impurity content of all other elements (excluding any intentionally included electrochemical modifier) of less than 50 ppm and an ash content (excluding any intentionally included electrochemical modifier) of less than 0.01%.

The amount of individual PIXE impurities present in the disclosed carbon materials can be determined by proton induced x-ray emission. Individual PIXE impurities may contribute in different ways to the overall electrochemical performance of the disclosed carbon materials. Thus, in some embodiments, the level of sodium present in the carbon material is less than 1000 ppm, less than 500 ppm, less than 100 ppm, less than 50 ppm, less than 10 ppm, or less than 1 ppm. In some embodiments, the level of magnesium present in the carbon material is less than 1000 ppm, less than 100 ppm, less than 50 ppm, less than 10 ppm, or less than 1 ppm.

In some embodiments, the level of aluminum present in the carbon material is less than 1000 ppm, less than 100 ppm, less than 50 ppm, less than 10 ppm, or less than 1 ppm. In some embodiments, the level of silicon present in the carbon material is less than 500 ppm, less than 300 ppm, less than 100 ppm, less than 50 ppm, less than 20 ppm, less than 10 ppm or less than 1 ppm. In some embodiments, the level of phosphorous present in the carbon material is less than 1000 ppm, less than 100 ppm, less than 50 ppm, less than 10 ppm, or less than 1 ppm. In some embodiments, the level of sulfur present in the carbon material is less than 1000 ppm, less than 100 ppm, less than 50 ppm, less than 30 ppm, less than 10 ppm, less than 5 ppm or less than 1 ppm. In some embodiments, the level of chlorine present in the carbon material is less than 1000 ppm, less than 100 ppm, less than 50 ppm, less than 10 ppm, or less than 1 ppm. In some embodiments, the level of potassium present in the carbon material is less than 1000 ppm, less than 100 ppm, less than 50 ppm, less than 10 ppm, or less than 1 ppm. In other embodiments, the level of calcium present in the carbon material is less than 100 ppm, less than 50 ppm, less than 20 ppm, less than 10 ppm, less than 5 ppm or less than 1 ppm. In some embodiments, the level of chromium present in the carbon material is less than 1000 ppm, less than 100 ppm, less than 50 ppm, less than 10 ppm, less than 5 ppm, less than 4 ppm, less than 3 ppm, less than 2 ppm or less than 1 ppm. In other embodiments, the level of iron present in the carbon material is less than 50 ppm, less than 20 ppm, less than 10 ppm, less than 5 ppm, less than 4 ppm, less than 3 ppm, less than 2 ppm or less than 1 ppm. In other embodiments, the level of nickel present in the carbon material is less than 20 ppm, less than 10 ppm, less than 5 ppm, less than 4 ppm, less than 3 ppm, less than 2 ppm or less than 1 ppm. In some other embodiments, the level of copper present in the carbon material is less than 140 ppm, less than 100 ppm, less than 40 ppm, less than 20 ppm, less than 10 ppm, less than 5 ppm, less than 4 ppm, less than 3 ppm, less than 2 ppm or less than 1 ppm. In yet other embodiments, the level of zinc present in the carbon material is less than 20 ppm, less than 10 ppm, less than 5 ppm, less than 2 ppm or less than 1 ppm. In yet other embodiments, the sum of all other PIXE impurities (excluding any intentionally included electrochemical modifier) present in the carbon material is less than 1000 ppm, less than 500 pm, less than 300 ppm, less than 200 ppm, less than 100 ppm, less than 50 ppm, less than 25 ppm, less than 10 ppm or less than 1 ppm. As noted above, in some embodiments other impurities such as hydrogen, oxygen and/or nitrogen may be present in levels ranging from less than 10% to less than 0.01%.

In some embodiments, the carbon material comprises undesired PIXE impurities near or below the detection limit of the proton induced x-ray emission analysis. For example, in some embodiments the carbon material comprises less than 50 ppm sodium, less than 15 ppm magnesium, less than 10 ppm aluminum, less than 8 ppm silicon, less than 4 ppm phosphorous, less than 3 ppm sulfur, less than 3 ppm chlorine, less than 2 ppm potassium, less than 3 ppm calcium, less than 2 ppm scandium, less than 1 ppm titanium, less than 1 ppm vanadium, less than 0.5 ppm chromium, less than 0.5 ppm manganese, less than 0.5 ppm iron, less than 0.25 ppm cobalt, less than 0.25 ppm nickel, less than 0.25 ppm copper, less than 0.5 ppm zinc, less than 0.5 ppm gallium, less than 0.5 ppm germanium, less than 0.5 ppm arsenic, less than 0.5 ppm selenium, less than 1 ppm bromine, less than 1 ppm rubidium, less than 1.5 ppm strontium, less than 2 ppm yttrium, less than 3 ppm zirconium, less than 2 ppm niobium, less than 4 ppm molybdenum, less than 4 ppm, technetium, less than 7 ppm rubidium, less than 6 ppm rhodium, less than 6 ppm palladium, less than 9 ppm silver, less than 6 ppm cadmium, less than 6 ppm indium, less than 5 ppm tin, less than 6 ppm antimony, less than 6 ppm tellurium, less than 5 ppm iodine, less than 4 ppm cesium, less than 4 ppm barium, less than 3 ppm lanthanum, less than 3 ppm cerium, less than 2 ppm praseodymium, less than 2 ppm, neodymium, less than 1.5 ppm promethium, less than 1 ppm samarium, less than 1 ppm europium, less than 1 ppm gadolinium, less than 1 ppm terbium, less than 1 ppm dysprosium, less than 1 ppm holmium, less than 1 ppm erbium, less than 1 ppm thulium, less than 1 ppm ytterbium, less than 1 ppm lutetium, less than 1 ppm hathium, less than 1 ppm tantalum, less than 1 ppm tungsten, less than 1.5 ppm rhenium, less than 1 ppm osmium, less than 1 ppm iridium, less than 1 ppm platinum, less than 1 ppm silver, less than 1 ppm mercury, less than 1 ppm thallium, less than 1 ppm lead, less than 1.5 ppm bismuth, less than 2 ppm thorium, or less than 4 ppm uranium.

In some embodiments, the carbon material comprises undesired PIXE impurities near or below the detection limit of the proton induced x-ray emission analysis. In some specific embodiments, the carbon material comprises less than 100 ppm sodium, less than 300 ppm silicon, less than 50 ppm sulfur, less than 100 ppm calcium, less than 20 ppm iron, less than 10 ppm nickel, less than 140 ppm copper, less than 5 ppm chromium and less than 5 ppm zinc as measured by proton induced x-ray emission. In other specific embodiments, the carbon material comprises less than 50 ppm sodium, less than 30 ppm sulfur, less than 100 ppm silicon, less than 50 ppm calcium, less than 10 ppm iron, less than 5 ppm nickel, less than 20 ppm copper, less than 2 ppm chromium and less than 2 ppm zinc.

In other specific embodiments, the carbon material comprises less than 50 ppm sodium, less than 50 ppm silicon, less than 30 ppm sulfur, less than 10 ppm calcium, less than 2 ppm iron, less than 1 ppm nickel, less than 1 ppm copper, less than 1 ppm chromium and less than 1 ppm zinc.

In some other specific embodiments, the carbon material comprises less than 100 ppm sodium, less than 50 ppm magnesium, less than 50 ppm aluminum, less than 10 ppm sulfur, less than 10 ppm chlorine, less than 10 ppm potassium, less than 1 ppm chromium and less than 1 ppm manganese.

In another embodiment of the present disclosure, the carbon material is prepared by a method disclosed herein, for example, in some embodiments the carbon material is prepared by a method comprising pyrolyzing a polymer gel as disclosed herein. The carbon materials may also be prepared by pryolyzing a substance such as chitosan. The carbon materials can be prepared by any number of methods described in more detail below.

Electrochemical modifiers can be incorporated into the carbon materials at various stages of the sol gel process. For example, electrochemical modifiers can be incorporated during the polymerization stage, into the polymer gel or into the pyrolyzed or activated carbon materials. Methods for preparation of carbon materials are described in more detail below.

2. Polymer Gels

Polymer gels are intermediates in the preparation of the disclosed carbon materials. As such, the physical and chemical properties of the polymer gels contribute to, and are predictive of, the properties of the carbon materials. Polymer gels used for preparation of the carbon materials are included within the scope of certain aspects of the present invention.

### B. Preparation of Carbon Materials

Methods for preparing the carbon materials are not known in the art. For example, methods for preparation of carbon materials are described in U.S. Pat. Nos. 7,723,262 and 8,293,818; and U.S. patent application Ser. Nos. 12/829,282; 13/046,572; 13/250,430; 12/965,709; 13/336,975 and 13/486,731, the full disclosures of which are hereby incorporated by reference in their entireties for all purposes. Accordingly, in one embodiment the present disclosure provides a method for preparing any of the carbon materials or polymer gels described above. The carbon materials may synthesized through pyrolysis of either a single precursor (such as chitosan) or from a complex resin, formed using a sol-gel method using polymer precursors such as phenol, resorcinol, urea, melamine, etc in water, ethanol, methanol, etc with formaldehyde. The resin may be acid or basic, and possibly contain a catalyst. The pyrolysis temperature and dwell time may be optimized as described below.

In some embodiments, the methods comprise preparation of a polymer gel by a sol gel process followed by pyrolysis of the polymer gel. The polymer gel may be dried (e.g., freeze dried) prior to pyrolysis; however drying is not required and in some embodiments is not desired. The sol gel process provides significant flexibility such that an electrochemical modifier can be incorporated at any number of steps. In one embodiment, a method for preparing a polymer gel comprising an electrochemical modifier is provided. In another embodiment, methods for preparing pyrolyzed polymer gels are provided. Details of the variable process parameters of the various embodiments of the disclosed methods are described below.

1. Preparation of Polymer Gels

The polymer gels may be prepared by a sol gel process. For example, the polymer gel may be prepared by co-polymerizing one or more polymer precursors in an appropriate solvent. In one embodiment, the one or more polymer precursors are co-polymerized under acidic conditions. In some embodiments, a first polymer precursor is a phenolic compound and a second polymer precursor is an aldehyde compound. In one embodiment, of the method the phenolic compound is phenol, resorcinol, catechol, hydroquinone, phloroglucinol, or a combination thereof; and the aldehyde compound is formaldehyde, acetaldehyde, propionaldehyde, butyraldehyde, benzaldehyde, cinnamaldehyde, or a combination thereof. In a further embodiment, the phenolic compound is resorcinol, phenol or a combination thereof, and the aldehyde compound is formaldehyde. In yet further embodiments, the phenolic compound is resorcinol and the aldehyde compound is formaldehyde. Other polymer precursors include nitrogen containing compounds such as melamine, urea and ammonia.

In certain embodiments, an optional electrochemical modifier is incorporated during the above described polymerization process. For example, in some embodiments, an electrochemical modifier in the form of metal particles, metal paste, metal salt, metal oxide or molten metal can be dissolved or suspended into the mixture from which the gel resin is produced.

In some embodiments, the metal salt dissolved into the mixture from which the gel resin is produced is soluble in the reaction mixture. In this case, the mixture from which the gel resin is produced may contain an acid and/or alcohol which improves the solubility of the metal salt. The metal-containing polymer gel can be optionally freeze dried, followed by pyrolysis. Alternatively, the metal-containing polymer gel is not freeze dried prior to pyrolysis.

The sol gel polymerization process is generally performed under catalytic conditions. Accordingly, in some embodiments, preparing the polymer gel comprises co-polymerizing one or more polymer precursors in the presence of a catalyst. In some embodiments, the catalyst comprises a basic volatile catalyst. For example, in one embodiment, the basic volatile catalyst comprises ammonium carbonate, ammonium bicarbonate, ammonium acetate, ammonium hydroxide, or combinations thereof. In a further embodiment, the basic volatile catalyst is ammonium carbonate. In another further embodiment, the basic volatile catalyst is ammonium acetate.

The molar ratio of catalyst to polymer precursor (e.g., phenolic compound) may have an effect on the final properties of the polymer gel as well as the final properties of the carbon materials. Thus, in some embodiments such catalysts are used in the range of molar ratios of 5:1 to 2000:1 phenolic compound:catalyst. In some embodiments, such catalysts can be used in the range of molar ratios of 10:1 to 400:1 phenolic compound:catalyst. For example in other embodiments, such catalysts can be used in the range of molar ratios of 5:1 to 100:1 phenolic compound:catalyst. For example, in some embodiments the molar ratio of catalyst to phenolic compound is about 400:1. In other embodiments the molar ratio of catalyst to phenolic compound is about 100:1. In other embodiments the molar ratio of catalyst to phenolic compound is about 50:1. In other embodiments the molar ratio of catalyst to phenolic compound is about 10:1.

The reaction solvent is another process parameter that may be varied to obtain the desired properties (e.g., surface area, porosity, purity, etc.) of the polymer gels and carbon materials. In some embodiments, the solvent for preparation of the polymer gel is a mixed solvent system of water and a miscible co-solvent. For example, in certain embodiments the solvent comprises a water miscible acid. Examples of water miscible acids include, but are not limited to, propionic acid, acetic acid, and formic acid. In further embodiments, the solvent comprises a ratio of water-miscible acid to water of 99:1, 90:10, 75:25, 50:50, 25:75, 10:90 or 1:90. In other embodiments, acidity is provided by adding a solid acid to the reaction solvent.

In some other embodiments of the foregoing, the solvent for preparation of the polymer gel is acidic. For example, in certain embodiments the solvent comprises acetic acid. For example, in one embodiment, the solvent is 100% acetic acid. In other embodiments, a mixed solvent system is provided, wherein one of the solvents is acidic. For example, in one embodiment of the method the solvent is a binary solvent comprising acetic acid and water. In further embodiments, the solvent comprises a ratio of acetic acid to water of 99:1, 90:10, 75:25, 50:50, 25:75, 20:80, 10:90 or 1:90. In other embodiments, acidity is provided by adding a solid acid to the reaction solvent.

In some embodiments, an optional electrochemical modifier is incorporated into the polymer gel after the polymerization step, for example either before or after and optional drying and before pyrolyzing polymer gel. In some other embodiments, the polymer gel (either before or after and optional drying and prior to pyrolysis) is impregnated with electrochemical modifier by immersion in a metal salt solution or suspension or particles. In some embodiments, the particle is micronized silicon powder. In other embodiments, the particle is nano silicon powder. In some embodiment, the particle is tin. In still other embodiments, the particle is a combination of silicon, tin, carbon, or any oxides. The metal salt solution or suspension may comprise acids and/or alcohols to improve solubility of the metal salt. In yet another variation, the polymer gel (either before or after an optional drying step) is contacted with a paste comprising the electrochemical modifier. In yet another variation, the polymer gel (either before or after an optional drying step) is contacted with a metal or metal oxide sol comprising the desired electrochemical modifier.

In some embodiments of the methods described herein, the molar ratio of phenolic precursor to catalyst is from about 5:1 to about 2000:1 or the molar ratio of phenolic precursor to catalyst is from about 20:1 to about 200:1. In further embodiments, the molar ratio of phenolic precursor to catalyst is from about 25:1 to about 100:1. In further embodiments, the molar ratio of phenolic precursor to catalyst is from about 5:1 to about 10:1. In further embodiments, the molar ratio of phenolic precursor to catalyst is from about 100:1 to about 5:1.

In the specific embodiment wherein one of the polymer precursors is resorcinol and another polymer precursor is formaldehyde, the resorcinol to catalyst ratio can be varied to obtain the desired properties of the resultant polymer gel and carbon materials. In some embodiments of the methods described herein, the molar ratio of resorcinol to catalyst is from about 10:1 to about 2000:1 or the molar ratio of resorcinol to catalyst is from about 20:1 to about 200:1. In further embodiments, the molar ratio of resorcinol to catalyst is from about 25:1 to about 100:1. In further embodiments, the molar ratio of resorcinol to catalyst is from about 5:1 to about 10:1. In further embodiments, the molar ratio of resorcinol to catalyst is from about 100:1 to about 5:1.

Polymerization to form a polymer gel can be accomplished by various means described in the art and may include addition of an electrochemical modifier. For instance, polymerization can be accomplished by incubating suitable polymer precursor materials, and optionally an electrochemical modifier, in the presence of a suitable catalyst for a sufficient period of time. The time for polymerization can be a period ranging from minutes or hours to days, depending on the temperature (the higher the temperature the faster, the reaction rate, and correspondingly, the shorter the time required). The polymerization temperature can range from room temperature to a temperature approaching (but lower than) the boiling point of the starting solution. For example, in some embodiments the polymer gel is aged at temperatures from about 20° C. to about 120° C., for example about 20° C. to about 100° C. Other embodiments include temperature ranging from about 30° C. to about 90° C., for example about 45° C. or about 85° C. In other embodiments, the temperature ranges from about 65° C. to about 80° C., while other embodiments include aging at two or more temperatures, for example about 45° C. and about 75-85° C. or about 80-85° C.

The structure of the polymer precursors is not particularly limited, provided that the polymer precursor is capable of reacting with another polymer precursor or with a second polymer precursor to form a polymer. Exemplary polymer precursors include amine-containing compounds, alcohol-containing compounds and carbonyl-containing compounds, for example in some embodiments the polymer precursors are selected from an alcohol, a phenol, a polyalcohol, a sugar, an alkyl amine, an aromatic amine, an aldehyde, a ketone, a carboxylic acid, an ester, a urea, an acid halide and an isocyanate.

The polymer precursor materials as disclosed herein include (a) alcohols, phenolic compounds, and other mono- or polyhydroxy compounds and (b) aldehydes, ketones, and combinations thereof. Representative alcohols in this context include straight chain and branched, saturated and unsaturated alcohols. Suitable phenolic compounds include polyhydroxy benzene, such as a dihydroxy or trihydroxy benzene. Representative polyhydroxy benzenes include resorcinol (i.e., 1,3-dihydroxy benzene), catechol, hydroquinone, and phloroglucinol. Mixtures of two or more polyhydroxy benzenes can also be used. Phenol (monohydroxy benzene) can also be used. Representative polyhydroxy compounds include sugars, such as glucose, and other polyols, such as mannitol. Aldehydes in this context include: straight chain saturated aldeydes such as methanal (formaldehyde), ethanal (acetaldehyde), propanal (propionaldehyde), butanal (butyraldehyde), and the like; straight chain unsaturated aldehydes such as ethenone and other ketenes, 2-propenal (acrylaldehyde), 2-butenal (crotonaldehyde), 3 butenal, and the like; branched saturated and unsaturated aldehydes; and aromatic-type aldehydes such as benzaldehyde, salicylaldehyde, hydrocinnamaldehyde, and the like. Suitable ketones include: straight chain saturated ketones such as propanone and 2 butanone, and the like; straight chain unsaturated ketones such as propenone, 2 butenone, and 3-butenone (methyl vinyl ketone) and the like; branched saturated and unsaturated ketones; and aromatic-type ketones such as methyl benzyl ketone (phenylacetone), ethyl benzyl ketone, and the like. The polymer precursor materials can also be combinations of the precursors described above.

In some embodiments, one polymer precursor is an alcohol-containing species and another polymer precursor is a carbonyl-containing species. The relative amounts of alcohol-containing species (e.g., alcohols, phenolic compounds and mono- or poly-hydroxy compounds or combinations thereof) reacted with the carbonyl containing species (e.g. aldehydes, ketones or combinations thereof) can vary substantially. In some embodiments, the ratio of alcohol-containing species to aldehyde species is selected so that the total moles of reactive alcohol groups in the alcohol-containing species is approximately the same as the total moles of reactive carbonyl groups in the aldehyde species. Similarly, the ratio of alcohol-containing species to ketone species may be selected so that the total moles of reactive alcohol groups in the alcohol containing species is approximately the same as the total moles of reactive carbonyl groups in the ketone species. The same general 1:1 molar ratio holds true when the carbonyl-containing species comprises a combination of an aldehyde species and a ketone species.

In other embodiments, the polymer precursor is a urea or an amine containing compound. For example, in some embodiments the polymer precursor is urea or melamine. Other embodiments include polymer precursors selected from isocyanates or other activated carbonyl compounds such as acid halides and the like.

The total solids content in the solution or suspension prior to polymer gel formation can be varied. The weight ratio of resorcinol to water is from about 0.05 to 1 to about 0.70 to 1. Alternatively, the ratio of resorcinol to water is from about 0.15 to 1 to about 0.6 to 1. Alternatively, the ratio of resorcinol to water is from about 0.15 to 1 to about 0.35 to 1. Alternatively, the ratio of resorcinol to water is from about 0.25 to 1 to about 0.5 to 1. Alternatively, the ratio of resorcinol to water is from about 0.3 to 1 to about 0.35 to 0.6.

Examples of solvents useful in the preparation of the polymer gels disclosed herein include but are not limited to water or alcohols such as, for example, ethanol, t butanol, methanol or combinations thereof as well as aqueous mixtures of the same. Such solvents are useful for dissolution of the polymer precursor materials, for example dissolution of the phenolic compound. In addition, in some processes such solvents are employed for solvent exchange in the polymer gel (prior to freezing and drying), wherein the solvent from the polymerization of the precursors, for example, resorcinol and formaldehyde, is exchanged for a pure alcohol. In one embodiment of the present application, a polymer gel is prepared by a process that does not include solvent exchange.

Suitable catalysts in the preparation of the polymer gels include volatile basic catalysts that facilitate polymerization of the precursor materials into a monolithic polymer. The catalyst can also comprise various combinations of the catalysts described above. In embodiments comprising phenolic compounds, such catalysts can be used in the range of molar ratios of 5:1 to 200:1 phenolic compound:catalyst. For example, in some specific embodiments such catalysts can be used in the range of molar ratios of 5:1 to 10:1 phenolic compound:catalyst.

2. Creation of Polymer Gel Particles

A monolithic polymer gel can be physically disrupted to create smaller particles according to various techniques known in the art. The resultant polymer gel particles generally have an average diameter of less than about 30 mm, for example, in the size range of about 1 mm to about 25 mm, or between about 1 mm to about 5 mm or between about 0.5 mm to about 10 mm. Alternatively, the size of the polymer gel particles can be in the range below about 1 mm, for example, in the size range of about 10 to 1000 microns. Techniques for creating polymer gel particles from monolithic material include manual or machine disruption methods, such as sieving, grinding, milling, or combinations thereof. Such methods are well-known to those of skill in the art. Various types of mills can be employed in this context such as roller, bead, and ball mills and rotary crushers and similar particle creation equipment known in the art.

In other embodiments, the polymer gel particles are in the range of 0.1 microns to 2.5 cm, from about 0.1 microns to about 1 cm, from about 1 micron to about 1000 microns, from about 1 micron to about 100 microns, from about 1 micron to about 50 microns, from about 1 micron to about 25 microns or from about 1 microns to about 10 microns. In other embodiments, the polymer gel particles are in the range of about 1 mm to about 100 mm, from about 1 mm to about 50 mm, from about 1 mm to about 25 mm or from about 1 mm to about 10 mm.

In an embodiment, a roller mill is employed. A roller mill has three stages to gradually reduce the size of the gel particles. The polymer gels are generally very brittle and are not damp to the touch. Consequently they are easily milled using this approach; however, the width of each stage must be set appropriately to achieve the targeted final mesh. This adjustment is made and validated for each combination of gel recipe and mesh size. Each gel is milled via passage through a sieve of known mesh size. Sieved particles can be temporarily stored in sealed containers.

In one embodiment, a rotary crusher is employed. The rotary crusher has a screen mesh size of about ⅛^{th} inch. In another embodiment, the rotary crusher has a screen mesh size of about ⅜^{th} inch. In another embodiment, the rotary crusher has a screen mesh size of about ⅝^{th} inch. In another embodiment, the rotary crusher has a screen mesh size of about ⅜^{th} inch.

Milling can be accomplished at room temperature according to methods well known to those of skill in the art. Alternatively, milling can be accomplished cryogenically, for example by co-milling the polymer gel with solid carbon dioxide (dry ice) particles.

3. Soaking or Treatment of Polymer Gels

The polymer gels described above, can be further soaked or treated for the inclusion of an optional electrochemical modifier. The inclusion of the electrochemical modifier may change both the electrochemical properties of the final product when used in a lithium battery and/or change the physical/chemical properties of the material.

In some embodiments, the optional electrochemical modifier is added through a liquid phase soaking or solvent exchange. The solvent used may be the same or different than that used in the polymer gel process. Generally, for soaking, wet polymer gels are weighed and placed into a larger container. A solution containing a solvent and a precursor for electrochemical modification is combined with the wet polymer gel to form a mixture. The mixture is left to soak at a set stir rate, temperature and time. Upon completion, the excess solvent is decanted from the mixture. In other embodiments, the optional electrochemical modifier is added through a vapor phase.

In some embodiments, the precursor may be soluble in the solvent. For precursors that are soluble in the chosen solvent, in some embodiments, the solution may be unsaturated, saturated, or super saturated. In other embodiments, the precursor may be insoluble and therefore suspended in the solvent.

In some embodiments, the soak temperature ranges from 20 to 30° C. In other embodiments, the soak temperature ranges from 30 to 40° C. In yet other embodiments, the soak temperature ranges from 40 to 50° C. In yet other embodiments, the soak temperature ranges from 50 to 60° C. In yet other embodiments, the soak temperature ranges from 60 to 70° C. In yet other embodiments, the soak temperature ranges from 70 to 80° C. In yet other embodiments, the soak temperature ranges from 80 to 100° C.

In some embodiments, the soak time (the period of time between the combination of the wet polymer gel and the solution and the decanting of the excess liquid) is from about 0 hours to about 5 hours. In other embodiments, the soak time ranges from about 10 minutes to about 120 minutes, between about 30 minute and 90 minutes, and between about 40 minutes and 60 minutes. In yet other embodiments, the soak time is between about from about 0 hours to about 10 hours, from about 0 hours to about 20 hours, from about 10 hours to about 100 hours, from about 10 hours to about 15 hours, or from about 5 hours to about 10 hours.

In some embodiments, the stir rate is between 0 and 10 rpm. In other embodiments, the stir rate is between 10 and 15 rpm, between 15 and 20 rpm, between 20 and 30 rpm, between 30 and 50 rpm, between 50 and 100 rpm, between 100 and 200 rpm, between 200 and 1000 rpm, or greater than 1000 rpm. In yet other embodiments, the mixture undergoes no artificial agitation.

The optional electrochemical modifier may fall into one or more than one of the chemical classifications listed in Table 1.

TABLE 1
Exemplary Electrochemical Modifiers

| Chemical Classification | Example Precursor Materials |
|---|---|
| Saccharides | Chitin |
| | Chitosan |
| | Glucose |
| | Sucrose |
| | Fructose |
| | Cellulose |
| Biopolymers | Lignin |
| Proteins | Gelatin |
| Amines and Ureas | Urea |
| | Melamine |
| Halogen Salts | LiBr |
| | NaCl |
| | KF |
| Nitrate Salts | NaNO₃ |
| | LiNO₃ |
| Carbides | SiC |
| | CaC₂ |
| Metal Containing Compounds | Aluminum isoproproxide |
| | Manganese Acetate |
| | Nickel Acetate |
| | Iron Acetate |
| Hydrocarbons | Propane |
| | Butane |
| | Ethylene |
| | Cyclohexane |
| | Methane |
| | Benzene |
| | Ethane |
| | Hexane |
| | Octane |
| | Pentane |
| Alcohols | Isopropanol |
| | Ethanol |
| | Methanol |
| | Butanol |
| | Ethylene Glycol |
| | Xylitol |
| | Menthol |
| Phosphate Salts | H₃PO₃ |
| | NH₄H₂PO₃ |
| | Na₃PO₃ |
| Ketones | Acetone |
| | Ethyl Methyl Ketone |
| | Acetophenone |
| | Muscone |

4. Pyrolysis of Polymer Gels

The polymer gels described above, can be further processed to obtain the desired carbon materials. Such processing includes, for example, pyrolysis. Generally, in the pyrolysis process, wet polymer gels are weighed and placed in a rotary kiln. The temperature ramp is set at 10° C. per minute, the dwell time and dwell temperature are set; cool down is determined by the natural cooling rate of the furnace. The entire process is usually run under an inert atmosphere, such as a nitrogen environment. However, in certain embodiments, the gas may be a hydrocarbon listed in table 1, such as methane, or ammonia. Pyrolyzed samples are then removed and weighed. Other pyrolysis processes are well known to those of skill in the art.

In some embodiments, an optional electrochemical modifier is incorporated into the carbon material after pyrolysis of the polymer gel. For example, the electrochemical modifier can be incorporated into the pyrolyzed polymer gel by contacting the pyrolyzed polymer gel with the electrochemical modifier, for example, colloidal metal, molten metal, metal salt, metal paste, metal oxide or other sources of metals.

In some embodiments, pyrolysis dwell time (the period of time during which the sample is at the desired temperature) is from about 0 minutes to about 180 minutes, from about 10 minutes to about 120 minutes, from about 30 minutes to about 100 minutes, from about 40 minutes to about 80 minutes, from about 45 to 70 minutes or from about 50 to 70 minutes.

Pyrolysis may also be carried out more slowly than described above. For example, in one embodiment the pyrolysis is carried out in about 120 to 480 minutes. In other embodiments, the pyrolysis is carried out in about 120 to 240 minutes.

In some embodiments, pyrolysis dwell temperature ranges from about 500° C. to 2400° C. In some embodiments, pyrolysis dwell temperature ranges from about 650° C. to 1800° C. In other embodiments pyrolysis dwell temperature ranges from about 700° C. to about 1200° C. In other embodiments pyrolysis dwell temperature ranges from about 850° C. to about 1050° C. In other embodiments pyrolysis dwell temperature ranges from about 1000° C. to about 1200° C.

In some embodiments, the pyrolysis dwell temperature is varied during the course of pyrolysis. In one embodiment, the pyrolysis is carried out in a rotary kiln with separate, distinct heating zones. The temperature for each zone is sequentially decreased from the entrance to the exit end of the rotary kiln tube. In one embodiment, the pyrolysis is carried out in a rotary kiln with separate distinct heating zones, and the temperature for each zone is sequentially increased from entrance to exit end of the rotary kiln tube.

In yet other embodiments, the surface of the hard carbon may be modified during pyrolysis due to the thermal breakdown of solid, liquid or gas precursors. Theses precursors may include any of the chemicals listed in Table 1. In one embodiment the precursors may be introduced prior to pyrolysis under room temperature conditions. In a second embodiment, the precursors may be introduced while the material is at an elevated temperature during pyrolysis. In a third embodiment, the precursors may be introduced post-pyrolysis. Multiple precursors or a mixture of precursors for chemical and structural modification may also be used.

The carbon may also undergo an additional heat treatment step to help change the surface functionality. In some embodiments, heat treatment dwell temperature ranges from about 500° C. to 2400° C. In some embodiments, heat treatment dwell temperature ranges from about 650° C. to 1800° C. In other embodiments heat treatment dwell temperature ranges from about 700° C. to about 1200° C. In other embodiments heat treatment dwell temperature ranges from about 850° C. to about 1050° C. In other embodiments heat treatment dwell temperature ranges from about 1000° C. to about 1200° C. In other embodiments heat treatment dwell temperature ranges from about 800° C. to about 1100° C.

In some embodiments, heat treatment dwell time (the period of time during which the sample is at the desired temperature) is from about 0 minutes to about 300 minutes, from about 10 minutes to about 180 minutes, from about 10 minutes to about 120 minutes, from about 30 minutes to about 100 minutes, from about 40 minutes to about 80 minutes, from about 45 to 70 minutes or from about 50 to 70 minutes.

Pyrolysis may also be carried out more slowly than described above. For example, in one embodiment the pyrolysis is carried out in about 120 to 480 minutes. In other embodiments, the pyrolysis is carried out in about 120 to 240 minutes.

In one embodiment the carbon may also undergo a heat treatment under a volatile gas, such as a hydrocarbon listed in Table 1. Wishing not to be bound by theory, the hydrocarbon or volatile gas may decompose or react on the surface of the carbon when exposed to elevated temperatures. The volatile may leave behind a thin layer, such as a soft carbon, covering the surface of the hard carbon.

In one embodiment the gas may be piped in directly from a compressed tank. In another embodiment the gas may originate through the heating of a liquid and the mixing of an inert carrier gas using a bubbler technique commonly known in the art. In another embodiment, as solid or liquid may be placed upstream of the sample and decompose into a volatile gas, which then reacts with the carbon in the hot zone.

In one embodiment the vapor deposition may be completed under a static gas environment. In another embodiment the vapor deposition may be completed in a dynamic, gas flowing environment but wherein the carbon is static. In yet another embodiment, the vapor deposition may be completed under continuous coating, wherein the gas and the carbon are flowing through a hot zone. In still yet another embodiment the vapor deposition may be completed under continuous coating, wherein the gas and the carbon are flowing through a hot zone, but where the gas is flowing counter current to the solid carbon. In another embodiment the carbon is coated by chemical vapor deposition while rotating in a rotary kiln.

The carbon may also undergo a vapor deposition through the heating of a volatile gas at different temperatures. In some embodiments vapor deposition temperature ranges from about 500° C. to 2400° C. In some embodiments, heat treatment dwell temperature ranges from about 650° C. to 1800° C. In other embodiments heat treatment dwell temperature ranges from about 700° C. to about 1000° C. In other embodiments heat treatment dwell temperature ranges from about 800° C. to about 900° C. In other embodiments heat treatment dwell temperature ranges from about 1000° C. to about 1200° C. In other embodiments heat treatment dwell temperature ranges from about 900° C. to about 1100° C., from about 950° C. to about 1050° C. or about 1000° C.

The carbon may also undergo a vapor deposition through the heating of a volatile gas for different dwell times. In some embodiments, vapor deposition dwell time (the period of time during which the sample is at the desired temperature) is from about 0 minutes to about 5 hours, from about 10 minutes to about 180 minutes, from about 10 minutes to about 120 minutes, from about 30 minutes to about 100 minutes, from about 40 minutes to about 80 minutes, from about 45 to 70 minutes or from about 50 to 70 minutes.

The thickness of the layer of carbon deposited by vapor deposition of hydrocarbon decomposition can be measured by HRTEM. In one embodiment the thickness of the layer is less than 0.1 nm, less than 0.5 nm, less than 1 nm, or less than 2 nm. In other embodiments the thickness of the carbon layer deposited by vapor deposition of hydrocarbon decomposition measured by HRTEM is between 1 nm and 100 nm. In yet other embodiments the thickness of the carbon layer deposited by vapor deposition of hydrocarbon decomposition measured by HRTEM is between 0.1 nm and 50 nm. In still other embodiments the thickness of the carbon layer deposited by vapor deposition of hydrocarbon decomposition measured by HRTEM is between 1 nm and 50 nm. In still other embodiments the thickness of the carbon layer deposited by vapor deposition of hydrocarbon decomposition measured by HRTEM is between 2 nm and 50 nm, for example between about 10 nm and 25 nm.

5. One-Step Polymerization/Pyrolysis Procedure

A carbon material may also be synthesized through a one-step polymerization/pyrolysis method. In general, the polymer is formed during the pyrolysis temperature ramp. The precursors are placed into a rotary kiln with an inert nitrogen atmosphere. The precursors will undergo polymerization within the kiln during the temperature ramp. There may or may not be an intermediate dwell time to allow for complete polymerization. After polymerization is complete, the temperature is once again increased, where the polymer undergoes pyrolysis as previously described.

In some embodiments the precursors comprise a saccharide, protein, or a biopolymer. Examples of saccharides include, but are not limited to chitin, chitosan, and lignin. A non-limiting example of a protein is animal derived gelatin. In other embodiments, the precursors may be partially polymerized prior to insertion into the kiln. In yet other embodiments, the precursors are not fully polymerized before pyrolysis is initiated.

The intermediate dwell time may vary. In one embodiment, no intermediate dwell time exists. In another embodiment, the dwell time ranges from about 0 to about 10 hrs. In yet another embodiment, the dwell time ranges from about 0 to about 5 hrs. In yet other embodiments, the dwell time ranges from about 0 to about 1 hour.

The intermediate dwell temperature may also vary. In some embodiments, the intermediate dwell temperature ranges from about 100 to about 600° C., from about 150 to about 500° C., or from about 350 to about 450° C. In other embodiments, the dwell temperature is greater than about 600° C. In yet other embodiments, the intermediate dwell temperature is below about 100° C.

The material will undergo pyrolysis to form carbon, as previously described. In some embodiments, pyrolysis dwell time (the period of time during which the sample is at the desired temperature) is from about 0 minutes to about 180 minutes, from about 10 minutes to about 120 minutes, from about 30 minutes to about 100 minutes, from about 40 minutes to about 80 minutes, from about 45 to 70 minutes or from about 50 to 70 minutes.

Pyrolysis may also be carried out more slowly than described above. For example, in one embodiment the pyrolysis is carried out in about 120 to 480 minutes. In other embodiments, the pyrolysis is carried out in about 120 to 240 minutes.

In some embodiments, pyrolysis dwell temperature ranges from about 500° C. to 2400° C. In some embodiments, pyrolysis dwell temperature ranges from about 650° C. to 1800° C. In other embodiments pyrolysis dwell temperature ranges from about 700° C. to about 1200° C. In other embodiments pyrolysis dwell temperature ranges from about 850° C. to about 1050° C. In other embodiments pyrolysis dwell temperature ranges from about 1000° C. to about 1200° C.

After pyrolysis the surface area of the carbon as measured by nitrogen sorption may vary between 0 and 500 m²/g, 0 and 250 m²/g, 5 and 100 m²/g, 5 and 50 m²/g. In other embodiments, the surface area of the carbon as measured by nitrogen sorption may vary between 250 and 500 m²/g, 300 and 400 m²/g, 300 and 350 m²/g, 350 and 400 m²/g.

### C. Characterization of Polymer Gels and Carbon Materials

The structural properties of the final carbon material and intermediate polymer gels may be measured using Nitrogen sorption at 77K, a method known to those of skill in the art. The final performance and characteristics of the finished carbon material is important, but the intermediate products (both dried polymer gel and pyrolyzed, but not activated, polymer gel), can also be evaluated, particularly from a quality control standpoint, as known to those of skill in the art. The Micromeretics ASAP 2020 is used to perform detailed micropore and mesopore analysis, which reveals a pore size distribution from 0.35 nm to 50 nm in some embodiments. The system produces a nitrogen isotherm starting at a pressure of 10⁻⁷ atm, which enables high resolution pore size distributions in the sub 1 nm range. The software generated reports utilize a Density Functional Theory (DFT) method to calculate properties such as pore size distributions, surface area distributions, total surface area, total pore volume, and pore volume within certain pore size ranges.

The impurity and optional electrochemical modifier content of the carbon materials can be determined by any number of analytical techniques known to those of skill in the art. One particular analytical method useful within the context of the present disclosure is proton induced x-ray emission (PIXE). This technique is capable of measuring the concentration of elements having atomic numbers ranging from 11 to 92 at low ppm levels. Accordingly, in one embodiment the concentration of electrochemical modifier, as well as all other elements, present in the carbon materials is determined by PIXE analysis.

### D. Devices Comprising the Carbon Materials

The disclosed carbon materials can be used as electrode material in any number of electrical energy storage and distribution devices. For example, in one embodiment the present disclosure provides a lithium-based electrical energy storage device comprising an electrode prepared from the disclosed carbon materials. Such lithium based devices are superior to previous devices in a number of respects including gravimetric and volumetric capacity and first cycle efficiency. Electrodes comprising the disclosed carbon materials are also provided.

Accordingly, in one embodiment, the present disclosure provides an electrical energy storage device comprising:

a) at least one anode comprising a hard carbon material;

b) at least cathode comprising a metal oxide; and

c) an electrolyte comprising lithium ions;

wherein the electrical energy storage device has a first cycle efficiency of at least 50% and a reversible capacity of at least 200 mAh/g with respect to the mass of the hard carbon material. In other embodiments, the efficiency is measured at a current density of about 100 mA/g with respect to the mass of the active hard carbon material in the anode. In still other embodiments, the efficiency is measured at a current density of about 1000 mA/g with respect to the mass of the active hard carbon material in the anode.

In some embodiments the properties of the device are tested electrochemically between upper and lower voltages of 3V and −20 mV, respectively. In other embodiments the lower cut-off voltage is between 50 mV and −20 mV, between 0V and −15 mV, or between 10 mV and 0V. Alternatively, the device is tested at a current density of 40 mA/g with respect to the mass of carbon material.

The hard carbon material may be any of the hard carbon materials described herein. In other embodiments, the first cycle efficiency is greater than 55%. In some other embodiments, the first cycle efficiency is greater than 60%. In yet other embodiments, the first cycle efficiency is greater than 65%. In still other embodiments, the first cycle efficiency is greater than 70%. In other embodiments, the first cycle efficiency is greater than 75%, and in other embodiments, the first cycle efficiency is greater than 80%, greater than 90%, greater than 95%, greater than 98%, or greater than 99%. In some embodiments of the foregoing, the hard carbon material comprises a surface area of less than about 300 m²/g. In other embodiments, the hard carbon material comprises a pore volume of less than about 0.1 cc/g. In still other embodiments of the foregoing, the hard carbon material comprises a surface area of less than about 300 m²/g and a pore volume of less than about 0.1 cc/g.

In another embodiment of the foregoing electrical energy storage device, the electrical energy storage device has a volumetric capacity (i.e., reversible capacity) of at least 400 mAh/cc. In other embodiments, the volumetric capacity is at least 450 mAh/cc. In some other embodiments, the volumetric capacity is at least 500 mAh/cc. In yet other embodiments, the volumetric capacity is at least 550 mAh/cc. In still other embodiments, the volumetric capacity is at least 600 mAh/cc. In other embodiments, the volumetric capacity is at least 650 mAh/cc, and in other embodiments, the volumetric capacity is at least 700 mAh/cc.

In another embodiment the device, the device has a gravimetric capacity (i.e., reversible capacity, based on mass of hard carbon) of at least 150 mAh/g. In other embodiments, the gravimetric capacity is at least 200 mAh/g. In some other embodiments, the gravimetric capacity is at least 300 mAh/g. In yet other embodiments, the gravimetric capacity is at least 400 mAh/g. In still other embodiments, the gravimetric capacity is at least 500 mAh/g. In other embodiments, the gravimetric capacity is at least 600 mAh/g, and in other embodiments, the gravimetric capacity is at least 700 mAh/g, at least 800 mAh/g, at least 900 mAh/g, at least 1000 mAh/g, at least 1100 mAh/g or even at least 1200 mAh/g. In some particular embodiments the device has a gravimetric capacity ranging from about 550 mAh/g to about 750 mAh/g.

Some of the capacity may be due to surface loss/storage, structural intercalation or storage of lithium within the pores. Structural storage is defined as capacity inserted above 50 mV vs Li/Li while lithium pore storage is below 50 mV versus Li/Li⁺ but above the potential of lithium plating. In one embodiment, the storage capacity ratio of a device between structural intercalation and pore storage is between 1:10 and 10:1. In another embodiment, the storage capacity ratio of a device between structural intercalation and pore storage is between 1:5 and 1:10. In yet another embodiment, the storage capacity ratio of a device between structural intercalation and pore storage is between 1:2 and 1:4. In still yet another embodiment, the storage capacity ratio of a device between structural intercalation and pore storage is between 1:1.5 and 1:2. In still another embodiment, the storage capacity ratio of a device between structural intercalation and pore storage is 1:1. The ratio of capacity stored through intercalation may be greater than that of pore storage in a device. In another embodiment, the storage capacity ratio of a device between structural intercalation and pore storage is between 10:1 and 5:1. In yet another embodiment, the storage capacity ratio of a device between structural intercalation and pore storage is between 2:1 and 4:1. In still yet another embodiment, the storage capacity ratio of a device between structural intercalation and pore storage is between 1.5:1 and 2:1.

Due to structural differences, lithium plating may occur at different voltages. The voltage of lithium plating is defined as when the voltage increases despite lithium insertion at a slow rate of 20 mA/g. In one embodiment the voltage of lithium plating of a device collected in a half-cell versus lithium metal at a current density of 20 mA/g is 0V. In another embodiment the voltage of lithium plating of a device collected in a half-cell versus lithium metal at a current density of 20 mA/g is between 0V and −5 mV. In yet another embodiment the voltage of lithium plating of a device collected in a half-cell versus lithium metal at a current density of 20 mA/g is between −5 mV and −10 mV. In still yet another embodiment the voltage of lithium plating of a device collected in a half-cell versus lithium metal at a current density of 20 mA/g is between −10 mV and −15 mV. In still another embodiment the voltage of lithium plating of a device collected in a half-cell versus lithium metal at a current density of 20 mA/g ranges from −15 mV to −20 mV. In yet another embodiment the voltage of lithium plating of a device collected in a half-cell versus lithium metal at a current density of 20 mA/g is below −20 mV.

In some embodiments of the foregoing, the hard carbon material comprises a surface area of less than about 300 m²/g. In other embodiments, the hard carbon material comprise a pore volume of less than about 0.1 cc/g. In still other embodiments of the foregoing, the hard carbon material comprises a surface area of less than about 300 m²/g and a pore volume of less than about 0.1 cc/g.

In yet still another embodiment of the foregoing electrical energy storage device, the electrical energy storage device has a volumetric capacity at least 5% greater than the same device which comprises a graphite electrode. In still other embodiments, the electrical energy storage device has a gravimetric capacity that is at least 10% greater, at least 20% greater, at least 30% greater, at least 40% greater or at least 50% than the gravimetric capacity of the same electrical energy storage device having a graphite electrode.

Embodiments wherein the cathode is comprised of a material other than a metal oxide are also envisioned. For examples, another embodiment, the cathode is comprised of a sulfur-based material rather than a metal oxide. In still other embodiments, the cathode comprises a lithium containing metal-phosphate. In still other embodiments, the cathode comprises lithium metal. In still other embodiments, the cathode is a combination of two or more of any of the foregoing materials. In still other embodiments, the cathode is an air cathode.

For ease of discussion, the above description is directed primarily to lithium based devices; however the disclosed carbon materials find equal utility in sodium based devices and such devices (and related carbon materials) are included within the scope of the invention.

### EXAMPLES

The polymer gels, pyrolyzed cryogels and carbon materials disclosed in the following Examples were prepared according to the methods disclosed herein. Chemicals were obtained from commercial sources at reagent grade purity or better and were used as received from the supplier without further purification.

Unless indicated otherwise, the following conditions were generally employed for preparation of the carbon materials and precursors. Phenolic compound and aldehyde were reacted in the presence of a catalyst in a binary solvent system (e.g., water and acetic acid). The molar ratio of phenolic compound to aldehyde was typically 0.5 to 1. For monolith procedures, the reaction was allowed to incubate in a sealed container at temperatures of up to 85° C. for up to 24 h. The resulting polymer hydrogel contained water, but no organic solvent; and was not subjected to solvent exchange of water for an organic solvent, such as t-butanol. The polymer hydrogel monolith was then physically disrupted, for example by grinding, to form polymer hydrogel particles having an average diameter of less than about 5 mm.

The wet polymer hydrogel was typically pyrolyzed by heating in a nitrogen atmosphere at temperatures ranging from 800-1200° C. for a period of time as specified in the examples. Specific pyrolysis conditions were as described in the following examples.

Where appropriate, impregnation of the carbon materials with electrochemical modifiers was accomplished by including a source of the electrochemical modifier in the polymerization reaction or contacting the carbon material, or precursors of the same (e.g., polymer hydrogel, dried polymer hydrogel, pyrolyzed polymer gel, etc.), with a source of the electrochemical modifier as described more fully above and exemplified below.

### Example 1

### Monolith Preparation of Wet Polymer Gel

Polymer gels were prepared using the following general procedure. A polymer gel was prepared by polymerization of resorcinol and formaldehyde (0.5:1) in water and acetic acid (75:25) and ammonium acetate (RC=10, unless otherwise stated). The reaction mixture was placed at elevated temperature (incubation at 45° C. for about 6 h followed by incubation at 85° C. for about 24 h) to allow for gellation to create a polymer gel. Polymer gel particles were created from the polymer gel and passed through a 4750 micron mesh sieve. In certain embodiments the polymer is rinsed in a urea or polysaccharide solution. While not wishing to be bound by theory, it is believed such treatment may either impart surface functionality or alter the bulk structure of the carbon and improve the electrochemical characteristics of the carbon materials.

### Example 2

Alternative Monolith Preparation of Wet Polymer Gel

Alternatively to Example 1, polymer gels were also prepared using the following general procedure. A polymer gel was prepared by polymerization of urea and formaldehyde (1:1.6) in water (3.3:1 water:urea) and formic acid. The reaction mixture was stirred at room temperature until gellation to create a white polymer gel. Polymer gel particles were created through manually crushing.

The extent of crosslinking of the resin can be controlled through both the temperature and the time of curing. In addition, various amine containing compounds such as urea, melamine and ammonia can be used. One of ordinary skill in the art will understand that the ratio of aldehyde (e.g., formaldehyde) to solvent (e.g., water) and amine containing compound can be varied to obtain the desired extent of cross linking and nitrogen content.

### Example 3

### Post-Gel Chemical Modification

A nitrogen containing hard carbon was synthesized using a resorcinol-formaldehyde gel mixture in a manner analogous to that described in Example 1. About 20 mL of polymer solution was obtained (prior to placing solution at elevated temperature and generating the polymer gel). The solution was then stored at 45° C. for about 5 h, followed by 24 h at 85° C. to fully induce cross-linking. The monolith gel was broken mechanically and milled to particle sizes below 100 microns. The gel particles were then soaked for 16 hours in a 30% saturated solution of urea (0.7:1 gel:urea and 1.09:1 gel:water) while stirring. After the excess liquid was decanted, the resulting wet polymer gel was allowed to dry for 48 hours at 85° C. in air then pyrolyzed by heating from room temperature to 1100° C. under nitrogen gas at a ramp rate of 10° C. per min to obtain a hard carbon containing the nitrogen electrochemical modifier.

In various embodiments of the above method, the gel particles are soaked for about 5 minutes to about 100 hrs, from about 1 hour to about 75 hours, from about 5 hours to about 60 hours, from about 10 hours to 50 hours, from about 10 hours to 20 hours from about 25 hours to about 50 hours, or about 40 hours. In certain embodiments the soak time is about 16 hours.

The drying temperature may be varied, for example from about room temperature (e.g. about 20-25 C) to about 10° C., from about 25 C to about 10° C., from about 50 to about 90 C, from about 75 C to about 95 C, or about 85 C.

Ratio of the polymer gel to the soak composite (e.g., a compound such as urea, melamine, ammonia, sucrose etc. or any of the compounds listed in table 1) can also be varied to obtain the desired result. The ratio of gel to nitrogen containing compound ranges from about 0.01:1 to about 10:1, from about 0.1:1 to about 10:1, from about 0.1:1 to about 5:1, from about 1:1 to about 5:1, from about 0.2:1 to about 1:1 or from about 0.4:1 to about 0; 9:1.

The ratio of gel to water can also range from about 0.01:1 to about 10:1, from about 0.5:1 to about 1.5:1, from about 0.7:1 to about 1.2:1 or from about 0.9:1 to about 1.1:1.

Various solvents such as water, alcohols, oils and/or ketones may used for soaking the polymer gel as described above. Various embodiments of the invention include polymer gels which have been prepared as described above (e.g., contain nitrogen as a result of soaking in a nitrogen containing compound) as well as carbon materials prepared from the same (which also contain nitrogen). Methods according to the general procedure described above are also included within the scope of the invention.

The concentration of the soak composite (e.g., one or more compound from Table 1) in the solvent in which it is soaked may be varied from about 5% to close to 100% by weight. In other embodiments, the concentration ranges from about 10% to about 90%, from about 20% to about 85%, from about 25% to about 85%, from about 50% to about 80% or from about 60% to about 80%, for example about 70%.

While not wishing to be bound by theory, it is believe that in certain embodiments the gel may undergo further cross linking while being soaked in the solution containing a compound from Table I.

### Example 4

### Preparation of Pyrolyzed Carbon Material from Wet Polymer Gel

Wet polymer gel prepared according to Examples 1-3 was pyrolyzed by passage through a rotary kiln at 1100° C. with a nitrogen gas flow of 200 L/h. The weight loss upon pyrolysis was about 85%.

The surface area of the pyrolyzed dried polymer gel was examined by nitrogen surface analysis using a surface area and porosity analyzer. The measured specific surface area using the standard BET approach was in the range of about 150 to 200 m²/g. The pyrolysis conditions, such as temperature and time, are altered to obtain hard carbon materials having any number of various properties.

In certain embodiments, the carbon after pyrolysis is rinsed in either a urea or polysaccharide solution and re-pyrolyzed at 600° C. in an inert nitrogen atmosphere. In other embodiments, the pyrolysis temperature is varied to yield varying chemical and physical properties of the carbon.

The wet gel may also be pyrolyzed in a non-inert atmosphere such as ammonia gas. A 5 gram sample first purged under a dynamic flow of 5% ammonia/95% N2 volume mixture. The sample is then heated to 900° C. under the ammonia/N2 flow. The temperature is held for 1 hour, wherein the gas is switched to pure nitrogen for cool down. The material is not exposed to an oxygen environment until below 150° C.

### Example 5

### Micronization of Hard Carbon Via Jet Milling

Carbon material prepared according to Example 2 was jet milled using a Jet Pulverizer Micron Master 2 inch diameter jet mill. The conditions comprised about 0.7 lbs of activated carbon per hour, nitrogen gas flow about 20 scf per min and about 100 psi pressure. The average particle size after jet milling was about 8 to 10 microns.

### Example 6

### Post-Carbon Surface Treatment

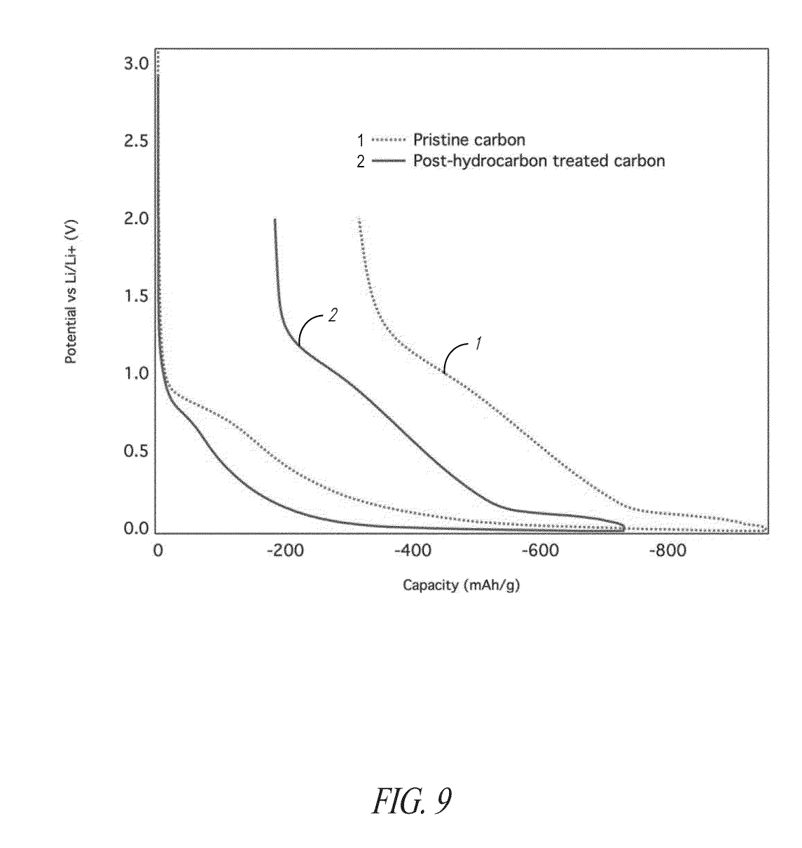

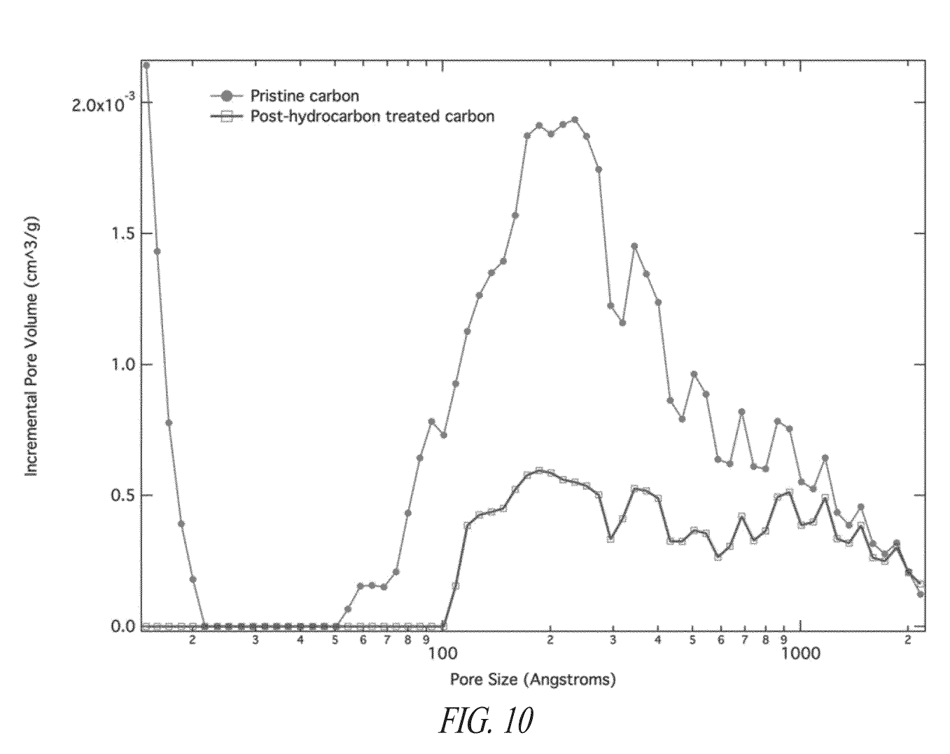

The 1^{st} cycle lithiation efficiency of the resulting hard carbon from example 5 can be improved via a non-oxygen containing hydrocarbon (from Table 1) treatment of the surface. In a typical embodiment the micronized/milled carbon is heated to 800° C. in a tube furnace under flowing nitrogen gas. At peak temperature the gas is diverted through a flask containing liquid cyclohexane. The cyclohexane then pyrolyzes on the surface of the hard carbon. FIG. 9 shows the superior electrochemical performance of the surface treated hard carbon. The modified pore size distribution is shown in FIG. 10. Exemplary surface areas of untreated and hydrocarbon treated hard carbon materials are presented in Table 2.

TABLE 2
Carbon Surface Areas Before and After Surface Treatment
with Hydrocarbons

| | BET surface area (m²/g) | BET surface area (m²/g) |
|---|---|---|
| | Before surface treatment | After surface treatment |
| Carbon A | 275 | 0.580 |
| Carbon B | 138 | 0.023 |

### Example 7

### Properties of Various Hard Carbons

Carbon materials were prepared in a manner analogous to those described in the above Examples and their properties measured. The electrochemical performance and certain other properties of the carbon samples are provided in Table 3. The data in Table 3 show that the carbons with surface area ranging from about 200 to about 700 m²/g and pore volumes ranging from about 0.1 to about 0.7 cc/g) had the best 1^{st} cycle efficiency and reversible capacity (Qᵣₑᵥ).

TABLE 3
Certain Properties of Exemplary Hard Carbon Materials

| | Properties | | | | |
|---|---|---|---|---|---|
| | | Specific | | | |
| | Skeletal | Surface | | Tap | |
| | Density | Area | Total Pore | Density | |
| Sample | (g/cc) | (m2/g) | Volume (cc/g) | (g/cc) | pH |
| Carbon 1 | — | 3.6 | 0.003 | 0.528 | — |
| Carbon 2 | 2.02 | 11.4 | 0.000882 | 0.97 | — |
| Carbon 3 | — | 241.7 | 0.11 | — | — |
| Carbon 4 | 1.44 | 338 | 0.14 | — | 7.038 |
| Carbon 5 | — | 705 | 0.57 | 0.44 | 3.8 |
| Carbon 6 | 1.89 | 1618 | 1.343 | 0.18 | 8.98 |
| Carbon 7 | 2.28 | 1755 | 0.798 | 0.36 | 5.41 |

| | Electrochemical Performances | | |
|---|---|---|---|
| | Q (initial) mAh/g | Q (rev) mAh/g | 1st cycle eff. (%) |
| Carbon 1 | 171 | 111 | 64 |
| Carbon 2 | 679 | 394 | 58 |
| Carbon 3 | 807 | 628 | 78 |
| Carbon 4 | 325 | 208 | 64 |
| Carbon 5 | 1401 | 566 | 40 |
| Carbon 6 | 1564 | 242 | 15 |
| Carbon 7 | 1366 | 314 | 23 |

The pore size distribution of exemplary hard carbons is provided in FIG. 1, which shows that hard carbon materials having pore size distributions ranging from microporous to mesoporous to macroporous can be obtained. The data also shows that the pore structure may also determine the packing and volumetric capacities of the material when used in a device. FIG. 2 depicts storage of lithium per unit volume of the device as a function of cycle number. The data from FIG. 2 correlates well with the data from FIG. 1. The two microporous materials display the highest volumetric capacity, possibly due to a higher density material. The mesoporous material has the third highest volumetric capacity while the macroporous material has the lowest volumetric capacity. While not wishing to be bound by theory, it is believed that the macroporous materials create empty spaces within the device, void of carbon for energy storage.

The particle size and particle size distribution of the hard carbon materials may affect the carbon packing efficiency and may contribute to the volumetric capacity of electrodes comprising the carbon materials. The particle size distribution of two exemplary hard carbon materials is presented in FIG. 3. Thus both single Gaussian and bimodal particle size distributions can be obtained. Other particle size distributions can be obtained by altering the synthetic parameters and/or through post processing such as milling or grinding.

As noted above, the crystallite size (Lₐ) and range of disorder may have an impact on the performance, such as energy and power density, of a hard carbon anode. Disorder, as determined by RAMAN spectroscopy, is a measure of the size of the crystallites found within both amorphous and crystalline structures (M. A. Pimenta, G. Dresselhaus, M. S. Dresselhaus, L.

G. Can ado, A. Jorio, and R. Saito, “Studying disorder in graphite-based systems by Raman spectroscopy,” Physical Chemistry Chemical Physics, vol. 9, no. 11, p. 1276, 2007). RAMAN spectra for exemplary hard carbon examples are depicted in FIG. 4, while crystallite sizes and electrochemical properties are listed in table 4. Data was collected with the wavelength of the light at 514 nm.

TABLE 4
Crystallite size and electrochemical properties for DOE carbons

| Carbon | | | 2^{nd} Lithium insertion |
|---|---|---|---|
| Sample | R | Lₐ (nm) | (mAh/g) |
| Carbon A | 0.6540 | 25.614 | 380 |
| Carbon B | 0.908 | 18.45 | 261 |
| Carbon C | 0.8972 | 18.67 | 268 |
| Carbon D | 0.80546 | 20.798 | 353 |

The data in Table 4 shows a possible trend between the available lithium sites for insertion and the range of disorder/crystallite size. This crystallite size may also affect the rate capability for carbons since a smaller crystallite size may allow for lower resistive lithium ion diffusion through the amorphous structure. Due to the possible different effects that the value of disorder has on the electrochemical output, this present invention includes embodiments having high and low levels of disorder.

TABLE 5
Example results of CHNO analysis of carbons

| Sample | C | H | N | O | C:N Ratio |
|---|---|---|---|---|---|
| Carbon A | 80.23 | <0.3 | 14.61 | 3.44 | 1:1.82 |
| Carbon B | 79.65 | <0.3 | 6.80 | 7.85 | 1:0.085 |
| Carbon C | 84.13 | <0.3 | 4.87 | 6.07 | 1:0.058 |
| Carbon D | 98.52 | <0.3 | 0.43 | <0.3 | 1:0.0044 |
| Carbon E | 94.35 | <0.3 | 1.76 | <3.89 | 1:0.019 |

The data in Table 5 shows possible compositions of hard carbons as measured by CHNO analysis. The nitrogen content may be added either in the polymer gel synthesis (Carbon A and B), during soaking of the wet polymer gel (Carbon C), or after carbon synthesis. It is possible that the nitrogen content or the C:N ratio may create a different crystalline or surface structure, allowing for the reversible storage of lithium ions. Due to the possible different effects nitrogen content may play in lithium kinetics, the present invention includes embodiments having both low and high quantities of nitrogen.

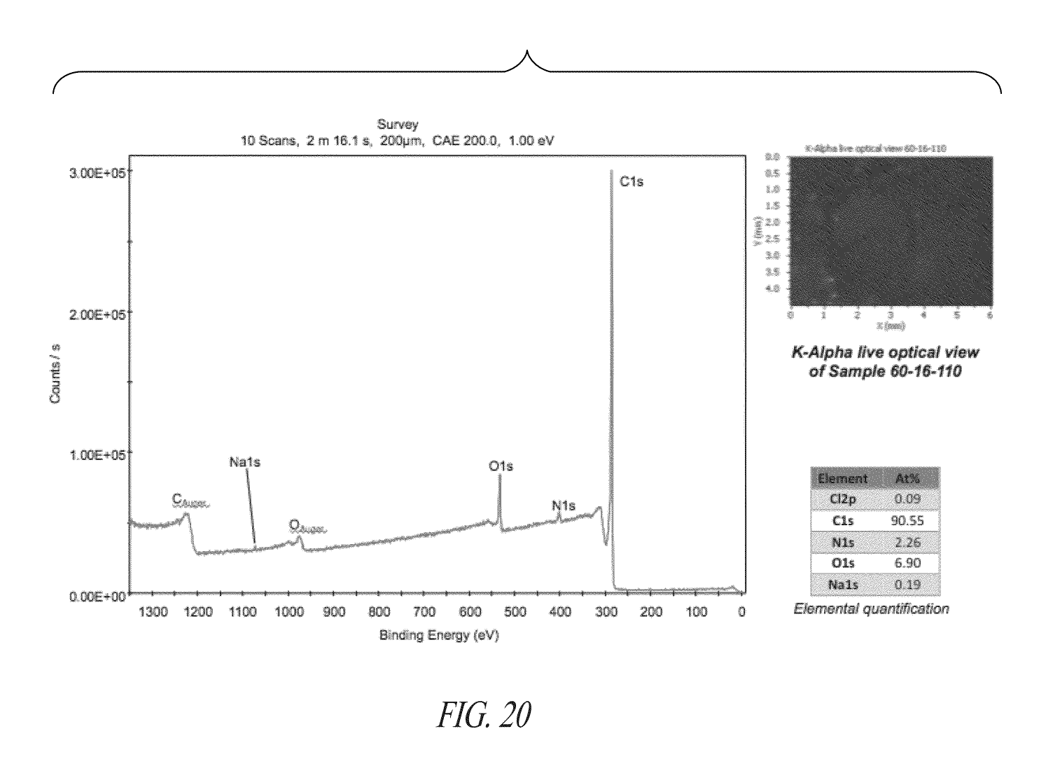

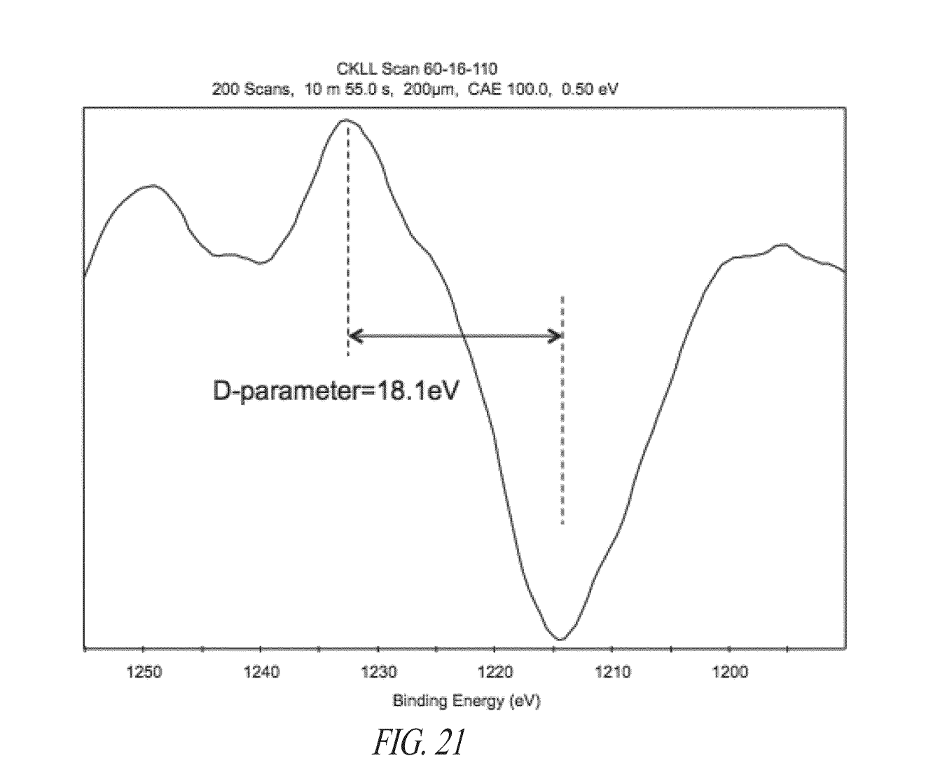

The elemental composition of the hard carbon may also be measured through XPS. FIG. 20 shows a wide angle XPS for an outstanding, unique carbon. The carbon has 2.26% nitrogen content, 90.55% carbon with 6.90% oxygen content. FIG. 21 uses Auger to indicate an sp2/sp3 hybridization percent concentration of 65%.

Exemplary carbon materials were also analyzed by X-ray diffraction (XRD) to determine the level of crystallinity (see FIG. 5). While Raman measures the size of the crystallites, XRD records the level of periodicity in the bulk structure through the scattering of incident X-rays. This invention include embodiments which are non-graphitic (crystallinity <10%) and semi-graphitic (crystallinity between 10 and 50%). In FIG. 5, the broad, dull peaks are synonymous with amorphous carbon, while sharper peaks indicate a higher level of crystal structure. Materials with both sharp and broad peaks are labeled as semi-graphitic. In addition to XRD, the bulk structure of the carbon materials is also characterized by hardness or Young's Elastic modulus.

For structural analysis, the carbon material may also be analyzed using Small Angle X-ray Diffraction (SAXS) (see FIGS. 6 and 7). Between 10° and 40°, the scattering angle is an indication of the number of stacked graphene sheets present within the bulk structure. For a single graphene sheet (N=1), the SAXS response is a simple negative sloping curve. For a double graphene stack (N=2), the SAXS is a single peak at ˜22° with a baseline at 0°. Initial test of an EnerG2 carbon indicates a mixed-bulk structure of both single layer graphene sheets and double stacked graphene layers. The percentage of single-double layers can be calculated from an empirical value (R) that compares the intensities of the single (A) and double component (B). Since lithium is stored within the layers, the total reversible capacity can be optimized by tailoring the internal carbon structure. Example SAXS of exemplary carbons is depicted in FIG. 7. Notice that single, double, and even tri-layer features are present in some of the carbons.

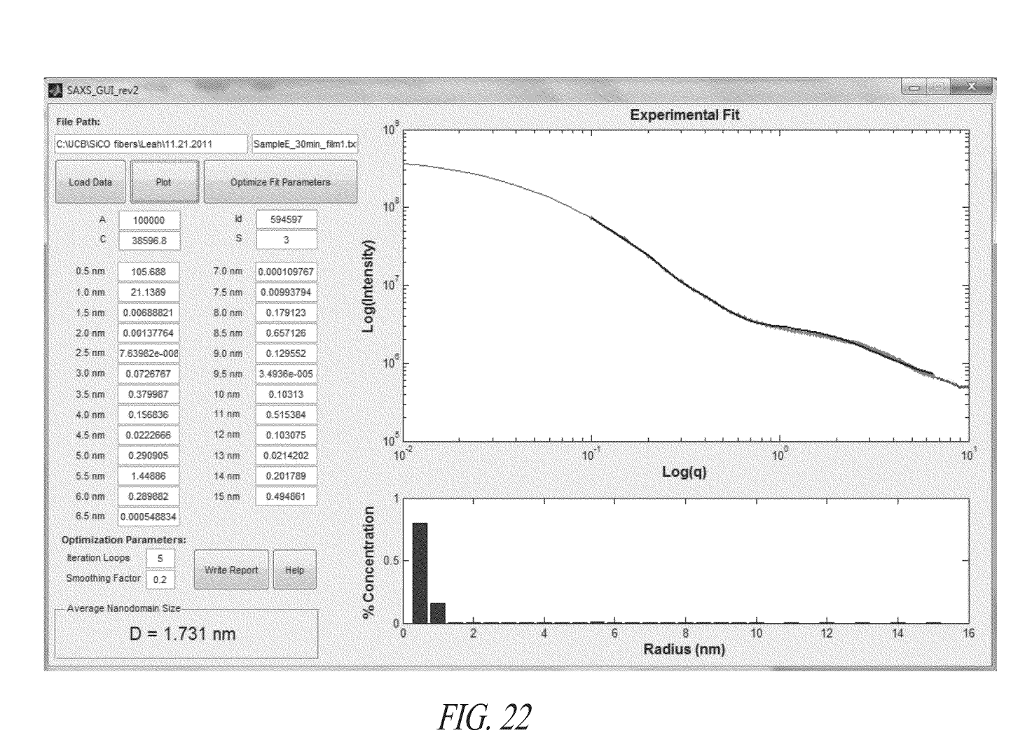

Not being bound by theory SAXS may also be used to measure the internal pore size distribution of the carbon. FIG. 22 shows the SAXS curve and the pore size distribution for pore smaller than 16 nm. In this example, the nitrogen containing carbon has between 0.5 and 1% of pores below 1 nm in radius.

As discussed in more detail above, the surface chemistry (e.g., presence of organics on the carbon surface) is a parameter that is adjusted to optimize the carbon materials for use in the lithium-based energy storage devices. Infra-red spectroscopy (FTIR) can be used as a metric to determine both surface and bulk structures of the carbon materials when in the presence of organics. FIG. 8a depicts FTIR spectra of certain exemplary carbons of the present disclosure. In one embodiment, the FTIR is featureless and indicates a carbon structure void of organics (e.g., carbons B and D). In another embodiment, the FTIR depicts large hills and valleys relating to a high level of organic content (e.g., carbons A and C).

As shown in FIG. 8b, presence of organics may have a direct relationship on the electrochemical performance and response of the carbon material when incorporated into an electrode in a lithium bearing device for energy storage. Accordingly, in some embodiments the carbon material comprises organic functionality as determined by FTIR analysis. The samples with flat FTIR signals (no organics) display a low extraction peak in the voltage profile at 0.2 V. Well known to the art, the extract voltage is typical of lithium stripping. The lithium stripping plateau is absent in the two FTIR samples that display organic curves in FTIR.

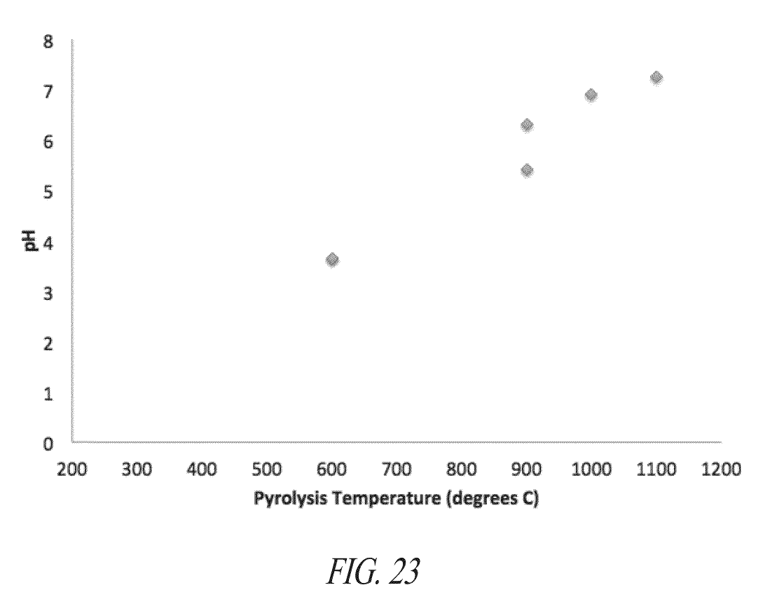

The pH of the carbon can also be controlled through the pyrolysis temperature. FIG. 23 shows pH as the pyrolysis temperature increases. Not being bound by theory, as the temperature of pyrolysis is increased, the surface functionality and the pH of the carbon will rise, becoming more basic. Tailoring the pH can be accomplished post-pyrolysis through heat treatment or an additional pyrolysis step.

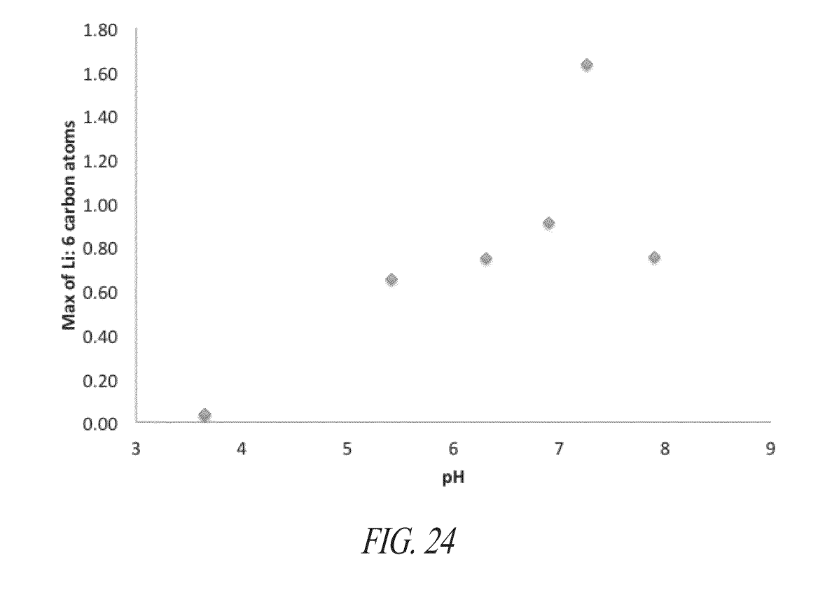

The material may also be characterized as the Li:C ratio, wherein there is no metallic lithium present. FIG. 24 shows an unexpected result wherein the maximum ratio of Li:C possible without the presence of metallic lithium is greater than 1.6 for a carbon between the pH values of 7 and 7.5.

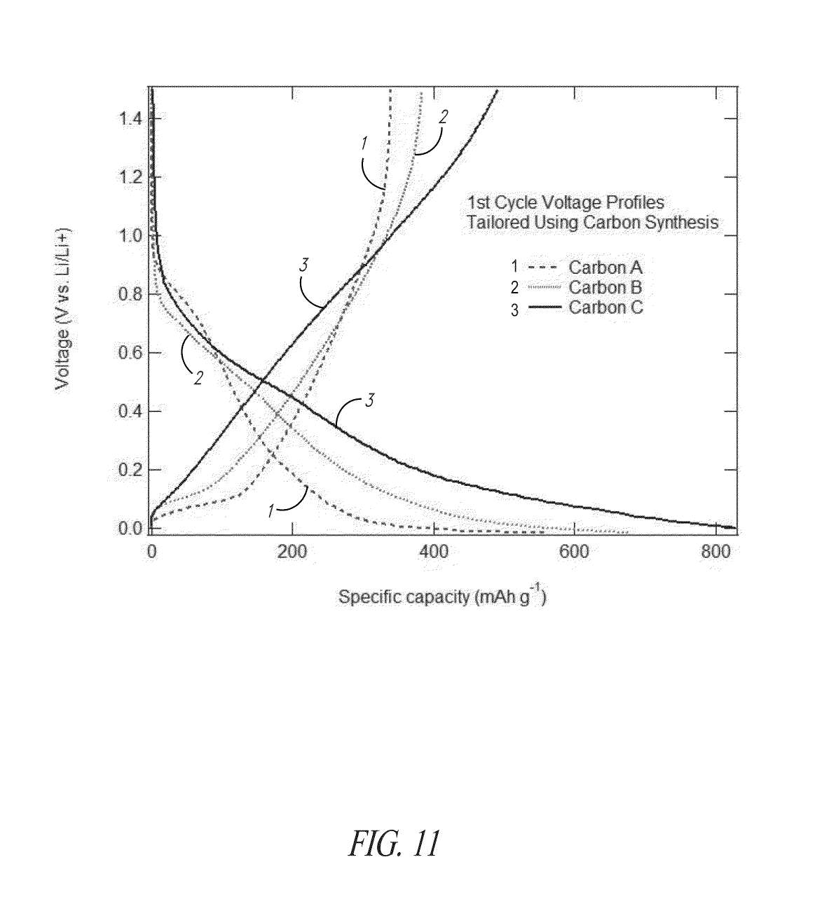

FIG. 11 shows 1^{st} cycle voltage profiles for three exemplary carbons containing between 1.5% and 6% nitrogen, prepared as described above. As the data shows, the total capacity and operating voltage can be tailored to the desired application. Carbon A has been tuned to have lowest gravimetric capacity upon extraction, though it is superior of all of the carbons in energy density due to the plateau close to zero. Carbon B has a smaller plateau but a larger gravimetric capacity than A. Carbon C is advantageous for vehicular applications due to its sloping voltage profile. This sloping profile allows for easy gauging of the state-of-charge (SOC) of the battery, which is difficult with flat plateaus.

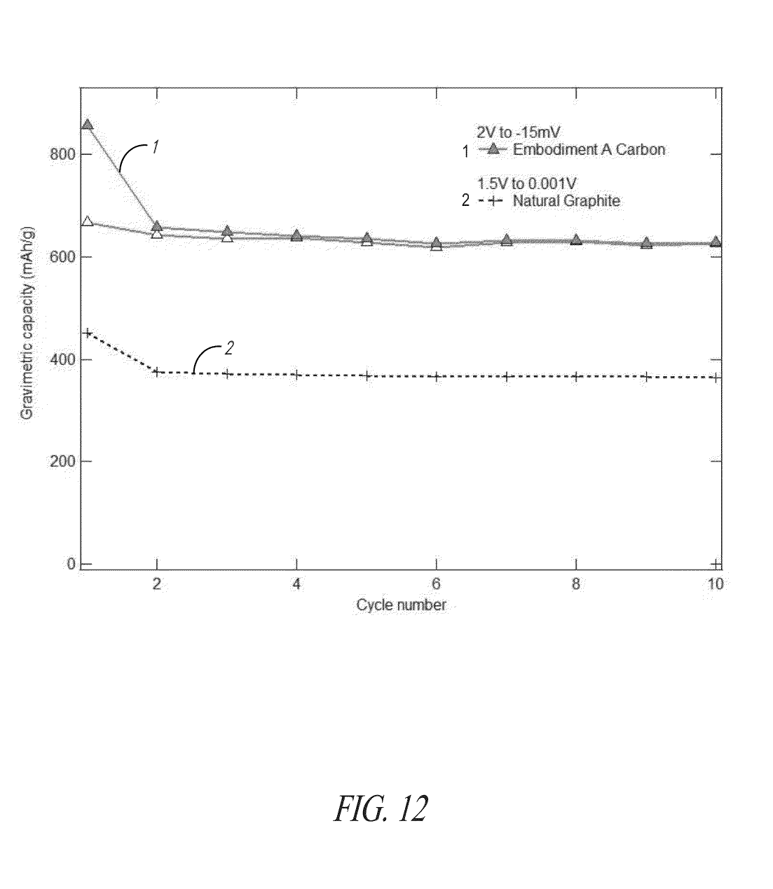

FIG. 12 shows the gravimetric capacity of an exemplary embodiment compared to the theoretical maximum capacity of traditional commercial graphite versus lithium metal, thus demonstrating that the presently disclosed carbon materials represent an improvement over previously known materials. The solid points represent lithium insertion while the open points represent lithium extraction. The carbon is both ultra-pure with a low percentage of impurities as measured by PIXE and with 1.6% nitrogen content and where the maximum atomic Li:C ratio without the presence of metallic lithium is 1.65:6.

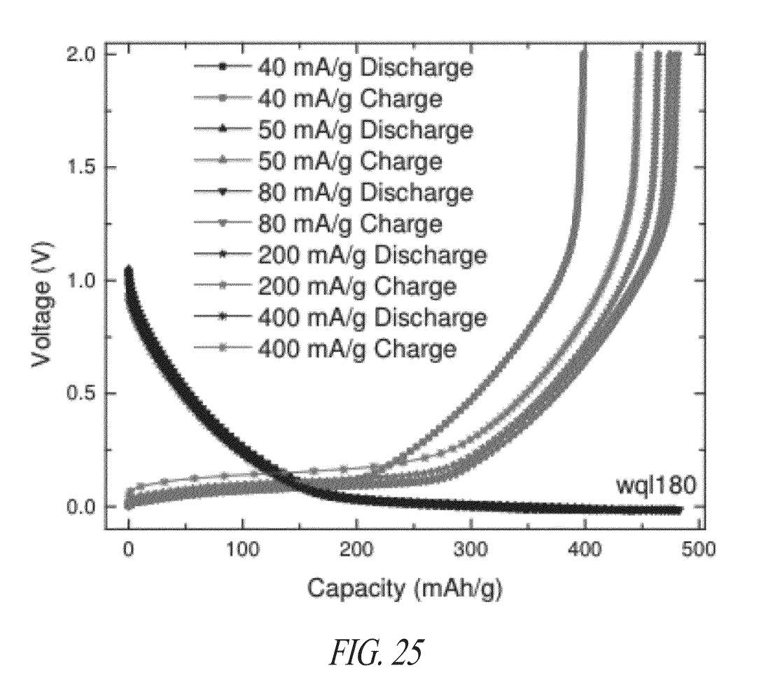

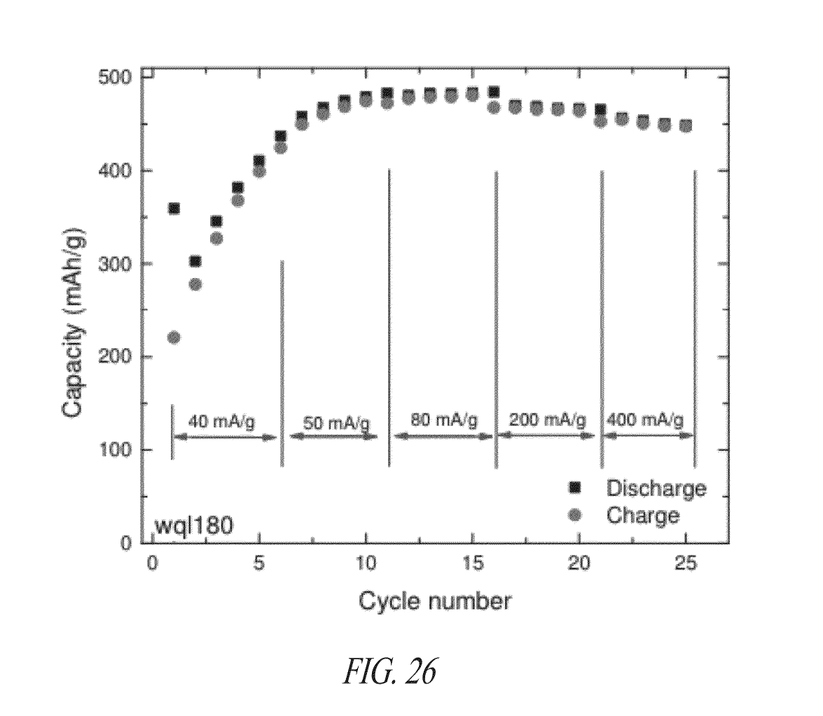

FIGS. 25 and 26 shows the capacity of an exemplary, ultrapure hard carbon as measured by a third party laboratory. The material shows excellent efficiency, capacity and rate capability. The material can be described as having 1.6% nitrogen content and where the maximum atomic Li:C ratio without the presence of metallic lithium is 1.65:6.

### Example 8

### Incorporation of Electrochemical Modifiers into Carbon Materials

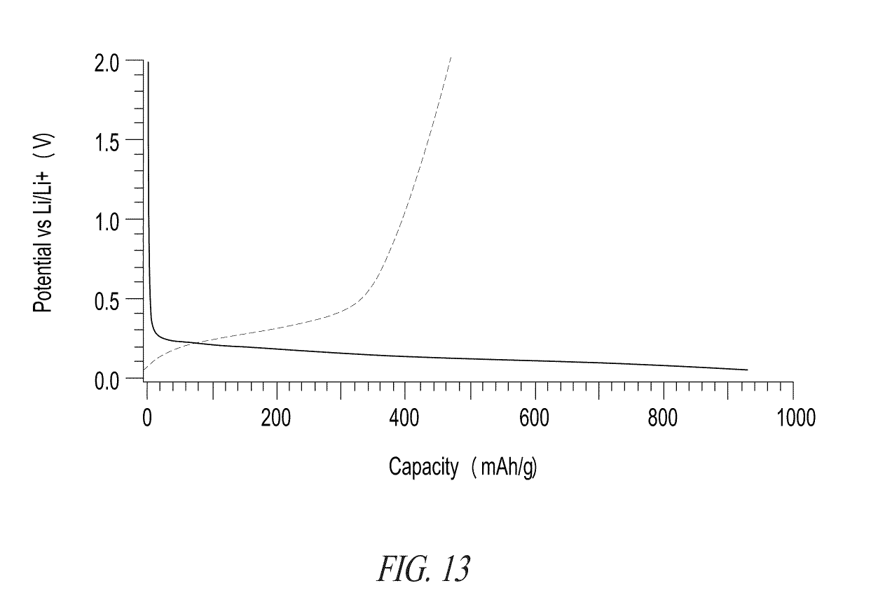

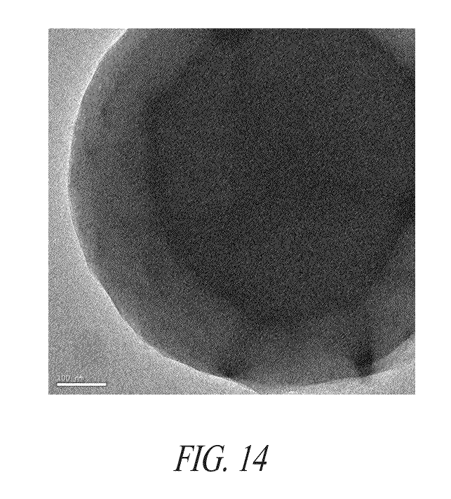

Silicon was incorporated into the carbon structure by mixing silicon powder directly with the gel prior to polymerization. After pyrolysis, the silicon was found to be encased in carbon matrix. The silicon powder may be nano-sized (<1 micron) or micron-sized (between 1 and 100 microns). In an alternative embodiment, the silicon-carbon composite was prepared by mechanically mixing for 10 minutes in a mortar and pestel, 1:1 by weight micronized silicon (−325 mesh) powder and micronized microporous non-activated carbon. For electrochemical testing the silicon-carbon powder was mixed into a slurry with the composition 80:10:10 (silicon-carbon:conductivity enhancer (carbon black):binder (polyvinylidene fluoride)) in n-methylpyrrolidone solvent then coated onto a copper current collector. Other embodiments may utilize nano (<100 nm) silicon powder. FIG. 13 depicts the voltage vs. specific capacity (mass relative to silicon) for this silicon-carbon composite. FIG. 14 shows a TEM of a silicon particle embedded into a hard carbon particle.

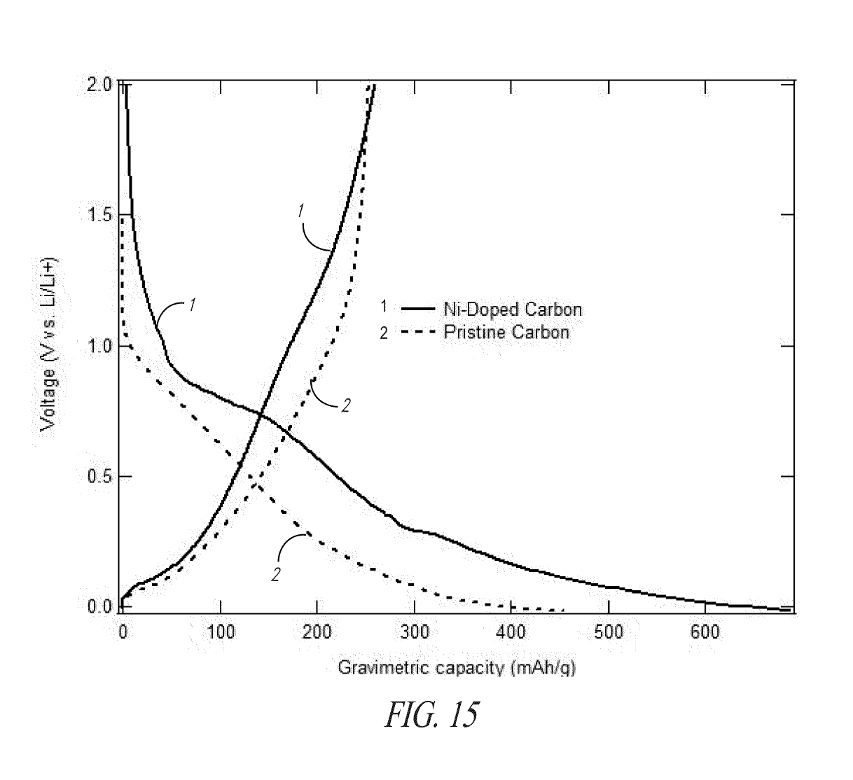

A resorcinol-formaldehyde-iron composite gel was prepared by combining resorcinol, 37 wt % formaldehyde solution, methanol, and nickel acetate in the weight ratio 31:46:19:4 until all components were dissolved. The mixture was kept at 45° C. for 24 hours until polymerization was complete. The gel was crushed and pyrolyzed at 650° C. for 1 hr in flowing nitrogen gas. Iron or manganese containing carbon materials are prepared in an analogous manner by use of nickel acetate or manganese acetate, respectively, instead of iron. Different pyrolysis temperatures (e.g., 900° C., 1000° C., etc.) may also be used. Table 6 summarizes physical properties of metal doped carbon composites as determined by BET/porosimetry nitrogen physisorption. FIG. 15 shows the modification to the electrochemical voltage profile with the addition of Ni-doping. Notice that both the shape of the voltage profile and the capacity can be tailored depending on the dopant, the quantity, and the processing conditions.

TABLE 6
Physical properties of Metal-Doped composite based on data
obtained by BET/porosimetry nitrogen physisorption.

| | | Average Pore Size |
|---|---|---|
| BET surface area (m²/g) | Pore Volume (cm³/g) | (angstroms) |
| 439 | 0.323 | 29 |

### Example 9

### Incorporation of Electrochemical Modifier During Polymerization of Polymer Gel

A resorcinol-formaldehyde gel mixture is prepared in a manner analogous to that described in Example 1. About 20 mL of polymer solution is obtained (prior to placing solution at elevated temperature and generating the polymer gel). To this solution, about 5 mL of a saturated solution containing a salt of an electrochemical modifier is added. The solution is then stored at 45° C. for about 5 h, followed by 24 h at 85° C. to fully induce the formation of a polymer gel containing the electrochemical modifier. This gel is disrupted to create particles, and the particles are frozen in liquid nitrogen.

The resulting wet polymer gel is then pyrolyzed by heating from room temperature to 850° C. under nitrogen gas at a ramp rate of 20° C. per min to obtain a hard carbon containing the electrochemical modifier.

### Example 10

### Incorporation of Alternate Phase Carbon During Polymerization of Polymer Gel

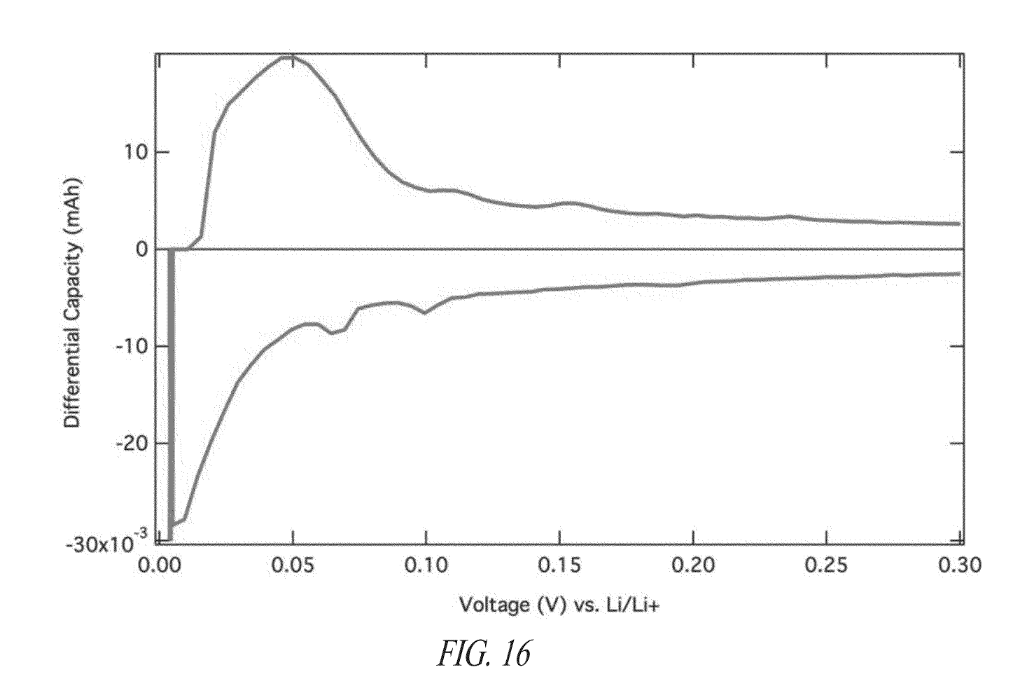

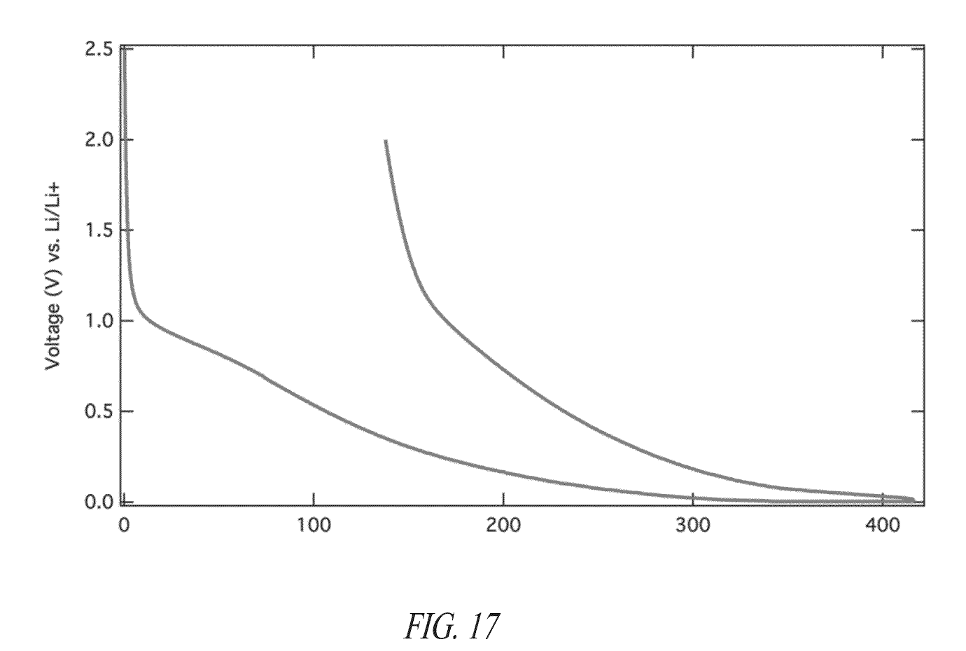

A resorcinol-formaldehyde gel was prepared as in Example 1 but during the solution phase (before addition of formaldehyde) graphite powder (99:1 w/w resorcinol/graphite) was added while stirring. The solution was continually stirred until gellation occurred at which point the resin was allowed to cure at 85° C. for 24 hours followed by pyrolysis (10° C./min ramp rate) at 1100° C. for 1 hour in flowing nitrogen. The electrochemical performance typical of this material is seen in FIGS. 16 and 17. This material is extremely unique as it shows both hard carbon and graphite phases during lithiation and delithiation.

### Example 11

### Optimal Voltage Window for Hard Carbon Performance

The material from Example 3 is tested in lithium ion battery half-cells as previously described. The anode electrode of an 88:2:10 composition (hard carbon:conductive additive:PVDF polymer binder) on 18 micron thick copper foil. The laminate thickness is 40 microns after calendaring.

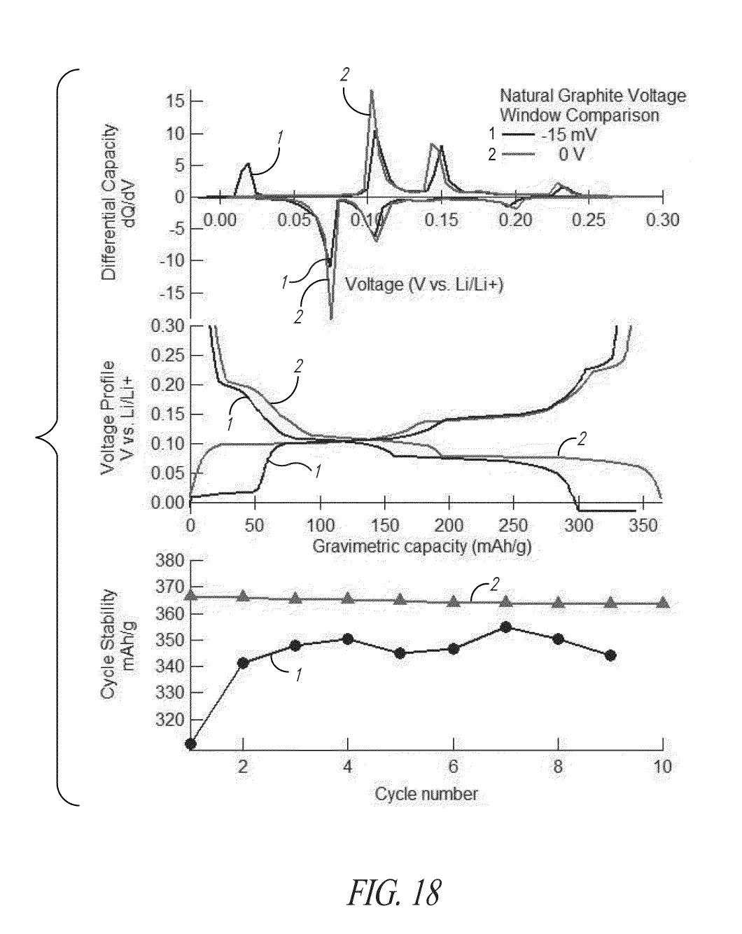

Cells are tested at 40 mA/g relative to the mass of hard carbon active material using a symmetric charge and discharge galvanostatic profile, with a 2-hour low voltage hold. One voltage window is set between 2.0V and 5 mV versus Li/Li⁺. A second voltage window is set between 2.0V and −15 mV versus Li/Li⁺. For comparison, identical cells were assembled using a graphite electrode. FIG. 18 compares the performance of the two cells using different lower voltage cut-offs for graphite. It is well known that graphite performs poorly when cycled below zero volts due to lithium plating and irreversible capacity. Notice that the capacity of graphite with a 0 V cut-off window displays stable cycling. However, when the voltage window is widened to −15 mV, the reversible capacity is actually lower and unstable.

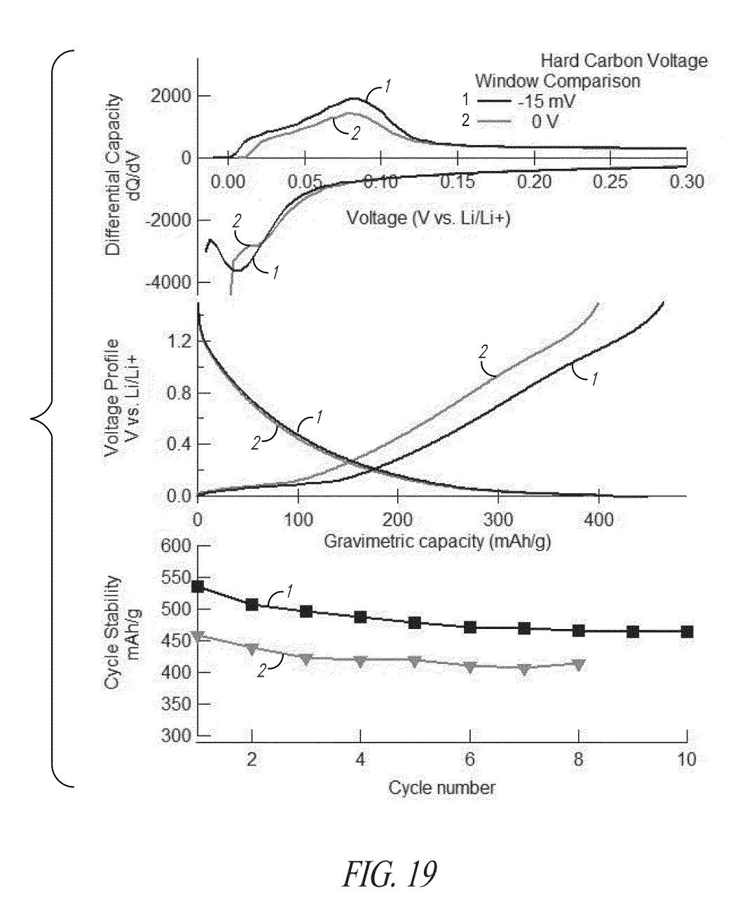

FIG. 19 compares the performance of the hard carbon two cells using different lower voltage cut-offs for graphite. Both the differential capacities and the voltage profiles show that the insertion mechanism for lithium is identical for both voltage windows. The cycling stability plot indicates that a negative voltage cut-off provides a 25% increase in capacity with no stability losses. This is drastically different than the graphite, where the capacity was lower and unstable. It is clear that hard carbons do not undergo the same detrimental lithium plating as in graphite. This may be due to the change in overpotential for lithium plating, associated with the insertion of lithium into the pores of the hard carbon anode material.

### Example 12

### Purity Analysis Of Ultrapure Synthetic Carbon

The ultrapure synthetic activated carbon samples were examined for their impurity content via proton induced x-ray emission (PIXE). PIXE is an industry standard, high sensitive and accurate measurement for simultaneous elemental analysis by excitation of the atoms in a sample to produce characteristic X-rays which are detected and their intensities identified and quantitated. PIXE capable of detection of all elements with atomic numbers ranging from 11 to 92 (i.e., from sodium to uranium).

As seen in Table 7, the ultrapure synthetic activated carbons according to the instant disclosure have a lower PIXE impurity content and lower ask content as compared to other known carbon samples.

TABLE 7
Purity Analysis of Ultrapure Synthetic Activated Carbon & Comparison Carbons

| | Impurity Concentration (PPM) | | | | | | |
|---|---|---|---|---|---|---|---|
| Impurity | Sample 1 | Sample 2 | Sample 3 | Sample 4 | Sample 5 | Sample 6 | Sample 7 |
| Na | ND* | ND | ND | ND | ND | 353.100 | ND |
| Mg | ND | ND | ND | ND | ND | 139.000 | ND |
| Al | ND | ND | ND | ND | ND | 63.850 | 38.941 |
| Si | 53.840 | 92.346 | 25.892 | 17.939 | 23.602 | 34.670 | 513.517 |
| P | ND | ND | ND | ND | ND | ND | 59.852 |
| S | ND | ND | ND | ND | ND | 90.110 | 113.504 |
| Cl | ND | ND | ND | ND | ND | 28.230 | 9.126 |
| K | ND | ND | ND | ND | ND | 44.210 | 76.953 |
| Ca | 21.090 | 16.971 | 6.141 | 9.299 | 5.504 | ND | 119.804 |
| Cr | ND | ND | ND | ND | ND | 4.310 | 3.744 |
| Mn | ND | ND | ND | ND | ND | ND | 7.552 |
| Fe | 7.582 | 5.360 | 1.898 | 2.642 | 1.392 | 3.115 | 59.212 |
| Ni | 4.011 | 3.389 | 0.565 | ND | ND | 36.620 | 2.831 |
| Cu | 16.270 | 15.951 | ND | ND | ND | 7.927 | 17.011 |
| Zn | 1.397 | 0.680 | 1.180 | 1.130 | 0.942 | ND | 2.151 |
| Total | 104.190 | 134.697 | 35.676 | 31.010 | 31.44 | 805.142 | 1024.198 |
| (% Ash) | (0.018) | (0.025) | (<0.007) | (0.006) | (0.006) | (0.13) | (0.16) |

*ND = not detected by PIXE analysis

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet, are incorporated herein by reference, in their entirety. Aspects of the embodiments can be modified, if necessary to employ concepts of the various patents, applications and publications to provide yet further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A carbon material comprising a surface area of greater than 50 m²/g and a specific lithium uptake capacity of greater than 1.4:6.

2. The carbon material of claim 1, wherein the specific surface area is greater than 100 m²/g.

3. The carbon material of claim 2, wherein the specific surface area is greater than 200 m²/g.

4. The carbon material of claim 1, wherein the carbon material comprises from 1% to 6% nitrogen by weight relative to total weight of all components in the carbon material.

5. The carbon material of claim 1, wherein the carbon material comprises from 6% to 20% nitrogen by weight relative to total weight of all components in the carbon material.

6. The carbon material of claim 1, wherein the carbon material comprises a total pore volume from 0.1 to 0.6 cm³/g.

7. The carbon material of claim 1, wherein the carbon material comprises a tap density from 0.3 to 0.9 g/cm³.

8. The carbon material of claim 1, wherein the carbon material comprises a nitrogen content from 1% to 20%, a total pore volume from 0.1 to 0.6 cm³/g and a tap density from 0.3 to 1.0 g/cm³.

9. The carbon material of claim 1, wherein the first cycle efficiency of a lithium based energy storage device is greater than 70% when the carbon material is incorporated into an electrode of the lithium based energy storage device.

10. The carbon material of claim 1, wherein the first cycle efficiency of a lithium based energy storage device is greater than 80% when the carbon material is incorporated into an electrode of the lithium based energy storage device.

11. The carbon material of claim 1, wherein the first cycle efficiency of a lithium based energy storage device is greater than 90% when the carbon material is incorporated into an electrode of the lithium based energy storage device.

12. The carbon material of claim 8, wherein the first cycle efficiency of a lithium based energy storage device is greater than 70% when the carbon material is incorporated into an electrode of the lithium based energy storage device.

13. The carbon material of claim 1, wherein 50% of the total pore volume comprises pores less than 100 nm in diameter.

14. The carbon material of claim 1, wherein 50% of the total pore volume comprises pores less than 1 nm in diameter.

15. The carbon material of claim 1, wherein the total concentration of all elements having an atomic number from 11 to 92 is below 200 ppm as measured by proton induced X-ray emission.

16. The carbon material of claim 12, wherein 50% of the total pore volume comprises pores less than 1 nm and wherein the total concentration of all elements having an atomic number from 11 to 92 is below 200 ppm as measured by proton induced X-ray emission.

17. The carbon material of claim 1, wherein the carbon material comprises an electrochemical modifier.

18. The carbon material of claim 17, wherein the electrochemical modifier is selected from iron, tin, silicon, nickel, aluminum and manganese.

19. The carbon material of claim 18, wherein the electrochemical modifier comprises silicon.

20. The carbon material of claim 18, wherein the electrochemical modifier comprises tin.

21. The carbon material of claim 1, wherein the carbon material comprises Al₂O₃.

22. The carbon material of claim 1, wherein the carbon material comprises organic functionality as determined by FTIR analysis.

23. The carbon material of claim 1, wherein the carbon material comprises less than 10% crystallinity.

24. The carbon material of claim 1, wherein the carbon material comprises an Lₐ ranging from 20 nm to 30 nm as determined by RAMAN spectroscopy analysis.

25. The carbon material of claim 1, wherein the carbon material comprises an R ranging from 0.60 to 0.90 as determined by RAMAN spectroscopy analysis.

26. The carbon material of claim 1, wherein the carbon material comprises a total of less than 200 ppm of all elements having atomic numbers ranging from 11 to 92, excluding any intentionally added electrochemical modifier, as measured by proton induced x-ray emission.

27. The carbon material of claim 1, wherein the carbon material comprises a pyrolyzed polymer cryogel.

28. The carbon material of claim 1, wherein the carbon material has a ratio of intercalation storage to pore storage ranging from 2:1 to 1:2.

29. The carbon material of claim 1, wherein the lithium content and lithium location within the carbon structure can be measured with a FIB and SEM.

30. The carbon material of claim 1, wherein the carbon material comprises a lithium plating potential between −5 mV and −15 mV versus lithium metal.

31. An electrode comprising a binder and a carbon material according to claim 1.

32. An electrical energy storage device comprising:
a) at least one anode comprising a hard carbon material;
b) at least one cathode comprising a metal oxide; and
c) an electrolyte comprising lithium ions;
wherein the electrical energy storage device has a first cycle efficiency of at least 70% and a reversible capacity of at least 200 mAh/g with respect to the mass of the hard carbon material present in the device.

33-61. (canceled)

62. The carbon material of claim 17, wherein the electrochemical modifier comprises phosphorous.
